(19) United States
(12) Patent Application Publication
(10) Pub. No.: US 2015/0163060 A1
(43) Pub. Date: Jun. 11, 2015

(54) METHODS, SYSTEMS AND APPARATUS FOR PUBLIC KEY ENCRYPTION USING ERROR CORRECTING CODES

(71) Applicants: Martin Tomlinson, Devon (GB); Cen Jung Tjhai, London (GB)

(72) Inventors: Martin Tomlinson, Devon (GB); Cen Jung Tjhai, London (GB)

(21) Appl. No.: 14/596,098

(22) Filed: Jan. 13, 2015

Related U.S. Application Data
(63) Continuation-in-part of application No. 13/642,459, filed on Dec. 12, 2012, now Pat. No. 8,958,553.

(30) Foreign Application Priority Data
Apr. 22, 2010 (GB) 1006747.8
Nov. 13, 2014 (GB) 1420152.9

(51) Int. Cl. H04L 9/30; H04L 9/08

(52) U.S. Cl. CPC H04L 9/304; H04L 9/0816; H04L 2209/24

(57) ABSTRACT

This invention provides improved security of the McEliece Public Key encryption system adding features which make full use of random number generation for given message and cryptogram parameters. Different embodiments of the invention are described which enable the level of security to be traded-off against cryptogram size and complexity. Message vectors are encoded with a scrambled generator matrix, using matrix multiplication to form codeword vectors. Shortened corrupted codewords are generated by corrupting each codeword vector and omitting a predefined number of bits, whereby a cryptogram is formed from the shortened corrupted codewords. Measures are included to defeat attacks based on information set decoding. A number of different applications are given.

### REFERENCE TO RELATED APPLICATIONS

This application is a continuation-in-part of U.S. Ser. No. 13/642,459, which is the National Stage of International Application PCT/GB2011/000636 filed Apr. 21, 2011, which claims priority from GB Patent Application 1006747.8 filed on Apr. 22, 2010. This application also claims priority under 35 U.S.C. §119 from GB Patent Application 1420152.9 filed on Nov. 13, 2014.

### FIELD OF THE INVENTION

This invention relates to computerised methods and apparatus for encrypting and decrypting data using public key encryption techniques, and to computerised methods and apparatus for communications using such techniques, as well as other applications thereof.

### BACKGROUND

Public key encryption is an invaluable technology enabling information to be encrypted and securely sent from one person to another without the need for a secret key to be shared between the parties. The first method was secretly invented in 1973 by Ellis, Cocks and Williamson whilst working at GCHQ (Government Communications Headquarters) and was based on the difficulty of finding discrete logarithms. Their method was independently invented by Diffie and Hellman who published their Diffie-Hellman key exchange in 1976 “New directions in cryptography”, IEEE Transactions on Information Theory, Vol 22, Issue 6.

Another method was independently invented in 1977 by Rivest, Shamir and Adleman, “A Method for Obtaining Digital Signatures and Public-Key Cryptosystems”, Communications of the ACM 21 (2), and is known as RSA. It is based on the considerable difficulty of factorizing large integers into prime factors. In RSA a large integer N which forms part of the public key is constructed from the product of two large prime numbers P₁ and P₂ which must be kept secret. An arbitrary integer e is chosen and the public key consists of N and e. The security of RSA is compromised if P₁ and P₂ are determined and this can be done, at least in theory, by factorising N. In typical implementations of RSA, N consists of a 1024 bit number which is predicted to be factorisable in practice within a few years with advances in computer technology. Longer numbers may be used such as 2048 bit numbers but alternative Public key systems based on different methods are likely to become more important.

Another different public key system is the McEliece system invented by the distinguished mathematician Robert McEliece in 1978, “A Public-Key Cryptosystem based on Algebraic Coding Theory”, DSN Progress Report 42-44. It is the first example of code based cryptography and uses the family of Goppa error correcting codes first published in 1970, “A new class of linear error-correcting codes”, V. D. Goppa, Problems of Info. Transmission, Vol. 6, No 3, pp. 207-212. The method relies on the difficulty of correcting unknown random errors if the particular Goppa code used in generating the public and private keys is unknown. A plaintext or cleartext message is encoded into binary codewords using the public key and a randomly chosen error pattern containing up to t bits is added to each code-word. and several such constructed codewords make up the cryptogram. In decryption, the associated private key is used to invoke an error correcting decoder based upon the underlying Goppa code to correct the errored bits in each codeword, prior to retrieval of the cleartext message.

In U.S. Pat. No. 5,054,066, Riek and McFarland improved the security of the system by complementing the error patterns so as to increase the number of errors contained in the cryptogram.

In the originally proposed Public Key encryption system a codeword is generated from message bits by using a permuted, scrambled generator matrix of a Goppa code of length n symbols, capable of correcting t errors. This matrix is the public key. The digital cryptogram is formed from codewords corrupted by exactly t randomly, or t pseudo-randomly, chosen bit errors. The security strength of the McEliece Public Key encryption system stems from the fact that a truly random binary error pattern is added to the encoded message as part of the digital cryptogram. The security is provided by the fact that it is impossible to remove the unknown bit errors unless the original unpermuted Goppa code, the private key, is known in which case the errors can be removed by correcting them and then recovering the original message by descrambling the information bits in the codeword to recover the original message. In the original example given in the above-referenced “A Public-Key Cryptosystem based on Algebraic Coding Theory”, R. J. McEliece, a Goppa code is employed having parameters (n, k, 2t+1)=(2^{m}, 2^{m}−mt, 2t+1) where n is the codeword length, k is the number of information bits, m is an integer that defines the number of Goppa code elements, and t is the number of errors in each cryptogram. In the original example described in the McEliece paper, the codeword length n is 1024 and t is 50. The number of possible error combinations is 3.19×10⁸⁵ equivalent to a secret key of length 284 bits. In a present day implementation of the McEliece cryptosystem, typically m=11 and t=68 so that the code parameters are (2048,1300,137), with each cryptogram containing 2048 bits, which can be an excessive number of bits for transmission for certain applications.

Even with the same message and the same public key a different digital cryptogram is produced each time. The messages are encoded with a scrambled, binary mapped, permuted, version of a GF(2^{m}) Goppa code. Without the knowledge of the particular Goppa code that is used, the error patterns cannot be corrected and the messages cannot be recovered. It is not possible to deduce which particular Goppa code is being used from the public key, which is the matrix used for encoding, because this matrix is a scrambled, permuted version of the original encoding matrix of the Goppa code, plus the fact that for a given m there are an extremely large number of Goppa codes, as discussed in “A Public-Key Cryptosystem based on Algebraic Coding Theory”, R. J. McEliece, DSN Progress Report 42-44, 1978. In the original example given in the above McEliece paper, the codeword length n is 1024 and t is 50. The number of possible error combinations is 3.19×10⁸⁵ equivalent to a secret key of length 284 bits.

### SUMMARY OF THE INVENTION

This invention is concerned with providing additional features to the original McEliece system which enhance the bandwidth efficiency and security of the Public Key Encryption arrangement, and to applications thereof. The invention is defined by the independent claims herewith. The following non-limiting summary is for technical information purposes only.

In the invention, a message is encrypted by first partitioning the message into message vectors of length k bits each and encoding these message vectors into codewords which are corrupted by a combination of bit errors and bit deletions to form the cryptogram.

It is a feature of the invention that the number of bit errors in each corrupted codeword is not fixed, but is an integer s, which is randomly chosen, with the constraint that, s≦t. This increases the number of possible error combinations, thereby increasing the security of the system. Furthermore it is shown that as a consequence 2(t−s) bits may be deleted from the codeword in random positions adding to the security of the digital cryptogram as well as reducing the size of the digital cryptogram, without shortening the message.

In the case of the original example, above, with t/2≦s≦t, the number of possible error combinations is increased to 3.36×10⁸⁵ and the average codeword in the cryptogram is reduced to 999 bits from 1024 bits.

Unlike most encryption systems, a characteristic of the encryption arrangement of an embodiment of the invention is the use of a truly random integer generator, not a pseudo random generator to form the cryptogram. Consequently the cryptogram is not predictable or deterministic. Even with the same message and public key the cryptogram produced will be different each time and without knowledge of the random errors and bit deletions, which may be determined only by using the structure of the Goppa code, recovery of the original message is impossible.

In a further embodiment of the invention, to reduce the size of the cryptogram, only the first Goppa codeword is corrupted with a random error vector. The following codewords contained in the cryptogram are corrupted by deleting bits in 2t random bit positions, defined by a position vector, known to the recipient of the cryptogram. With the Goppa code codewords of length n bits with k information bits correcting t errors, the shortened codewords have length n−2t and still contain k information bits, improving the bandwidth efficiency of the system. The recipient of the cryptogram, knowing the positions of the 2t deleted bits in each codeword, marks these bit positions as erasures.

The Goppa code is capable of correcting 2t erasures in each codeword and in this way the original message is retrieved.

In another embodiment of the invention, to reduce further the size of the cryptogram, only the first Goppa codeword is corrupted with a random error vector, and this vector is used to provide the initial state of a scrambler which is used to scramble all of the following message bits which are sent uncoded. In this embodiment of the invention, the cryptogram contains only one Goppa codeword.

In a further embodiment of the invention, to enhance the security of the system, in addition to scrambling using the fixed non-singular matrix contained in the Public Key, a different scrambler for 0 each message vector is used. This scrambler is derived front the random error vector which is added to the codeword to produce the corrupted codeword after encoding using the permuted, scrambled generator matrix of a Goppa code. As the constructed digital cryptogram is a function of truly randomly chosen vectors, not pseudo randomly chosen vectors, or a fixed vector, the security of the Public Key encryption system is enhanced compared to the standard McEliece Public Key system. Even with an identical message and using the same public key, the resulting cryptograms will have no similarity at all. This is not true for the standard McEliece Public Key system as each codeword will only differ in a maximum of 2t bit positions.

In another embodiment of the invention, to enhance the security of the system and to make broadcasting of digital cryptograms easier, additional errors may be inserted into the digital cryptogram so that each corrupted codeword contains more than t errors. A sophisticated method of introducing the additional errors is not necessary since provided there are sufficient additional errors to defeat decryption based on guessing the positions of the additional errors the message is theoretically unrecoverable front the corrupted digital cryptogram even with knowledge of the private key This feature may find applications where a message needs to be distributed to several recipients using the same or different Public/Private Keys at the same time, possibly in a commercial, competitive environment.

The corrupted digital cryptograms may be sent to each recipient arriving asynchronously, due to variable network delays and only the relatively short key containing information of the additional error positions needs to be sent at the same time to all recipients.

In a further embodiment of the invention, to enhance the security of the system, additional errors are inserted into each codeword in positions defined by a position vector, which is derived front a cryptographic hash of the previous message vector. Standard hash function may be used, such as SHA-256. The first message vector uses a position vector derived from a hash or message already known by the recipient of the cryptogram.

The invention may be used in a wide number of different applications such as active and passive RFID secure bar-codes, secure ticketing, magnetic cards, message services, e-mail applications, digital broadcasting, digital communications, video communications and digital storage. Encryption and decryption is amenable to high speed implementation operating at speeds beyond 1 Gbit/sec.

### BRIEF DESCRIPTION OF THE DRAWINGS

Embodiments of the invention will now be illustrated, by way of example only, with reference to the accompanying drawings in which:

FIG. 1 is a block diagram which shows the structure of a Public Key encryption system with s random bit errors and 2(t−s) bit deletions according to an embodiment of the invention.

FIG. 2 is a block diagram which shows the structure of a random integer generator of the number of added random bit errors, s, which is preferably used with the embodiment of FIG. 1.

FIG. 3 is a block diagram which shows the structure of a random integer generator for generating error positions randomly, which is preferably used with the embodiment of FIG. 1.

FIG. 4 is a block diagram which shows the structure of a Private Key decryption system with s random bit errors and 2(t−s) bit deletions according to an embodiment of the invention for use in decrypting messages produced by the encryption apparatus of FIG. 1.

FIG. 5 is a block diagram which shows the structure of a Public Key encryption system according to a second embodiment of the invention with s random bit errors, 2(t−s) bit deletions and a random number of additional errors.

FIG. 6 is a block diagram which shows the structure of a Private Key decryption system with s random bit errors, 2(t−s) bit deletions and a random number of additional errors according to the second embodiment of the invention for use in decrypting messages produced by the encryption apparatus of FIG. 5.

FIG. 7 is a block diagram which shows the structure of a position vector generator for generating error positions according to a further embodiment of the invention using a hash of message vector and non-linear feedback shift register.

FIG. 8 is a block diagram which shows the structure of a message vector scrambler according to a further embodiment of the invention using non-linear feedback shift register with taps defined by s bit error pattern.

FIG. 9 is a block diagram which shows the structure of a corresponding descrambler.

FIG. 10 is a block diagram which shows schematically a system of Active RFID devices utilising embodiments of the present invention.

FIG. 11 is a block diagram which shows the structure of a Public Key encryption system according to a first alternative embodiment.

FIG. 12 is a schematic block diagram illustrating an exemplary scrambler arrangement for encrypting a message vector.

FIG. 13 is a schematic block diagram illustrating an exemplary descrambler arrangement for decrypting an input vector.

FIG. 14 is a schematic block diagram illustrating the composition of a random error pattern in terms of partial error patterns or vectors A, B and C, and a resulting shortened codeword.

FIG. 15 is a flow diagram for a process for the first alternative embodiment showing how the Data D is decrypted from the shortened corrupted codeword.

FIG. 16 is a flow diagram for the second alternative embodiment showing how an encryption key is derived from the random error pattern which in turn is used to encrypt Data D and how a shortened corrupted codeword is formed without including partial error pattern A in the cryptogram.

FIG. 17 is a flow diagram of a process for decrypting the cryptogram according to the second alternative embodiment.

FIG. 18 is a flow diagram for the third alternative embodiment showing how an encryption key is derived from a random error pattern which in turn is used to encrypt Data D and how a cryptogram is formed but without including partial error patterns A and B in the cryptogram.

FIG. 19 is a flow diagram of a process for decrypting the cryptogram according to the third alternative embodiment.

FIG. 20 shows a random bits generator being used to augment a shortened corrupted codeword according to the third alternative embodiment with a prefix of a sequence of random bits so as to form a cryptogram of a fourth alternative embodiment which will defeat an attack based on information set decoding.

FIG. 21 is a flow diagram of a process for generating a cryptogram of a fifth alternative embodiment in which a Control Data X vector is used to control a predetermined permutation of a cryptogram of the fourth alternative embodiment as well as to control the number of random bits contained in a cryptogram of the fourth alternative embodiment.

FIG. 22 is a flow diagram of a process for encrypting the Control Data X vector and forming a cryptogram according to a sixth alternative embodiment.

FIG. 23 is a flow diagram of a process for decrypting the Control Data X vector from the cryptogram constructed according to the sixth alternative embodiment.

FIG. 24 shows the composition of a cryptogram formed by combining the cryptogram of the fifth alternative embodiment with the cryptogram of the sixth alternative embodiment.

FIG. 25 is a flow diagram of a process for turning a cryptogram of the fifth alternative embodiment, using the Control Data X vector, back into a cryptogram of the third alternative embodiment.

FIG. 26 is a flow diagram of a process for forming a cryptogram of the third alternative embodiment in which a very long code is used with the constraint that a user chooses to use only part of the encoding public key matrix, a sub matrix, so that partial Error Pattern A is confined to positions corresponding to this sub matrix.

FIG. 27 is a flow diagram of a process for forming a cryptogram of the seventh alternative embodiment.

FIG. 28, which comprised FIGS. 28A and 28B, schematically illustrates a cryptogram format for an instant messaging app in which each message is independently encrypted.

FIG. 29, which comprised FIGS. 29A and 29B, schematically illustrates a cryptogram format for an instant messaging app in which each message is independently encrypted with two keys for two recipients but with a common encrypted message.

FIG. 30 shows a cryptogram format for storing encrypted data onto an RFID tag such as an NFC tag.

FIG. 31 shows an example of using the invention to encrypt a message onto a 2D barcode using a mobile phone.

FIG. 32 is a block diagram of an example of a computer system on which one or more of the functions of the embodiments may be implemented.

### DESCRIPTION OF EMBODIMENTS

The security strength of the McEliece Public Key encryption system stems from the fact that a truly random binary error pattern is added to the encoded message as part of the digital cryptogram. Even with the same message and the same public key a different digital cryptogram is produced each time. The messages are encoded with a scrambled, binary mapped, permuted, version of a GF(2^{m}) Goppa code. Without the knowledge of the particular Goppa code that is used, the error patterns cannot be corrected and the messages cannot be recovered. It is not possible to deduce which particular Goppa code is being used from the public key, which is the matrix used for encoding, because this matrix is a scrambled, permuted version of the original encoding matrix of the Goppa code, plus the fact that for a given m there are an extremely large number of Goppa codes, as discussed in the above-referenced McEliece paper.

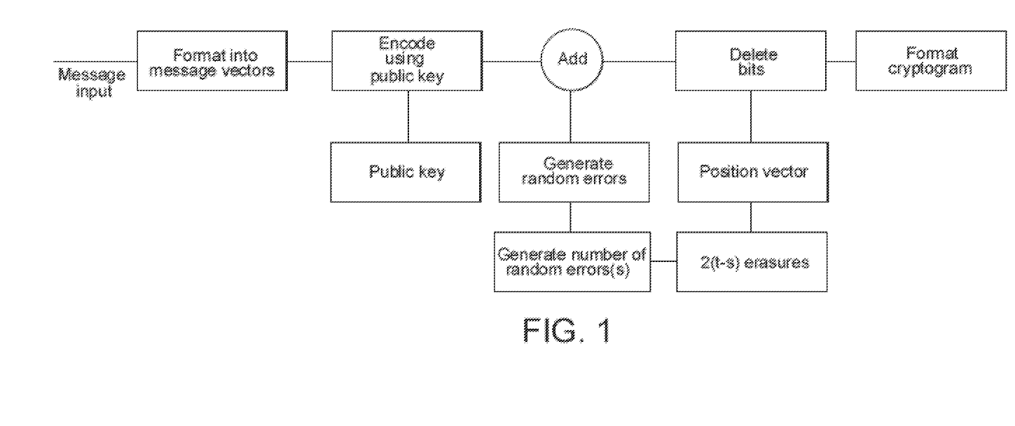

The method of encryption in one embodiment is shown in FIG. 1, in which blocks represent code modules such as subroutines or function calls, executed by programmable hardware. The apparatus for performing the method comprises a chipset provided in a mobile phone or other portable communications device which includes a CPU, a program storage carrier medium such as Flash or EPROM memory, random access memory for performing calculations, and data reception and transmission hardware devices including modems and codecs. Optionally, a reader such as a USB port or card reader, or disc drive for removable media, is included—in such case, the removable media may contain the operating program for causing the above-described hardware to perform the functions set forth below.

The message information to be sent, if not in digital form, is digitally encoded into binary form comprising a sequence of information bits. The message comprising a sequence of information bits is formatted by appending dummy bits as necessary into an integral number of binary message vectors of length k bits each. This is carried out by format into message vectors shown in FIG. 1. Each message vector is scrambled and encoded into a codeword, n bits long, defined by an error correcting code which is derived from a binary Goppa code and a scrambling matrix. The binary Goppa code is derived itself from a non-binary Goppa code and the procedure is described below for a specific example.

The encode using public key shown in FIG. 1 carries out the scrambling and codeword encoding for each message vector by selecting rows of the codeword generator matrix according to the message bits contained in the message vector. This operation is described in more detail below for a specific example. The codeword generator matrix to be used for encoding is defined by the public key which is stored in a buffer memory, public key shown in FIG. 1. As shown in FIG. 1 a random number generator generates a number s internally constrained to be less than or equal to t and this is carried out by generate number of random errors (s). The parameter t is the number of bit errors that the Goppa code can correct.

The number of random errors s is input to generate random errors which for each codeword, initialises an n bit buffer memory with zeros, and uses a random number generator to generate s 1's in s random positions of the buffer memory. The contents of the n bit buffer are added to the codeword of n bits by add shown in FIG. 1. The 1's are added modulo 2 which inverts the codeword bits in these positions so that these bits are in error. In FIG. 1 t−s erasures takes the input s, calculates 2(t−s) and outputs this value to position vector which comprises a buffer memory of n bits containing a sequence of integers corresponding to a position vector described below. The first 2(t−s) integers are input to delete bits which deletes the bits in the corresponding positions of the codeword so that 2(t−s) bits of the codeword are deleted. The procedure is carried out for each codeword so that each codeword is randomly shortened due to deleted bits and corrupted with a random number of bit errors in random positions. In FIG. 1 format cryptogram has the sequence of shortened corrupted codewords as input and appends these together, together with formatting information to produce the cryptogram.

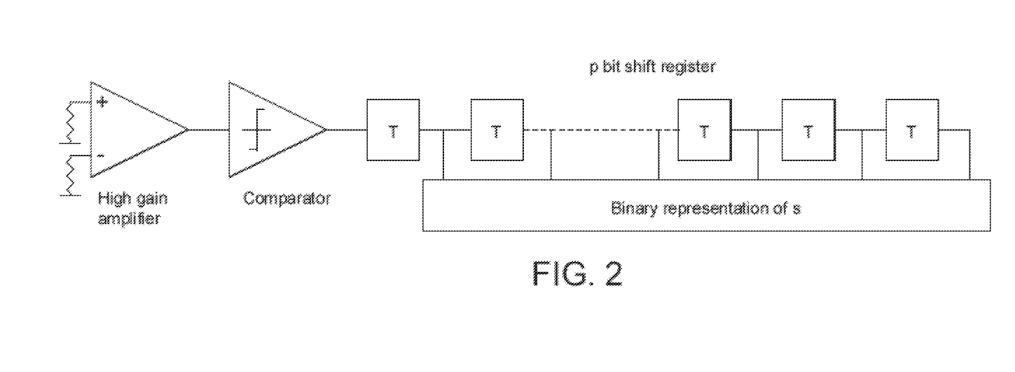

The highest level of security is provided by generate number of random errors (s) of FIG. 1 being a truly random number generator and not a pseudo random generator. An example of a random number generator is shown in FIG. 2.

The differential amplifier, with high gain amplifies the thermal noise generated by the resistor terminated inputs. The output of the amplifier is the amplified random noise which is input to a comparator which carries out binary quantisation. The comparator output is a 1 if the amplifier output is a positive voltage and a 0 otherwise. This produces 1's and 0's with equal probability at the output of the comparator. The output of the comparator is clocked into a shift register having p shift register stages, each of delay T. The clock rate is 1/T. After p clock cycles the contents of the shift register represents a number in binary which is the random number s having a uniform probability distribution between 0 and 2^{p-1}.

One or more of the bits output from the shift register may be permanently set to a 1 to provide a lower limit to the random number of errors s. As an example if the 4^{th} bit (counting from 0) is permanently set to 1 then s has a uniform probability distribution between 2³=8 and 2^{p-1}.

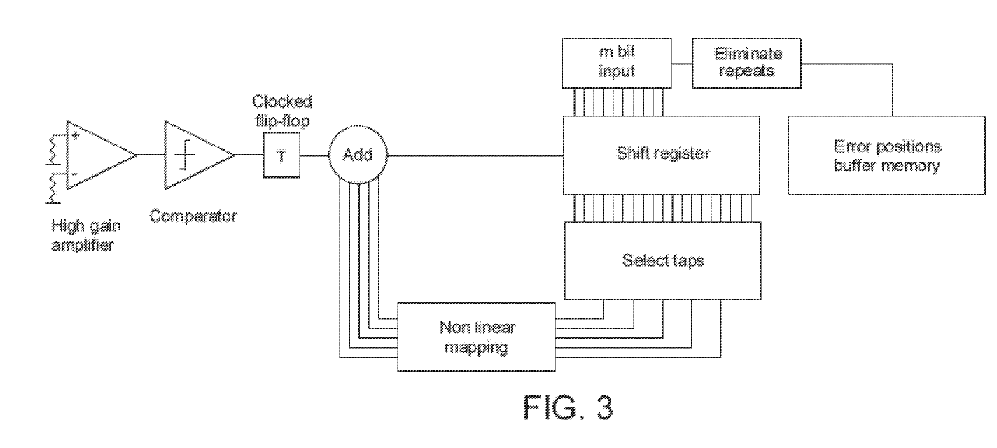

Similarly the highest level of security is provided if the positions of the errors generated by generate random errors of FIG. 1 is a truly random number generator and not a pseudo random generator. An example of an arrangement which generates truly random positions in the range of 0 to 2^{m-1} corresponding to the codeword length is shown in FIG. 3.

As shown in FIG. 3, the differential amplifier, with high gain amplifies the thermal noise generated by the resistor terminated inputs. The output of the amplifier is the amplified random noise which is input to a comparator which outputs a 1 if the amplifier output is a positive voltage and a 0 otherwise. This produces 1's and 0's with equal probability at the output of the comparator. The output of the comparator is clocked into a flip-flop clocked at 1/T, with the same clock source as the shift register shown in FIG. 3, shift register. The output of the flip-flop is a clocked output of truly random 1's and 0's which is input to a non-linear feedback shift register arrangement.

The output of the flip-flop is input to a modulo 2 adder add which is added to the outputs of a non-linear mapping of u selected outputs of the shift register. Which outputs are selected corresponds to the key which is being used. The parameter u is a design parameter typically equal to 8.

The non-linear mapping non linear mapping shown in FIG. 3 has a pseudorandom one to one correspondence between each of the 2^{u} input states to each of the 2^{u} output states. An example of such a one to one correspondence, for u=4 is given in Table 1. For example, the first entry, 0000, value 0 is mapped to 0011, value 3.

TABLE 1
Example of non-linear mapping for u = 4

0000 => 0011
0001 => 1011
0010 => 0111
0011 => 0110
0100 => 1111
0101 => 0001
0110 => 1001
0111 => 1100
1000 => 1010
1001 => 0000
1010 => 1000
1011 => 0010
1100 => 0101
1101 => 1110
1110 => 0100
1111 => 1101

The shift register typically has a relatively large number of stages, 64 is a typical number of stages and a number of tapped outputs, typically 8. The relationship between the input of the shift register aᵢₙ and the tapped outputs is usually represented by the delay operator D. Defining the tap positions as wᵢ for i=0 to iₘₐₓ, the input to the non-linear mapping non linear mapping shown in FIG. 3, defined as xᵢ for i=0 to iₘₐₓ, is

xᵢ=αᵢₙD^{w}^{ᵢ} (1)

and the output yⱼ after the mapping function, depicted as M is

yⱼ=M[xᵢ]=M[αᵢₙD^{w}^{_{i]}} (2)

The input to the shift register is the output of the adder given by the sum of the random input R_{nd} and the summed output of the mapped outputs. Accordingly

$$\begin{matrix}{α}_{in} = {R}_{nd} + {\sum }_{j = o}^{{i}_{max}} {y}_{j} \\ = {R}_{nd} + {\sum }_{j = o}^{{i}_{max}} M [ {x}_{i} ] \\ = {R}_{nd} + {\sum }_{j = o}^{{i}_{max}} M [ {α}_{in} {D}^{{w}_{i}} ]\end{matrix} \qquad ( 3 )$$

It can be seen that the shift register input aᵢₙ is a non-linear function of delayed outputs of itself added to the random input R_{nd} and so will be a random binary function.

The positions of the errors is given by the output of m bit input shown in FIG. 3, an m bit memory register and defined as eₚₒₛ. Without loss of generality consider that the first m outputs of the shift register are used as the input to m bit input. The output of m bit input is a binary representation of a number given by

$${e}_{pos} = {\sum }_{j = o}^{m - 1} {2}^{j} \times {α}_{in} {D}^{j} \qquad ( 4 )$$

Since aᵢₙ is a random binary function eₚₒₛ will be an integer between 0 and 2^{m-1} randomly distributed with a uniform distribution. As shown in FIG. 3 these randomly generated integers are stored in memory in error positions buffer memory after eliminate repeats has eliminated any repeated numbers, since repeated integers will occur from time to time in any independently distributed random integer generator.

The random bit errors and bit deletions can only be corrected with the knowledge of the particular non-binary Goppa code, the private key, which is used in deriving the codeword generator matrix. In describing additional details of the present embodiments, some background on Goppa codes will now be provided, based on the above-referenced Goppa paper. Goppa defined a family of codes where the coordinates of each codeword {c₀, c₁, c₂, . . . c₂^{m}₋₁} with {c₀=x₀, c₁=x₁, c₂=x₂, . . . c₂ₘ₋₁=x₂ₘ₋₁} satisfy the congruence p(z) modulo g(z)=0 where g(z) is now known as the Goppa polynomial and p(z) is the Lagrange interpolation polynomial.

Goppa codes have coefficients from GF(2^{m}) and provided g(z) has no roots which are elements of GF(2^{m}) (which is straightforward to achieve) the Goppa codes have parameters (2^{m},k,2^{m}−k+1). Goppa codes can be converted into binary codes, provided that g(z) has no roots which are elements of GF(2^{m}) and has no repeated roots. The codes have parameters (2^{m},2^{m}−mt,dₘᵢₙ) where dₘᵢₙ≧2t+1, the Goppa code bound on minimum Hamming distance. Most binary Goppa codes have equality for the bound and t is the number of correctible errors.

For a Goppa polynomial of degree r there are r parity check equations defined from the congruence. Denoting g(z) by

$$\begin{matrix}g ( z ) = {g}_{r} {z}^{r} + {g}_{r - 1} {z}^{r - 1} + {g}_{r - 2} {z}^{r - 2} + … + {g}_{r - 1} z + {g}_{0} & ( 5 ) \\ {\sum }_{i = 0}^{{2}^{m} - 1} \frac{{c}_{i}}{z - {α}_{i}} = 0 modulo g ( z ) & ( 6 )\end{matrix}$$

Since equation (6) is modulo g(z) then g(z) is equivalent to 0, and we can add g(z) to the numerator. Dividing each term z−αᵢ into 1+g(z) produces the following

$$\frac{g ( z ) + 1}{z - {α}_{i}} = {q}_{i} ( z ) + \frac{{r}_{m} + 1}{z - {α}_{i}} \qquad ( 7 )$$

where rₘ is the remainder, an element of GF(2^{m}) after dividing g(z) by z−αᵢ.

As rₘ is a scalar, g(z) may simply be pre-multiplied by 1/rₘ so that the remainder cancels with the other numerator term which is 1:

$$\begin{matrix}\begin{matrix}\frac{\frac{g ( z )}{{r}_{m}} + 1}{z - {α}_{i}} = \frac{{q}_{i} ( z )}{{r}_{m}} + \frac{\frac{{r}_{m}}{{r}_{m}} + 1}{z - {α}_{i}} \\ = \frac{{q}_{i} ( z )}{{r}_{m}}\end{matrix} & ( 8 ) \\ g ( z ) = ( z - {α}_{i} ) {q}_{i} ( z ) + {r}_{m} & ( 9 )\end{matrix}$$

When z=αᵢ, rₘ=g(αᵢ).

Substituting for rₘ in equation (8) produces

$$\begin{matrix}\frac{\frac{g ( z )}{g ( {α}_{i} )} + 1}{z - {α}_{i}} = \frac{{q}_{i} ( z )}{g ( {α}_{i} )} \\ Since \frac{g ( z )}{g ( {α}_{i} )} modulo g ( z ) = 0 & ( 10 ) \\ \frac{1}{z - {α}_{i}} = \frac{{q}_{i} ( z )}{g ( {α}_{i} )} modulo g ( z ) & ( 11 )\end{matrix}$$

The quotient polynomial qᵢ(z) is a polynomial of degree r−1 with coefficients which are a function of αᵢ and the Goppa polynomial coefficients. Denoting qᵢ(z) as

qᵢ(z)=q_{i,0}+q_{i,1}z+q_{i,2}z²+q_{i,3}z³+ . . . +q_{i,(r-1)}z^{r-1} (12)

Since the coefficients of each power of z sum to zero the r parity check equations are given by

$${\sum }_{i = 0}^{{2}^{m} - 1} \frac{{c}_{i} {q}_{i , j}}{g ( {α}_{i} )} = 0 for j = 0 to r \text{-} 1 \qquad ( 13 )$$

If the Goppa polynomial has any roots which are elements of GF(2^{m}), say αⱼ, then the codeword coordinate cⱼ has to be permanently set to zero in order to satisfy the parity check equations. Effectively the code length is reduced by the number of roots of g(z) which are elements of GF(2^{m}). Usually the Goppa polynomial is chosen to have distinct roots, none of which are in GF(2^{m}).

The security depends upon the number of bit errors added and in practical examples of the invention it is necessary to use long Goppa codes of length 1024 bits, 2048 bits or longer. For clarity, the invention will be described by way of example for a binary Goppa code of length 32 bits capable of correcting 4 bit errors. It is important to note that all binary Goppa codes are derived from non-binary Goppa codes which are designed first.

In this example, the non-binary Goppa code consists of 32 symbols from the Galois field GF(2⁵) and each symbol takes on 32 possible values with the code capable of correcting 2 errors. There are 28 information symbols and 4 parity check symbols. (It should be noted that when the Goppa code is used with information symbols restricted to 2 values as a binary Goppa code, twice as many errors can be corrected). The non-binary Goppa code has parameters of a (32,28,5) code. There are 4 parity check symbols defined by the 4 parity check equations and the Goppa polynomial has degree 4. Choosing arbitrarily as the Goppa polynomial for the following worked example, the polynomial 1+z+z⁴ which has roots only in GF(16) and none in GF(32), we determine qⱼ(z) by dividing by

qᵢ(z)=z³+αᵢz²+αᵢ²z+(1+αᵢ³) (14)

The 4 parity check equations are

$$\begin{matrix}{\sum }_{i = 0}^{31} \frac{{c}_{i}}{g ( {α}_{i} )} = 0 & ( 15 ) \\ {\sum }_{i = 0}^{31} \frac{{c}_{i} {α}_{i}}{g ( {α}_{i} )} = 0 & ( 16 ) \\ {\sum }_{i = 0}^{31} \frac{{c}_{i} {α}_{i}^{2}}{g ( {α}_{i} )} = 0 & ( 17 ) \\ {\sum }_{i = 0}^{31} \frac{{c}_{i} ( {α}_{i}^{3} + 1 )}{g ( {α}_{i} )} = 0 & ( 18 )\end{matrix}$$

Using the GF(2⁵) Table, Table 2 to evaluate the different terms for GF(2⁵), the parity check matrix is

$${H}_{( 32 , 28 , 5 )} = [ \begin{matrix}1 & 1 & {α}^{14} & {α}^{28} & {α}^{20} & {α}^{25} & … & {α}^{10} \\ 0 & 1 & {α}^{15} & {α}^{30} & {α}^{23} & {α}^{29} & … & {α}^{9} \\ 0 & 1 & {α}^{16} & {α}^{1} & {α}^{26} & {α}^{2} & … & {α}^{8} \\ 1 & 0 & {α}^{12} & {α}^{24} & {α}^{5} & {α}^{17} & … & {α}^{5}\end{matrix} ] \qquad ( 19 )$$

To implement the Goppa code as a binary code, the symbols in the parity check matrix are replaced with their m-bit binary column representations of each respective GF(2^{m}) symbol. For the (32,28,5) Goppa code above, each of the 4 parity symbols in each column of (19) will be represented as a 5 bit symbol from Table 2. The parity check matrix will now have 20 rows for the binary code. The minimum Hamming distance of the binary Goppa code is improved from r+1 to 2r+1.

TABLE 2
GF(32) non-zero extension field elements defined by 1 +
α² + α⁵ = 0

α⁰ = 1
α¹ = α
α² = α²
α³ = α³
α⁴ = α⁴
α⁵ = 1 + α²
α⁶ = α + α³
α⁷ = α² + α⁴
α⁸ = 1 + α² + α³
α⁹ = α + α³ + α⁴
α¹⁰ = 1 + α⁴
α¹¹ = 1 + α + α²
α¹² = α + α² + α³
α¹³ = α² + α³ + α⁴
α¹⁴ = 1 + α² + α³ + α⁴
α¹⁵ = 1 + α + α² + α³ + α⁴
α¹⁶ = 1 + α + α³ + α⁴
α¹⁷ = 1 + α + α⁴
α¹⁸ = 1 + α
α¹⁹ = α + α²
α²⁰ = α² + α³
α²¹ = α³ + α⁴
α²² = 1 + α² + α⁴
α²³ = 1 + α + α² + α³
α²⁴ = α + α² + α³ + α⁴
α²⁵ = 1 + α³ + α⁴
α²⁶ = 1 + α + α² + α⁴
α²⁷ = 1 + α + α³
α²⁸ = α + α² + α⁴
α²⁹ = 1 + α³
α³⁰ = α + α⁴

Correspondingly the binary Goppa code becomes a (32,12,9) code with parity check matrix:

$${H}_{( 32 , 12 , 9 )} = [ \begin{matrix}1 & 1 & 1 & 0 & 0 & 1 & … & 1 \\ 0 & 0 & 0 & 1 & 0 & 0 & … & 0 \\ 0 & 0 & 1 & 1 & 1 & 0 & … & 0 \\ 0 & 0 & 1 & 0 & 1 & 1 & … & 0 \\ 0 & 0 & 1 & 1 & 0 & 1 & … & 1 \\ 0 & 1 & 1 & 0 & 1 & 1 & … & 0 \\ 0 & 0 & 1 & 1 & 1 & 0 & … & 1 \\ 0 & 0 & 1 & 0 & 1 & 0 & … & 0 \\ 0 & 0 & 1 & 0 & 1 & 1 & … & 1 \\ 0 & 0 & 1 & 1 & 0 & 0 & … & 1 \\ 0 & 1 & 1 & 1 & 1 & 0 & … & 1 \\ 0 & 0 & 1 & 0 & 1 & 0 & … & 0 \\ 0 & 0 & 0 & 0 & 1 & 1 & … & 1 \\ 0 & 0 & 1 & 0 & 0 & 0 & … & 1 \\ 0 & 0 & 1 & 0 & 1 & 0 & … & 0 \\ 1 & 0 & 0 & 0 & 1 & 1 & … & 1 \\ 0 & 0 & 1 & 1 & 0 & 1 & … & 0 \\ 0 & 0 & 1 & 1 & 1 & 0 & … & 1 \\ 0 & 0 & 1 & 1 & 0 & 0 & … & 0 \\ 0 & 0 & 0 & 1 & 0 & 1 & … & 0\end{matrix} ] \qquad ( 20 )$$

The next step is to turn the parity check matrix into reduced echelon form by using elementary matrix row and column operations so that there are 20 rows representing 20 independent parity check equations for each parity bit as described in standard text-books on error correcting codes, such as The Theory of Error Correcting Codes, F. J. MacWilliams and N. J. A. Sloane, North Holland, 1977 and Error Control Coding, S. Lin and D. J. Costello, Jr., 2nd ed., Pearson Prentice Hall, 2004. From the reduced echelon parity check matrix the generator matrix can be obtained straightforwardly as it is the transpose of the reduced echelon parity check matrix. The resulting generator matrix is

$${G}_{( 32 , 12 , 9 )} = [ \begin{matrix}1 & 0 & 0 & 0 & 0 & 0 & 0 & 0 & 0 & 0 & 0 & 0 & 1 & 1 & 0 & 0 & 0 & 1 & 1 & 1 & 1 & 0 & 1 & 0 & 0 & 1 & 1 & 1 & 0 & 1 & 1 & 0 \\ 0 & 1 & 0 & 0 & 0 & 0 & 0 & 0 & 0 & 0 & 0 & 0 & 1 & 1 & 0 & 1 & 0 & 1 & 1 & 0 & 0 & 0 & 0 & 1 & 1 & 0 & 1 & 0 & 1 & 1 & 0 & 0 \\ 0 & 0 & 1 & 0 & 0 & 0 & 0 & 0 & 0 & 0 & 0 & 0 & 0 & 0 & 1 & 1 & 0 & 0 & 1 & 1 & 0 & 0 & 0 & 0 & 1 & 1 & 0 & 1 & 0 & 0 & 1 & 0 \\ 0 & 0 & 0 & 1 & 0 & 0 & 0 & 0 & 0 & 0 & 0 & 0 & 1 & 1 & 1 & 1 & 1 & 1 & 0 & 1 & 0 & 1 & 0 & 1 & 1 & 0 & 0 & 0 & 1 & 0 & 1 & 0 \\ 0 & 0 & 0 & 0 & 1 & 0 & 0 & 0 & 0 & 0 & 0 & 0 & 1 & 1 & 0 & 0 & 0 & 0 & 1 & 1 & 0 & 1 & 0 & 0 & 1 & 1 & 1 & 0 & 0 & 0 & 0 & 1 \\ 0 & 0 & 0 & 0 & 0 & 1 & 0 & 0 & 0 & 0 & 0 & 0 & 1 & 1 & 1 & 1 & 1 & 0 & 0 & 1 & 1 & 0 & 0 & 0 & 1 & 0 & 1 & 0 & 1 & 0 & 0 & 1 \\ 0 & 0 & 0 & 0 & 0 & 0 & 1 & 0 & 0 & 0 & 0 & 0 & 0 & 0 & 0 & 0 & 1 & 0 & 1 & 1 & 1 & 1 & 1 & 1 & 0 & 0 & 0 & 1 & 1 & 1 & 0 & 0 \\ 0 & 0 & 0 & 0 & 0 & 0 & 0 & 1 & 0 & 0 & 0 & 0 & 0 & 0 & 1 & 1 & 1 & 0 & 0 & 1 & 1 & 0 & 0 & 1 & 1 & 1 & 0 & 0 & 0 & 1 & 0 & 0 \\ 0 & 0 & 0 & 0 & 0 & 0 & 0 & 0 & 1 & 0 & 0 & 0 & 1 & 1 & 1 & 1 & 0 & 1 & 1 & 1 & 1 & 1 & 1 & 1 & 0 & 1 & 1 & 1 & 1 & 1 & 0 & 1 \\ 0 & 0 & 0 & 0 & 0 & 0 & 0 & 0 & 0 & 1 & 0 & 0 & 1 & 1 & 1 & 0 & 1 & 1 & 0 & 1 & 1 & 1 & 1 & 0 & 0 & 1 & 0 & 0 & 1 & 0 & 1 & 1 \\ 0 & 0 & 0 & 0 & 0 & 0 & 0 & 0 & 0 & 0 & 1 & 0 & 0 & 0 & 0 & 1 & 1 & 1 & 0 & 0 & 1 & 1 & 1 & 0 & 1 & 1 & 0 & 0 & 1 & 1 & 0 & 0 \\ 0 & 0 & 0 & 0 & 0 & 0 & 0 & 0 & 0 & 0 & 0 & 1 & 1 & 1 & 1 & 0 & 1 & 1 & 0 & 0 & 1 & 0 & 0 & 1 & 1 & 0 & 1 & 1 & 0 & 1 & 1 & 1\end{matrix} ] \qquad ( 21 )$$

It will be noticed that the generator matrix is in reduced echelon form and has 12 rows, one row for each information bit. Each row is the codeword resulting from that information bit equal to a 1, all other information bits equal to 0.

The next step is to scramble the information bits by multiplying by a k×k non-singular matrix, that is one that is invertible. As a simple example the following 12×12 matrix is invertible:

$${NS}_{12 \times 12} = [ \begin{matrix}0 & 1 & 1 & 1 & 0 & 1 & 0 & 0 & 1 & 1 & 1 & 0 \\ 0 & 0 & 1 & 1 & 1 & 0 & 1 & 0 & 0 & 1 & 1 & 1 \\ 1 & 0 & 0 & 1 & 1 & 1 & 0 & 1 & 0 & 0 & 1 & 1 \\ 1 & 1 & 0 & 0 & 1 & 1 & 1 & 0 & 1 & 0 & 0 & 1 \\ 1 & 1 & 1 & 0 & 0 & 1 & 1 & 1 & 0 & 1 & 0 & 0 \\ 0 & 1 & 1 & 1 & 0 & 0 & 1 & 1 & 1 & 0 & 1 & 0 \\ 0 & 0 & 1 & 1 & 1 & 0 & 0 & 1 & 1 & 1 & 0 & 1 \\ 1 & 0 & 0 & 1 & 1 & 1 & 0 & 0 & 1 & 1 & 1 & 0 \\ 0 & 1 & 0 & 0 & 1 & 1 & 1 & 0 & 0 & 1 & 1 & 1 \\ 1 & 0 & 1 & 0 & 0 & 1 & 1 & 1 & 0 & 0 & 1 & 1 \\ 1 & 1 & 0 & 1 & 0 & 0 & 1 & 1 & 1 & 0 & 0 & 1 \\ 1 & 1 & 1 & 0 & 1 & 0 & 0 & 1 & 1 & 1 & 0 & 0\end{matrix} ] \qquad ( 22 )$$

It is invertible using this matrix:

$${NS}_{12 \times 12}^{- 1} = [ \begin{matrix}1 & 1 & 0 & 1 & 0 & 0 & 0 & 0 & 0 & 0 & 0 & 0 \\ 0 & 1 & 1 & 0 & 1 & 0 & 0 & 0 & 0 & 0 & 0 & 0 \\ 0 & 0 & 1 & 1 & 0 & 1 & 0 & 0 & 0 & 0 & 0 & 0 \\ 0 & 0 & 0 & 1 & 1 & 0 & 1 & 0 & 0 & 0 & 0 & 0 \\ 0 & 0 & 0 & 0 & 1 & 1 & 0 & 1 & 0 & 0 & 0 & 0 \\ 0 & 0 & 0 & 0 & 0 & 1 & 1 & 0 & 1 & 0 & 0 & 0 \\ 0 & 0 & 0 & 0 & 0 & 0 & 1 & 1 & 0 & 1 & 0 & 0 \\ 0 & 0 & 0 & 0 & 0 & 0 & 0 & 1 & 1 & 0 & 1 & 0 \\ 0 & 0 & 0 & 0 & 0 & 0 & 0 & 0 & 1 & 1 & 0 & 1 \\ 1 & 0 & 0 & 0 & 0 & 0 & 0 & 0 & 0 & 1 & 1 & 0 \\ 0 & 1 & 0 & 0 & 0 & 0 & 0 & 0 & 0 & 0 & 1 & 1 \\ 1 & 0 & 1 & 0 & 0 & 0 & 0 & 0 & 0 & 0 & 0 & 1\end{matrix} ] \qquad ( 23 )$$

The next step is to scramble the generator matrix with the non-singular matrix to produce the scrambled generator matrix given below. The code produced with this generator matrix has the same codewords as the generator matrix given by matrix (21) and can correct the same number of errors but there is a different mapping to codewords from a given information bit pattern.

$${SG}_{( 32 , 12 , 9 )} = [ \begin{matrix}0 & 1 & 1 & 1 & 0 & 1 & 0 & 0 & 1 & 1 & 1 & 0 & 1 & 1 & 1 & 0 & 0 & 1 & 0 & 1 & 1 & 1 & 1 & 0 & 0 & 0 & 0 & 0 & 0 & 1 & 1 & 1 \\ 0 & 0 & 1 & 1 & 1 & 0 & 1 & 0 & 0 & 1 & 1 & 1 & 0 & 0 & 0 & 1 & 1 & 0 & 0 & 1 & 1 & 0 & 1 & 0 & 0 & 0 & 1 & 1 & 0 & 1 & 0 & 1 \\ 1 & 0 & 0 & 1 & 1 & 1 & 0 & 1 & 0 & 0 & 1 & 1 & 1 & 1 & 0 & 0 & 1 & 0 & 0 & 1 & 1 & 1 & 0 & 1 & 0 & 0 & 0 & 0 & 1 & 0 & 1 & 1 \\ 1 & 1 & 0 & 0 & 1 & 1 & 1 & 0 & 1 & 0 & 0 & 1 & 0 & 0 & 1 & 1 & 1 & 0 & 1 & 1 & 1 & 1 & 1 & 0 & 0 & 1 & 0 & 0 & 0 & 1 & 0 & 0 \\ 1 & 1 & 1 & 0 & 0 & 1 & 1 & 1 & 0 & 1 & 0 & 0 & 0 & 0 & 0 & 0 & 0 & 1 & 1 & 0 & 0 & 1 & 1 & 0 & 1 & 0 & 0 & 1 & 0 & 0 & 1 & 0 \\ 0 & 1 & 1 & 1 & 0 & 0 & 1 & 1 & 1 & 0 & 1 & 0 & 1 & 1 & 0 & 0 & 0 & 0 & 1 & 1 & 1 & 1 & 1 & 0 & 0 & 0 & 1 & 1 & 1 & 1 & 0 & 1 \\ 0 & 0 & 1 & 1 & 1 & 0 & 0 & 1 & 1 & 1 & 0 & 1 & 1 & 1 & 0 & 0 & 0 & 0 & 0 & 0 & 1 & 1 & 0 & 1 & 0 & 1 & 0 & 1 & 1 & 1 & 0 & 0 \\ 1 & 0 & 0 & 1 & 1 & 1 & 0 & 0 & 1 & 1 & 1 & 0 & 0 & 0 & 0 & 0 & 0 & 1 & 1 & 0 & 1 & 1 & 0 & 0 & 0 & 1 & 0 & 0 & 1 & 1 & 1 & 0 \\ 0 & 1 & 0 & 0 & 1 & 1 & 1 & 0 & 0 & 1 & 1 & 1 & 1 & 1 & 1 & 1 & 1 & 0 & 1 & 0 & 1 & 0 & 1 & 1 & 1 & 1 & 0 & 0 & 1 & 0 & 0 & 0 \\ 1 & 0 & 1 & 0 & 0 & 1 & 1 & 1 & 0 & 0 & 1 & 1 & 1 & 1 & 0 & 0 & 1 & 1 & 0 & 1 & 1 & 1 & 1 & 0 & 0 & 0 & 0 & 0 & 1 & 1 & 1 & 0 \\ 1 & 1 & 0 & 1 & 0 & 0 & 1 & 1 & 1 & 0 & 0 & 1 & 1 & 1 & 0 & 0 & 0 & 1 & 0 & 1 & 1 & 1 & 1 & 0 & 0 & 1 & 0 & 0 & 0 & 0 & 1 & 0 \\ 1 & 1 & 1 & 0 & 1 & 0 & 0 & 1 & 1 & 1 & 0 & 0 & 1 & 1 & 0 & 0 & 0 & 0 & 0 & 0 & 1 & 0 & 1 & 0 & 1 & 0 & 1 & 1 & 1 & 0 & 1 & 1\end{matrix} ] \qquad ( 24 )$$

It may be seen that, for example, the first row of this matrix is the modulo 2 sum of rows 1, 2, 3, 5, 8, 9 and 10 of matrix (21) in accordance with the non-singular matrix (22).

The final step in producing the public key generator matrix for the codewords from the message vectors is to permute the columns of the matrix above. Any permutation may be randomly chosen. For example we may use the following permutation

$$\begin{matrix}\begin{matrix}27 & 15 & 4 & 2 & 19 & 21 & 17 & 14 & 7 & 16 & 20 & 1 & 29 & 8 & 11 & 12 & … \\ 0 & 1 & 2 & 3 & 4 & 5 & 6 & 7 & 8 & 9 & 10 & 11 & 12 & 13 & 14 & 15 & … \\ … & 25 & 5 & 30 & 24 & 6 & 18 & 13 & 3 & 0 & 26 & 23 & 28 & 22 & 31 & 9 & 10 \\ … & 16 & 17 & 18 & 19 & 20 & 21 & 22 & 23 & 24 & 25 & 26 & 27 & 28 & 29 & 30 & 31\end{matrix} & ( 25 )\end{matrix}$$

so that for example column 0 of matrix (24) becomes column 24 of the permuted generator matrix and column 31 of matrix (24) becomes column 29 of the permuted generator matrix. It will be appreciated that the same permutation may be represented by a corresponding permutation matrix and a permutation of an input sequence of bits can be achieved by a matrix multiplication with a permutation matrix.

The resulting, permuted generator matrix is given below:

$${PSG}_{( 32 , 12 , 9 )} = [ \begin{matrix}0 & 0 & 0 & 1 & 1 & 1 & 1 & 1 & 0 & 0 & 1 & 1 & 1 & 1 & 0 & 1 & 0 & 1 & 1 & 0 & 0 & 0 & 1 & 1 & 0 & 0 & 0 & 0 & 1 & 1 & 1 & 1 \\ 1 & 1 & 1 & 1 & 1 & 0 & 0 & 0 & 0 & 1 & 1 & 0 & 1 & 0 & 1 & 0 & 0 & 0 & 0 & 0 & 1 & 0 & 0 & 1 & 0 & 1 & 0 & 0 & 1 & 1 & 1 & 1 \\ 0 & 0 & 1 & 0 & 1 & 1 & 0 & 0 & 1 & 1 & 1 & 0 & 0 & 0 & 1 & 1 & 0 & 1 & 1 & 0 & 0 & 0 & 1 & 1 & 1 & 0 & 1 & 1 & 0 & 1 & 0 & 1 \\ 0 & 1 & 1 & 0 & 1 & 1 & 0 & 1 & 0 & 1 & 1 & 1 & 1 & 1 & 1 & 0 & 1 & 1 & 0 & 0 & 1 & 1 & 0 & 0 & 1 & 0 & 0 & 0 & 1 & 0 & 0 & 0 \\ 1 & 0 & 0 & 1 & 0 & 1 & 1 & 0 & 1 & 0 & 0 & 1 & 0 & 0 & 0 & 0 & 0 & 1 & 1 & 1 & 1 & 1 & 0 & 0 & 1 & 0 & 0 & 0 & 1 & 0 & 1 & 0 \\ 1 & 0 & 0 & 1 & 1 & 1 & 0 & 0 & 1 & 0 & 1 & 1 & 1 & 1 & 0 & 1 & 0 & 0 & 0 & 0 & 1 & 1 & 1 & 1 & 0 & 1 & 0 & 1 & 1 & 1 & 0 & 1 \\ 1 & 0 & 1 & 1 & 0 & 1 & 0 & 0 & 1 & 0 & 1 & 0 & 1 & 1 & 1 & 1 & 1 & 0 & 0 & 0 & 0 & 0 & 1 & 1 & 0 & 0 & 1 & 1 & 0 & 0 & 1 & 0 \\ 0 & 0 & 1 & 0 & 0 & 1 & 1 & 0 & 0 & 0 & 1 & 0 & 1 & 1 & 0 & 0 & 1 & 1 & 1 & 0 & 0 & 1 & 0 & 1 & 1 & 0 & 0 & 1 & 0 & 0 & 1 & 1 \\ 0 & 1 & 1 & 0 & 0 & 0 & 0 & 1 & 0 & 1 & 1 & 1 & 0 & 0 & 1 & 1 & 1 & 1 & 0 & 1 & 1 & 1 & 1 & 0 & 0 & 0 & 1 & 1 & 1 & 0 & 1 & 1 \\ 0 & 0 & 0 & 1 & 1 & 1 & 1 & 0 & 1 & 1 & 1 & 0 & 1 & 0 & 1 & 1 & 0 & 1 & 1 & 0 & 1 & 0 & 1 & 0 & 1 & 0 & 0 & 1 & 1 & 0 & 0 & 1 \\ 0 & 0 & 0 & 0 & 1 & 1 & 1 & 0 & 1 & 0 & 1 & 1 & 0 & 1 & 1 & 1 & 1 & 0 & 1 & 0 & 1 & 0 & 1 & 1 & 1 & 0 & 0 & 0 & 1 & 0 & 0 & 0 \\ 1 & 0 & 1 & 1 & 0 & 0 & 0 & 0 & 1 & 0 & 1 & 1 & 0 & 1 & 0 & 1 & 0 & 0 & 1 & 1 & 0 & 0 & 1 & 0 & 1 & 1 & 0 & 1 & 1 & 1 & 1 & 0\end{matrix} ] \qquad ( 26 )$$

With this particular example of the Goppa code the message needs to be split into message vectors of length 12 bits adding padding bits as necessary so that there is an integral number of message vectors. As a simple example of a message, consider that the message consists of a single message vector with the information bit pattern {0,1,0,1,1,1,0,0,0,0,0,1}.

Starting with an all 0's vector, where the information bit pattern is a 1, the corresponding row from the permuted, scrambled matrix, matrix (26) with the same position is added modulo 2 to the result so far to produce the codeword which will form the digital cryptogram plus added random errors. In this example, this codeword is generated from adding modulo 2, rows 2, 4, 5, 6, and 12 from the permuted, scrambled matrix, matrix (26) to produce:

$$\begin{matrix}\begin{matrix}0 & 0 & 0 & 1 & 1 & 1 & 1 & 1 & 0 & 0 & 1 & 1 & 1 & 1 & 0 & 1 & 0 & 1 & 1 & 0 & 0 & 0 & 1 & 1 & 0 & 0 & 0 & 0 & 1 & 1 & 1 & 1 \\ + & + & + & + & + & + & + & + & + & + & + & + & + & + & + & + & + & + & + & + & + & + & + & + & + & + & + & + & + & + & + & + \\ 0 & 0 & 1 & 0 & 1 & 1 & 0 & 0 & 1 & 1 & 1 & 0 & 0 & 0 & 1 & 1 & 0 & 1 & 1 & 0 & 0 & 0 & 1 & 1 & 1 & 0 & 1 & 1 & 0 & 1 & 0 & 1 \\ + & + & + & + & + & + & + & + & + & + & + & + & + & + & + & + & + & + & + & + & + & + & + & + & + & + & + & + & + & + & + & + \\ 0 & 1 & 1 & 0 & 1 & 1 & 0 & 1 & 0 & 1 & 1 & 1 & 1 & 1 & 1 & 0 & 1 & 1 & 0 & 0 & 1 & 1 & 0 & 0 & 1 & 0 & 0 & 0 & 1 & 0 & 1 & 0 \\ + & + & + & + & + & + & + & + & + & + & + & + & + & + & + & + & + & + & + & + & + & + & + & + & + & + & + & + & + & + & + & + \\ 1 & 0 & 0 & 1 & 0 & 1 & 1 & 0 & 1 & 0 & 0 & 1 & 0 & 0 & 0 & 0 & 0 & 1 & 1 & 1 & 1 & 1 & 0 & 0 & 1 & 0 & 0 & 0 & 1 & 0 & 1 & 0 \\ + & + & + & + & + & + & + & + & + & + & + & + & + & + & + & + & + & + & + & + & + & + & + & + & + & + & + & + & + & + & + & + \\ 1 & 0 & 1 & 1 & 0 & 0 & 0 & 0 & 1 & 0 & 1 & 1 & 0 & 1 & 0 & 1 & 0 & 0 & 1 & 1 & 0 & 0 & 1 & 0 & 1 & 1 & 0 & 1 & 1 & 1 & 1 & 0 \\ ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ & ″ \\ 0 & 1 & 1 & 1 & 1 & 0 & 0 & 0 & 1 & 0 & 0 & 0 & 0 & 1 & 0 & 1 & 1 & 0 & 0 & 0 & 0 & 0 & 1 & 0 & 0 & 1 & 1 & 0 & 0 & 1 & 1 & 0\end{matrix} & ( 27 )\end{matrix}$$

The resulting codeword is

{0 1 1 1 1 0 0 0 1 0 0 0 0 1 0 1 1 0 0 0 0 0 1 0 0 1 1 0 0 1 1 0}.

This Goppa code can correct up to 4 errors, (t=4), so a random number is chosen for the number of bits to be in errors (s) and 2(t−s) bits are deleted from the codeword in pre-determined positions. The pre-determined positions may be given by a secret key, a position vector, known only to the originator and intended recipient of the cryptogram, may be included as part of the public key, or may be contained in a previous cryptogram sent to the recipient. An example of a position vector, which defines the bit positions to be deleted is

{19,3,27,17,8,30,11,15,2,5,19, . . . ,25}.

The notation being, for example, that if there are 2 bits to be deleted, the bit positions to be deleted are the first 2 bit positions in the position vector, 19 and 3. As well as the secret key, the position vector, the recipient needs to know the number of bits deleted, preferably with the information provided in a secure way. One method is for the message vector to contain, as part of the message, a number indicating the number of errors to be deleted in the next codeword, the following codeword (not the current codeword); the first codeword having a known, fixed number of deleted bits.

The number of bit errors and the bit error positions are randomly chosen to be in error. A truly random source such as a thermal noise source as described above produces the most secure results, but a pseudo random generator can be used instead, particularly if seeded from the time of day with fine time resolution such as 1 mS. If the number of random errors chosen is too few, the security of the digital cryptogram will be compromised. Correspondingly the minimum number of errors chosen is a design parameter depending upon the length of the Goppa code and t, the number of correctible errors. A suitable choice for the minimum number of errors chosen in practice lies between t/2 and 3t/4.

For the example above, consider that the number of bit errors is 2 and these are randomly chosen to be in positions 7 and 23 (starting the position index from 0). The bits in these positions in the codeword are inverted to produce the result

{0 1 1 1 1 0 0 1 1 0 0 0 0 1 0 1 1 0 0 0 0 0 1 1 0 1 1 0 0 1 1 0}.

As there are 2 bits in error 4 bits (2(t−s)=2(4−2)) may be deleted. Using the position vector example above the deleted bits are in positions {19, 3, 27 and 17} resulting in 28 bits,

{0 1 1 1 0 0 1 1 0 0 0 0 1 0 1 1 0 0 0 1 1 0 1 1 0 1 1 0}.

This result forms the digital cryptogram which is transmitted or stored depending upon the application.

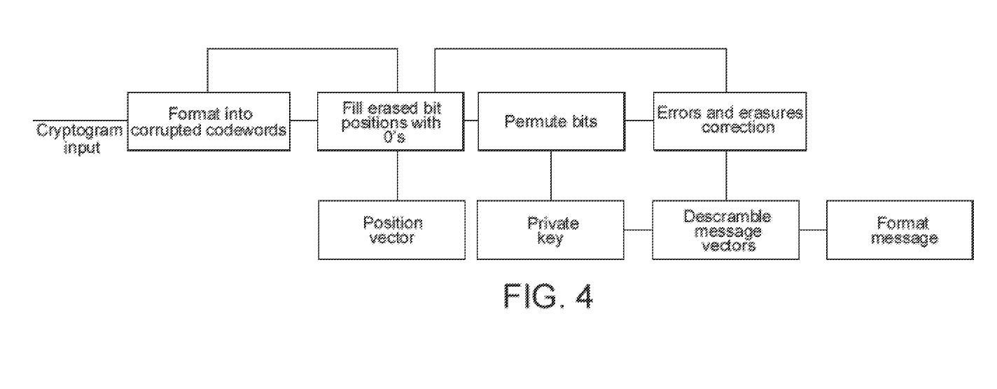

The intended recipient of this cryptogram retrieves the message in a series of steps. FIG. 4 shows the system used for decryption. The retrieved cryptogram is formatted into corrupted codewords by format into corrupted codewords shown in FIG. 4. In the formatting process the number of deleted bits in each codeword is determined from the retrieved length of each codeword. The next step is to insert 0's in the deleted bit positions so that each corrupted codeword is of the correct length. This is carried out by fill erased positions with 0's using as input the position vector stored in a buffer memory as position vector in FIG. 4 plus the number of deleted (erased) bits from format into corrupted codewords. For the example above, the recipient first receives or otherwise retrieves the cryptogram

{0 1 1 1 0 0 1 1 0 0 0 0 1 0 1 1 0 0 0 1 1 0 1 1 0 1 1 0}.

The number of deleted bits and their positions and so inserts 0's in positions {19, 3, 27 and 17} to produce

{0 1 1 0 1 0 0 1 1 0 0 0 0 1 0 1 1 0 0 0 0 0 1 1 0 1 1 0 0 1 1 0}.

The private key contains the information of which Goppa code was used, the inverse of the non-singular matrix used to scramble the data and the permutation applied to codeword symbols in constructing the public key generator matrix. This information is stored in private key in FIG. 4.

For the example, the private key is used to undo the permutation applied to codeword symbols by applying the following permutation:

$$\begin{matrix}\begin{matrix}0 & 1 & 2 & 3 & 4 & 5 & 6 & 7 & 8 & 9 & 10 & 11 & 12 & 13 & 14 & 15 & … \\ 27 & 15 & 4 & 2 & 19 & 21 & 17 & 14 & 7 & 16 & 20 & 1 & 29 & 8 & 11 & 12 & … \\ … & 16 & 17 & 18 & 19 & 20 & 21 & 22 & 23 & 24 & 25 & 26 & 27 & 28 & 29 & 30 & 31 \\ … & 25 & 5 & 30 & 24 & 6 & 18 & 13 & 3 & 0 & 26 & 23 & 28 & 22 & 31 & 9 & 10\end{matrix} & ( 28 )\end{matrix}$$

so that for example bit 24 becomes bit 0 after permutation and bit 27 becomes bit 31 after permutation. The resulting, corrupted codeword is

{0 0 0 1 1 0 0 1 1 1 0 0 1 1 1 1 0 0 0 1 0 0 0 1 0 1 1 0 0 0 0 1}.

The permutation is carried out by permute bits shown in FIG. 4.

The next step is to treat the bits in the corrupted codeword as GF(2⁵) symbols and use the parity check matrix, matrix (19), from the private key to calculate the syndrome value for each row of the parity check matrix to produce α²⁸, α⁷, α¹³, and α¹⁹. This is carried out by an errors and erasures decoder as a first step in correcting the errors and erasures. The errors and erasures are corrected by errors and erasures correction, which knows the positions of the erased bits from fill erased positions with 0's shown in FIG. 4.

In the example the errors and erasures are corrected using the syndrome values to produce the uncorrupted codeword. There are several published algorithms for correcting bit errors and erasures for Goppa codes, for example in “An erasures-and-errors decoding algorithm for Goppa codes”, Y. Sugiyama, M. Kasahara, S. Hirasawa, and T. Namekawa, IEEE Trans. Inform. Theory, vol. IT-22, pp. 238-241, March 1976, “Decoding Goppa codes with a BCH decoder”, C. T. Retter, IEEE Trans. Inform. Theory, vol. IT-21, p. 112, January 1975; Algebraic Coding Theory, E. R. Berlekamp, McGraw-Hill, 1968; and “The algebraic decoding of Goppa codes”, N. J. Patterson, IEEE Transactions on Information Theory 21, p.p. 203-207.

Using, for example, the method described by Sugiyama, the uncorrupted codeword is obtained:

{1 0 0 0 1 0 0 1 1 1 0 0 0 0 1 0 0 1 1 1 0 1 1 0 0 1 1 0 0 1 0 1}

The scrambled information data is the first 12 bits of the codeword

{1 0 0 0 1 0 0 1 1 1 0 0}.

The last step is to unscramble the scrambled data using matrix (23) to produce the original message after formatting the unscrambled data

{0,1,0,1,1,1,0,0,0,0,0,1}.

In FIG. 4 descramble message vectors takes as input the matrix which is the inverse of the non-singular matrix stored in private key and outputs the descramble message vectors to format message.

In practice using the invention much longer codes of length n would be used than described above. Typically n is set equal to 1024, 2048, 4096 bits or longer. Longer codes are more secure but the public key is larger and encryption and decryption takes longer Consider a practical example with n=1024, correcting t=60 bit errors with a randomly chosen irreducible Goppa polynomial of degree 60, say,

g(z)=1+z+z²+z²³+z⁶⁰

Setting the number of inserted bit errors s as a randomly chosen number from 40 to 60, the number of deleted bits correspondingly, is 2(t−s), ranging from 40 to 0 and the average codeword length is 994 bits. There are 9.12×10⁹⁶ different bit error combinations providing security equivalent to a random key of length 325 bits. The message vector length is 424 bits per codeword of which 6 bits may be assigned to indicate the number of deleted bits in the following codeword.

As another example with n=2048 and correcting t=80 bit errors with a randomly chosen irreducible Goppa polynomial of degree 80, an example being

g(z)=1+αz+z³+α⁵z¹⁷+z⁸⁰

Setting the number of inserted bit errors s as a randomly chosen number from 40 to 80, the number of deleted bits correspondingly, is 2(t−s), ranging from 80 to 0 and the average codeword length is 2008 bits. There are 2.45×10¹⁴⁴ different bit error combinations providing security equivalent to a random key of length 482 bits. The message vector length is 1168 bits per codeword of which 7 bits may be assigned to indicate the number of deleted bits in the following codeword.

In a further embodiment of the invention to enhance the security, additional bits in error may be deliberately added to the cryptogram using the secret key, the position vector to determine the positions of the additional error bits. The number of additional bits in error is randomly chosen between 0 and n−1. The recipient needs to know the number of additional bits in error (as well as the position vector), preferably with this information provided in a secure way. One method is for the message vector to contain, as part of the message, the number of additional bits in error in the next codeword, the following codeword (not the current codeword); the first codeword having a known, fixed number of additional bits in error.

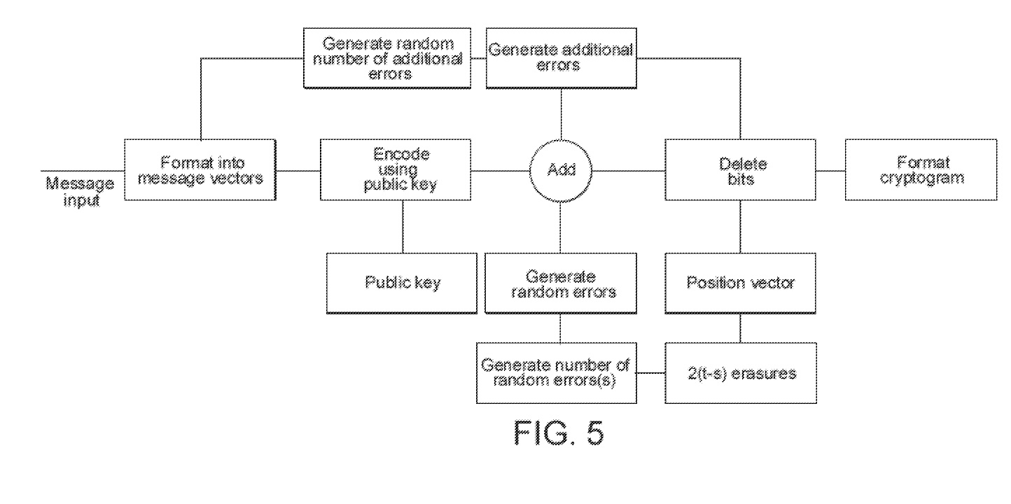

As each corrupted codeword contains more than t bits in error, it is theoretically impossible, even with the knowledge of the private key to recover the original codewords free from errors and to determine the unknown bits in the deleted bit positions. The system is depicted in FIG. 5.

The encryption arrangement is as shown in FIG. 1 except that the system accommodates additional errors added by generate additional errors shown in FIG. 5 using a random integer generator between 0 and n−1 generated by generate random number of additional errors. Any suitable random integer generator may be used. For example, the random integer generator design shown in FIG. 2 may be used with the number of shift register stages p now set equal to m where n=2^{m}. Additional errors may be added in the same positions as random errors, as this provides for a simpler implementation or may take account of the positions of the random errors. However, there is no point in adding additional bit errors to bits which will subsequently be deleted.

As shown in FIG. 5 the number of additional errors is communicated to the recipient as part of the message vector in the preceding codeword with the information included with the message. This is carried out by format into message vectors shown in FIG. 5. In this case usually 1 or 2 more message vectors in total will be required to convey the information regarding numbers of additional errors and the position vector (if this has not been already communicated to the recipient). Clearly there are alternative arrangements to communicate the numbers of additional errors to the recipient such as using a previously agreed sequence of numbers or substituting a pseudo random number generator for the truly random number generator (generate random number of additional errors shown in FIG. 5) with a known seed.

From the example above with the previous position vector

{19,3,27,17,8,30,11,15,2,5,19, . . . ,25}.

In the example above, the errored bits are in positions 7 and 23 (starting the position index from 0) and the deleted bits are in positions {19, 3, 27 and 17}. The encoded codeword prior to corruption is:

{0 1 1 1 1 0 0 0 1 0 0 0 0 1 0 1 1 0 0 0 0 0 1 0 0 1 1 0 0 1 1 0}.

The number of additional bits in error is randomly chosen to be 5, say. As the first 4 positions (index 0 to 3) in the position vector are to be deleted bits, starting from index 4, the bits in codeword positions {8,30,11,15, and 2} are inverted in addition to the errored bits in positions 7 and 23. The 32 bit corrupted codeword is produced:

{0 1 0 1 1 0 0 1 0 0 0 1 0 1 0 0 1 0 0 0 0 0 1 1 0 1 1 0 0 1 0 0}.

The bits in positions {19, 3, 27 and 17} are deleted to produce the 28 bit corrupted codeword:

{0 1 0 1 0 0 1 0 0 0 1 0 1 0 0 1 0 0 0 1 1 0 1 1 0 1 0 0}.

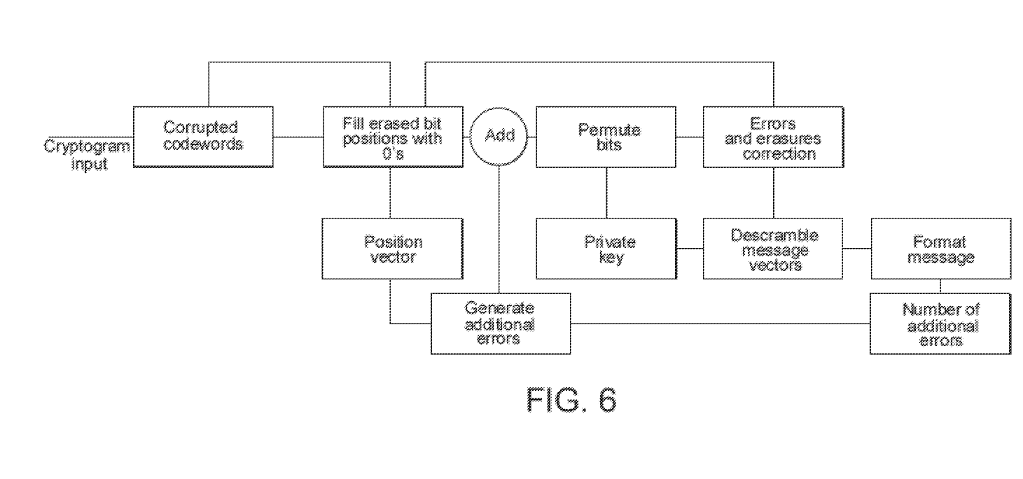

In this embodiment of the invention, the additional bits in error are removed by the recipient of the cryptogram prior to errors and erasures correction as shown in FIG. 6. The number of additional bits in error in the following codewords are retrieved from the descrambled message vectors by format message shown in FIG. 6 and input to number of additional errors which outputs this number to generate additional errors which is the same as in FIG. 5. The position vector is stored in a buffer memory in position vector and outputs this to generate additional errors. Each additional error is corrected by the adder add, shown in FIG. 6, which adds, modulo 2, a 1 which is output from generate additional errors in the same position of each additional error. Retrieval of the message from this point follows correction of the errors and erasures, descrambling and formatting as described for FIG. 5.

Following the example above, using the number of deleted bits and the position vector, 0's are inserted in the deleted bit positions to form the 32 bit corrupted codeword:

{0 1 0 0 1 0 0 1 0 0 0 1 0 1 0 0 1 0 0 0 0 0 1 1 0 1 1 0 0 1 0 0}.

Following the addition of the output from generate additional errors the bits in positions {8, 30, 11, 15, and 2} are inverted, thereby correcting the 5 additional errors to form the corrupted codeword:

{0 1 1 0 1 0 0 1 1 0 0 0 0 1 0 1 1 0 0 0 0 0 1 1 0 1 1 0 0 1 1 0}.

As in the first embodiment of the invention, this corrupted codeword is permuted, the syndromes calculated and the errors plus erasures corrected to retrieve the original message:

{0,1,0,1,1,1,0,0,0,0,0,1}

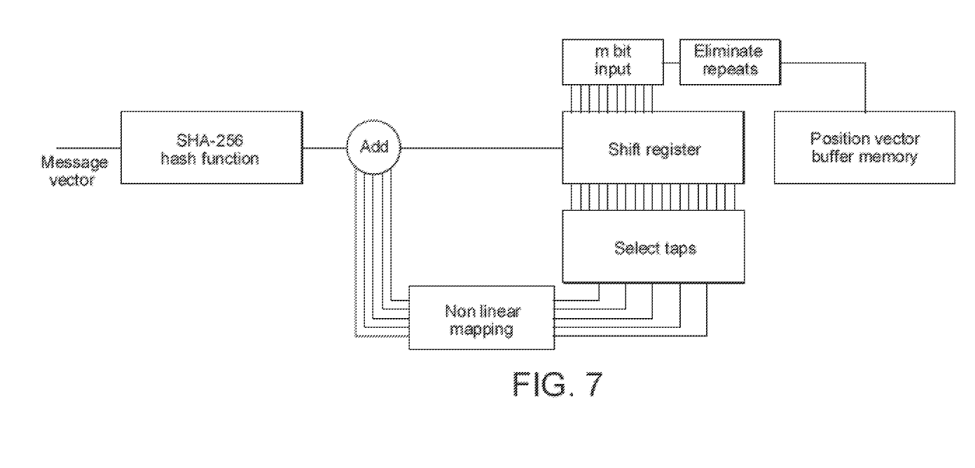

In a further embodiment of the invention the position vector, instead of being a static vector, is derived from a cryptographic hash of a previous message vector. Any standard cryptographic hash function may be used, such as MD5 (RFC 1321, R. Rivest, MIT Laboratory for Computer Science and RSA Data Security, April 1992) or SHA 2 (Secure Hash Standard (SHS), Federal Information Processing Standards Publication 180-4 by the US National Institute of Standards and Technology). Considering, for example use of the SHA-256 (a variant of SHA-2) as shown in FIG. 7. The message vector of length k bits is hashed using SHA-256 to produce a binary hash vector of length 256 bits.

By way of example, the binary hash vector is input to a non-linear feedback shift register consisting of shift register having p stages, typically 64 stages with outputs determined by select taps enabling different scrambling keys to be used by selecting different outputs. the non-linear feedback shift register arrangement to produce a position vector in error positions buffer memory is the same as that of FIG. 3 whose operation is described above.

As the hash vector is clocked in to the non-linear feedback shift register of FIG. 7, a derived position vector is stored in error positions buffer memory, and used for encrypting the message vector as described above. The current message vector is encrypted using a position vector derived from the hash of the previous message vector. As the recipient of the cryptogram has decrypted the previous message vector, the recipient of the cryptogram can use the same hash function and non-linear feedback shift register to derive the position vector in order to decrypt the current corrupted codeword. There are a number of arrangements that may be used for the first codeword. For example a static position vector, known only to the sender and recipient of the cryptogram could be used or alternatively a position vector derived from a fixed hash vector known only to the sender and recipient of the cryptogram or the hash of a fixed message known only to the sender and recipient of the cryptogram. A simpler arrangement may be used where the shift register has no feedback so that the position vector is derived directly from the hash vector. In this case a hash has to be used in which the length of the hash vector exceeds n, the length of the codeword.

In a further embodiment of the invention, to enhance the security of the system, in addition to scrambling using the non-singular matrix implicitly contained in the Public Key, each message vector is independently scrambled using a scrambler which is derived from the random error vector which will be added to the codeword resulting from encoding with the scrambled generator matrix. In this embodiment of the invention the random error vector is generated first before the codeword is constructed by encoding with the scrambled generator matrix.

This scrambler which is derived from the error vector, for each message vector, may be implemented in a number of ways. The message vector may be scrambled by multiplying by a k×k non-singular matrix derived from the error vector.

Alternatively, the message vector may be scrambled by treating the message vector as a polynomial m₁(x) of degree k−1 and multiplying it by a circulant polynomial p₁(x) modulo 1+x^{k} which has an inverse, as discussed in the above-referenced MacWilliams and Sloane text-book. The circulant polynomial p₁(x) is derived from the error vector. Denoting the inverse of the circulant polynomial p₁(x) as q₁(x) then

p₁(x)q₁(x)=1 modulo 1+x^{k} (29)

Accordingly the scrambled message vector is m₁(x)p₁(x) which is encoded into a codeword using the scrambled generator matrix. Each message vector is scrambled a different way as the error patterns are random and different from corrupted codeword to corrupted codeword. The corrupted codewords form the cryptogram as in the other embodiments of the invention.

On decoding of each codeword, the corresponding error vector is obtained with retrieval of the scrambled message vector. Considering the above example, the circulant polynomial p₁(x) is derived from the error vector and the inverse q₁(x) is calculated using Euclid's method from p₁(x), for example as described in the above-referenced textbook by MacWilliams and Sloane. The original message vector is obtained by multiplying the retrieved scrambled message vector m₁(x)p₁(x) by p₁(x) because

m₁(x)p₁(x)q₁(x)=m₁(x)modulo 1+x^{k} (30)

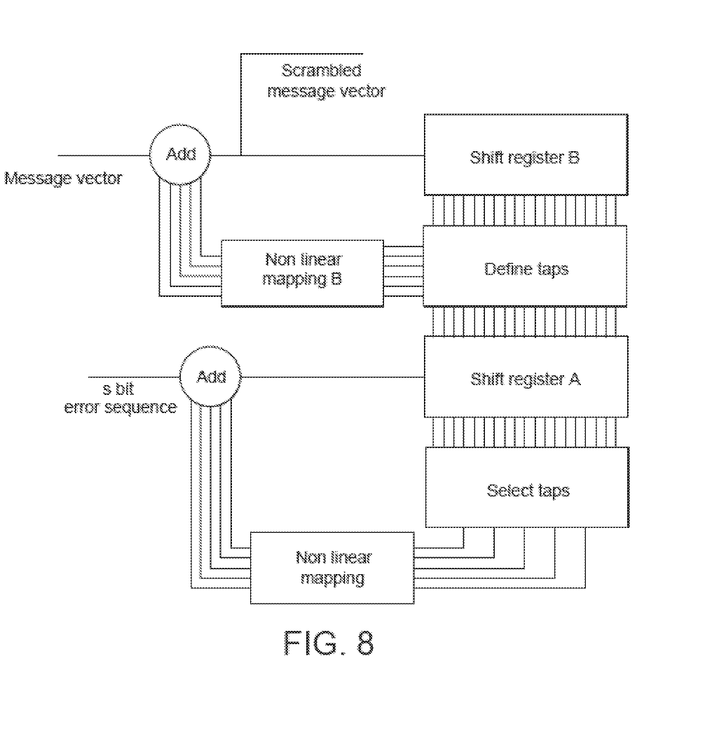

Another example of scrambling each message vector using a scrambler derived from the error vector is to use two non-linear feedback shift registers as shown in FIG. 8. The first operation is for the error vector, which is represented as a s bit sequence is input to a modulo 2 adder add whose output is input to shift register A as shown in FIG. 8. The non-linear feedback shift registers are the same as in FIG. 3 with operation as described above but select taps will usually have a different setting and non linear mapping also will usually have a different mapping, but this is not essential. After clocking the s bit error sequence into the non-linear feedback shift register, shift register A shown in FIG. 8 will essentially contain a random binary vector. This vector is used by define taps to define which outputs of shift register B are to be input to non linear mapping B whose outputs are added modulo 2 to the message vector input to form the input to shift register B shown in FIG. 8. The scrambling of the message vector is carried out by a non-linear feedback shift register whose feedback connections are determined by a random binary vector derived from the error vector, the s bit error sequence.

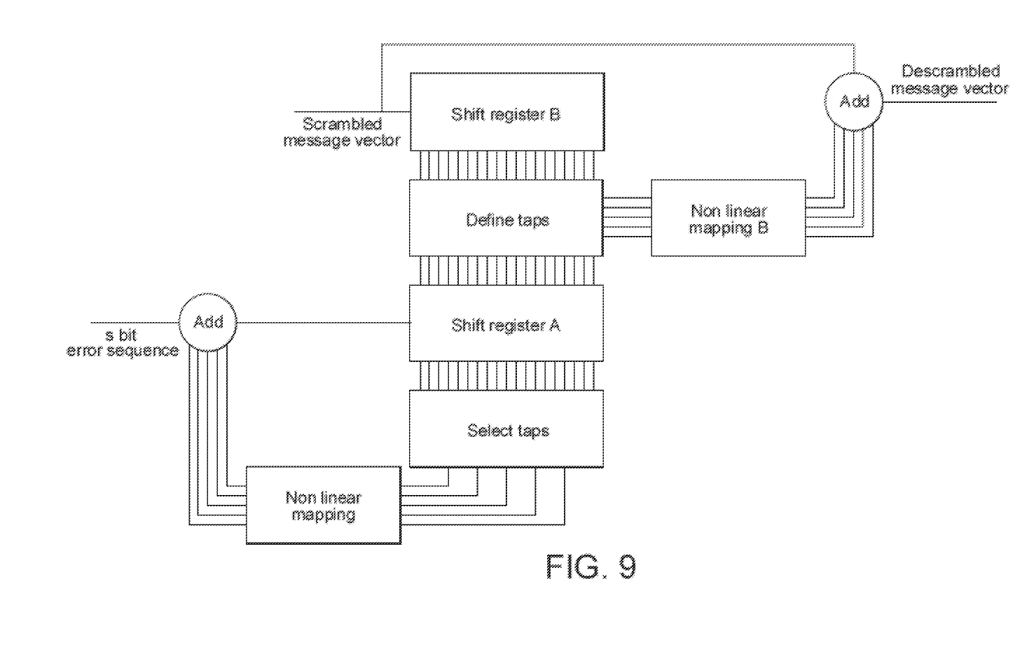

The corresponding descrambler is shown in FIG. 9. Following decoding of each corrupted codeword, having correcting the random errors and bit erasures the scramble message vector is obtained and the error vector in the form of the s bit error sequence. As in the scrambler, the s bit error sequence is input to a modulo 2 adder add whose output is input to shift register A as shown in FIG. 9. After clocking the s bit error sequence into the non-linear feedback shift register, shift register A shown in FIG. 9 will contain exactly the same binary vector as shift register A of FIG. 8. Consequently exactly the same outputs of shift register B to be input to non linear mapping B will be defined by define taps. Moreover comparing the input of shift register B of the scrambler in FIG. 8 to the input of shift register B of the descrambler in FIG. 9, it will be seen that the contents are identical and equal to the scrambled message vector.

Consequently the same selected shift register outputs will be identical and with the same non-linear mapping non linear mapping B the outputs of non linear mapping B in FIG. 9 will be identical to those that were the outputs of non linear mapping B in FIG. 8. The result of the addition of these outputs modulo 2 with the scrambled message vector is to produce the original message vector at the output of add in FIG. 9. This is carried out for each scrambled message vector and associated error vector to recover the original message.

In some applications a reduced size cryptogram is essential perhaps due to limited communications or storage capacity. For these applications a further embodiment of the invention may be used in which the cryptogram consists of only one corrupted codeword containing random errors, the first codeword. The following codewords are corrupted by only deleting bits. The number of deleted bits is 2t bits per codeword using a position vector as described above.

For example with n=1024, and the Goppa code correcting t=60 bit errors, there are 2t bits deleted per codeword so that apart from the first corrupted codeword, each corrupted codeword is only 904 bits long and conveys 624 message vector bits per corrupted codeword.

In another example with n=2048 and correcting t=80 bit errors apart from the first corrupted codeword, each corrupted codeword is only 1888 bits long and conveys 1168 message vector bits per corrupted codeword.

In a further embodiment of the invention with the aim of minimising the cryptogram size for a given message the cryptogram consists of only one corrupted codeword containing random errors, the first codeword. The error vector of the first codeword is used to derive a scrambler for the following message vector as described above. All of the message vectors following the first codeword are scrambled using this scrambler and the scrambled message vectors are appended to the first corrupted codeword to form the cryptogram. For example with n=2048 and a Goppa code correcting t=80 bit errors and 11 message vectors of length 1168 bits, assuming no deleted bits in the first codeword, the cryptogram is only 2048+10×1168=13728 bits long and conveys 12848 bits.

Decryption is carried out by using the private key to retrieve the first codeword and its associated error pattern, deriving the descrambler from the error pattern and descrambling the scrambled message vectors to retrieve the message.

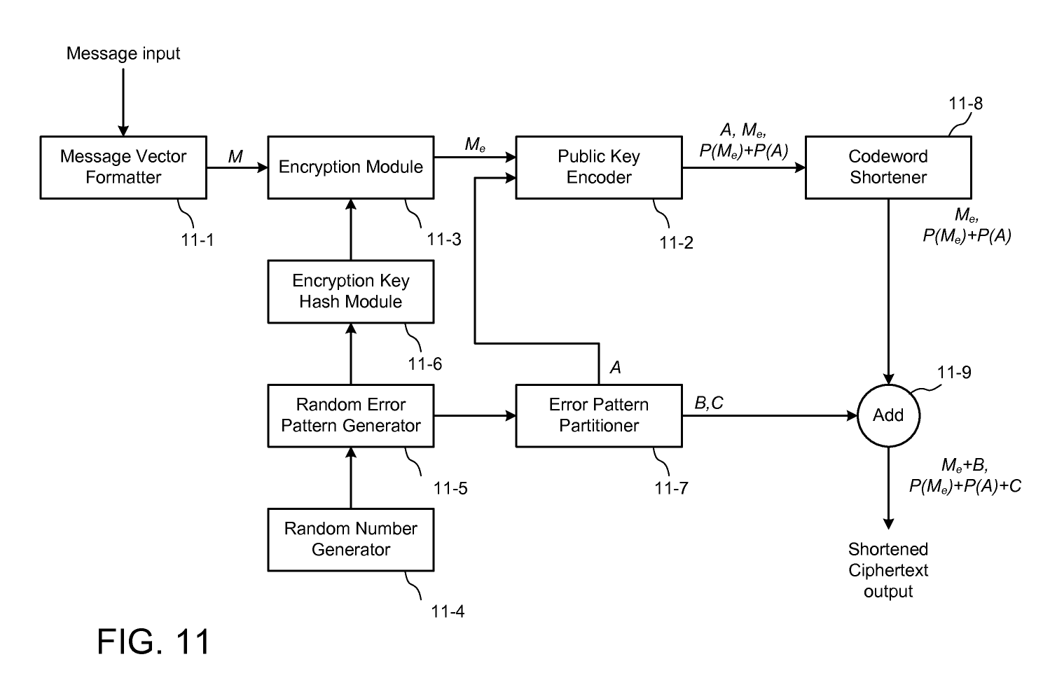

A further embodiment will now be described of an alternative technique of reducing the length of the cryptogram. The method of encryption according to this alternative embodiment of the invention is shown in FIG. 11, in which blocks represent code modules such as subroutines or function calls, executed by programmable hardware, similar to the systems in the embodiments described above with reference to FIGS. 1 and 5. It will be appreciated that the described systems may instead be implemented as a dedicated encryption and/or decryption hardware system.

As shown in FIG. 11, the system receives an input message, which may be a data vector consisting of a sequence of bits. The received message is input to a message vector formatter module 11-1, which may pad the vector with a number of trailing zeros as necessary. In this embodiment, the message vector formatter module 11-1 partitions the message into an integral number of blocks, each block having a predefined number of kₛ bits, where kₛ is a predefined smaller number of information bits with a corresponding reduction k−kₛ in the length of the shortened cryptogram. This embodiment is similar to the embodiments described above with reference to FIG. 1, in that the formatted message block M is then encoded using a public key encoder 11-2, before the encoded codewords are corrupted with bit errors in random positions and shortened. However, in this alternative technique, each codeword is corrupted by adding the random bit errors in two stages, and consequently the way in which the corrupted codewords are shortened is also different, as will be described in more detail below for a specific example.

Preferably, an encryption module 11-3 is provided to encrypt each message block of kₛ bits into an encrypted output (Mₑ) of kₛ bits, which is passed to the public key encoder 11-2. For example, a fixed scrambler may be used to provide a one to one mapping between the 2^{k}^{ₛ} possible message vectors and the 2^{k}^{ₛ} scrambled message vectors such that the reverse mapping, which is provided by the descrambler, used in decryption, produces error multiplication if there are any errors present. For many messages some information can be gained if no scrambler is used even if the message contains errors. The scrambler and corresponding descrambler prevents information being gained this way from the cryptogram itself or by means of some error guessing strategy for decryption by an interceptor. The descrambler is preferably designed to have the property that it produces descrambled message vectors having a large Hamming distance between vectors for input scrambled message vectors which differ in a small number of bit positions.

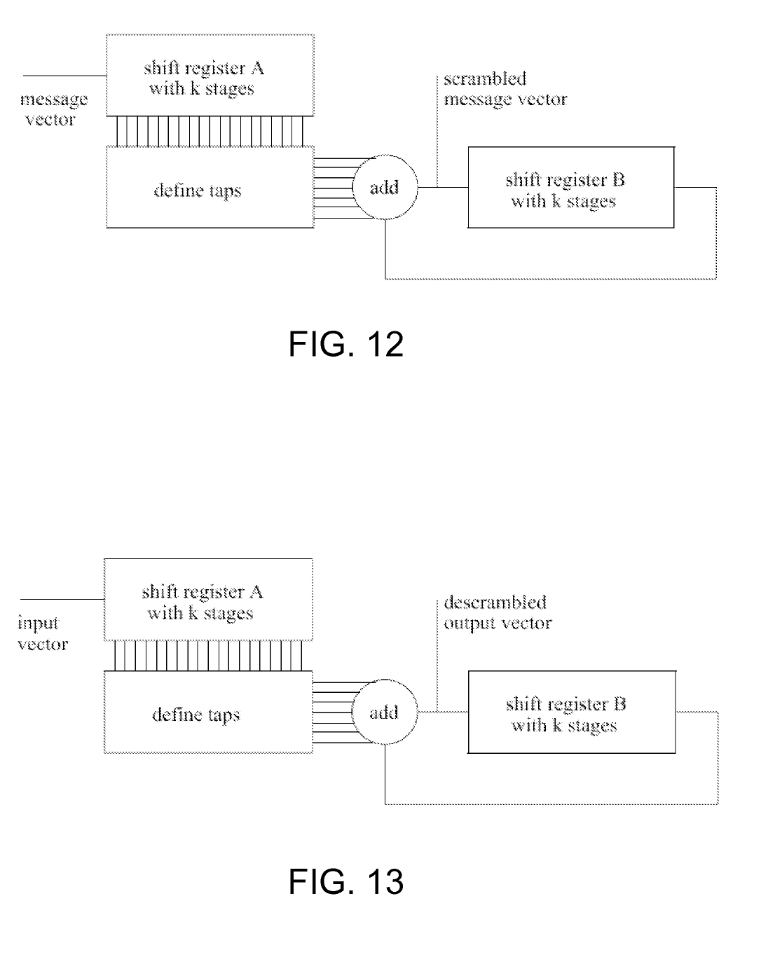

There are a number of different techniques of realising such a scrambler and descrambler. One method is to use symmetric key encryption, such as the Advanced Encryption Standard (AES) with a fixed key, as discussed in the textbook The Design of Rijndael: AES—The Advanced Encryption Standard, by J. Daemen and V. Rijmen, Springer 2002. Another exemplary scrambler arrangement is shown in FIG. 12. A similar arrangement may be used for descrambling but with different taps, for example as shown in FIG. 13. Denoting each k bit message vector as a polynomial m(x) of degree k−1:

m(x)=m₀+m₁x+m₂x²+m₃x³+ . . . +mₖ₋₁x^{k-1} (31)

and denoting the tap positions determined by define taps of FIG. 4 by μ(x) where

μ(x)=μ₀+μ₁x+μ₂x²+μ₃x³+ . . . +μₖ₋₁x^{k-1} (32)

where the coefficients μ₀ through to μₖ₋₁ have binary values of 1 or 0.

The output of the scrambler, denoted by the polynomial, scram(x), is the scrambled message vector given by the polynomial multiplication

scram(x)=m(x)·μ(x)modulo(1+x^{k}) (33)

The scrambled message vector may be produced by the arrangement shown in FIG. 12 after the blocks shift register A with k stages and shift register B with k stages have been clocked 2k times and is present at the input of the block shift register B with k stages whose last stage output is connected to the adder, adder input. The input of shift register B with k stages corresponds to the scrambled message vector for the next additional k clock cycles, with these bits defining the binary coefficients of scram(x). The descrambler arrangement is shown in FIG. 13 and is a similar circuit to that of the scrambler but with different tap settings. The descrambler may be used in decryption of input vectors.

A worked example will now be given of an exemplary scrambler polynomial, μ(x), for k=12:

μ(x)=1+x+x⁴+x⁵+x⁸+x⁹+x¹¹ (36)

For brevity, the binary coefficients may be represented as a binary vector. In this example μ(x) is represented as {1 1 0 0 1 1 0 0 1 1 0 1}. This is a good scrambler polynomial because it has a relatively large number of taps (7 taps) and its inverse, the descrambler polynomial also has a relatively large number of taps (7 taps). The corresponding descrambler polynomial, θ(x) is

θ(x)=1+x+x³+x⁴+x⁷+x⁸+x¹¹ (37)

which may be represented by the binary vector {1 1 0 1 1 0 0 1 1 0 0 1}. It is straightforward to verify that

$$\begin{matrix}μ ( x ) \times θ ( x ) = 1 + {x}^{2} + {x}^{3} + {x}^{4} + {x}^{5} + {x}^{6} + {x}^{8} + {x}^{10} + \\ {x}^{14} + {x}^{15} + {x}^{16} + {x}^{17} + {x}^{18} + {x}^{20} + {x}^{22} \\ = 1 modulo ( 1 + {x}^{k} )\end{matrix} \qquad ( 38 )$$

and so

scram(x)×θ(x)=m(x)modulo(1+x^{k}) (39)

As a simple example of a message, consider that the message consists of a single message vector with the information bit pattern {0,1,0,1,0,0,0,0,0.0,0,1} and so:

m(x)=x+x³+x¹¹ (40)

This is input to the scrambling arrangement shown in FIG. 12. The scrambled message output is scram(x)=m(x)×μ(x) given by

$$\begin{matrix}scram ( x ) = ( 1 + x + {x}^{4} + {x}^{5} + {x}^{8} + {x}^{9} + {x}^{11} ) \cdot \\ ( x + {x}^{3} + {x}^{5} + {x}^{11} ) \\ = x + {x}^{2} + {x}^{5} + {x}^{6} + {x}^{9} + {x}^{10} + {x}^{12} + \\ {x}^{3} + {x}^{4} + {x}^{7} + {x}^{8} + {x}^{11} + {x}^{12} + {x}^{14} + \\ {x}^{11} + {x}^{12} + {x}^{13} + {x}^{16} + {x}^{19} + {x}^{20} + {x}^{22} \\ modulo ( 1 + {x}^{12} ) \\ = 1 + x + {x}^{5} + {x}^{6} + {x}^{9}\end{matrix} \qquad ( 41 )$$

and the scrambling arrangement shown in FIG. 12 produces the scrambled message comprising bit pattern {1,1,0,0,0,1,1,0,0,1,0,0}.

Referring back to FIG. 11, for each message vector M of kₛ bits, a random number generator 11-4 outputs random numbers within the range 0 to 2^{m}−1, which define the positions of each of the t errors to be added to the encrypted codeword Mₑ. It will be appreciated that in an arrangement where the encryption module 11-3 is omitted, the bit errors would instead be added to the formatted message vector M. Any suitable random number generator 11-4 may be used, for example, the random integer generator shown in FIG. 2. The generated random numbers are output to a random error pattern generator 11-5, which generates truly random positions in the range of 0 to 2^{m}−1 corresponding to the codeword length. The output of the random error pattern generator 11-5 is a sequence of n bits containing t 1's and n−t 0's, associated with a respective message vector M The error pattern may be passed to an encryption key hash module 11-6, which is used to calculate and output kₛ bits representing a digest, also referred to as a hash, of the input n bits. The output of the hash module 11-6 may then be used as the binary vector defining binary coefficients of the scrambler polynomial for the encryption module 11-3.

In this embodiment, the n bit error pattern generated by the random error pattern generator 11-5 is received by an error pattern partitioner 11-7, which splits the received error pattern into three distinct data portions: a first portion (A) consisting the first k−kₛ bits, a second portion (B) consisting the middle kₛ bits, and a third portion (C) consisting the last n−k bits, which corresponds to the number of parity bits calculated by the public key encoder 11-2. The first k−kₛ bits of the error pattern forming the first portion A are input to the public key encoder 11-2 and prepended to the respective encrypted message vector Mₑ of length kₛ bits. It will be appreciated that in the simplified alternative where the encryption module 11-3 is not implemented, the first portion (A) of the error pattern would instead be appended before the formatted message vector M of length kₛ bits.

The prepended encrypted message vector A,Mₑ of length k bits is encoded by the public key encoder 11-2 to output a codeword, consisting of the bits from the first portion (A) of the error pattern and the encrypted message vector Mₑ, followed by calculated parity bits P(Mₑ)+P(A) of the prepended encrypted message vector A,Mₑ. As discussed in the embodiments above, the public key encoder 11-2 encodes the input message data using matrix multiplication to form a codeword vector, based on a reduced echelon generator matrix, which in turn is based on a permuted, scrambled generator matrix from a particular instance of a Goppa code of a predefined length of n bits, able to correct a predefined number of t errors. The particular Goppa code, the particular permutation, and the particular scrambling matrices form the private key which is used in the decryption of cryptograms produced by the present embodiment.

The codeword output of the public key encoder (A, Mₑ, P(Mₑ)+P(A)) is passed to a codeword shortener module 11-8, which calculates and outputs a shortened corrupted codeword consisting of n−k+kₛ bits only, where the first k−kₛ bits of the codeword are omitted or deleted. Deleting these bits corrupts the codeword as well as shortening it because the result is no longer a codeword. As will be explained in further detail below with reference to a specific example, the corrupted shortened codewords each consist of the kₛ bits of the corresponding encrypted message block (Mₑ), followed by n−k parity bits resulting from the addition of the parity bits P(Mₑ)+P(A), which has the property that the shortened corrupted codeword has the same syndrome as a full length codeword corrupted by the addition of the first portion A error pattern.

The n−k+kₛ bits of each corrupted shortened codeword are input to a modulo 2 adder 11-9, where each corrupted shortened codeword is further corrupted by adding to it the second (B) and third (C) portions of the error pattern to generate a respective shortened cryptogram output consisting of Mₑ+B, P(Mₑ)+P(A)+C). It will be appreciated that the modulo 2 adder 11-9 may be implemented by using an exclusive or gate.

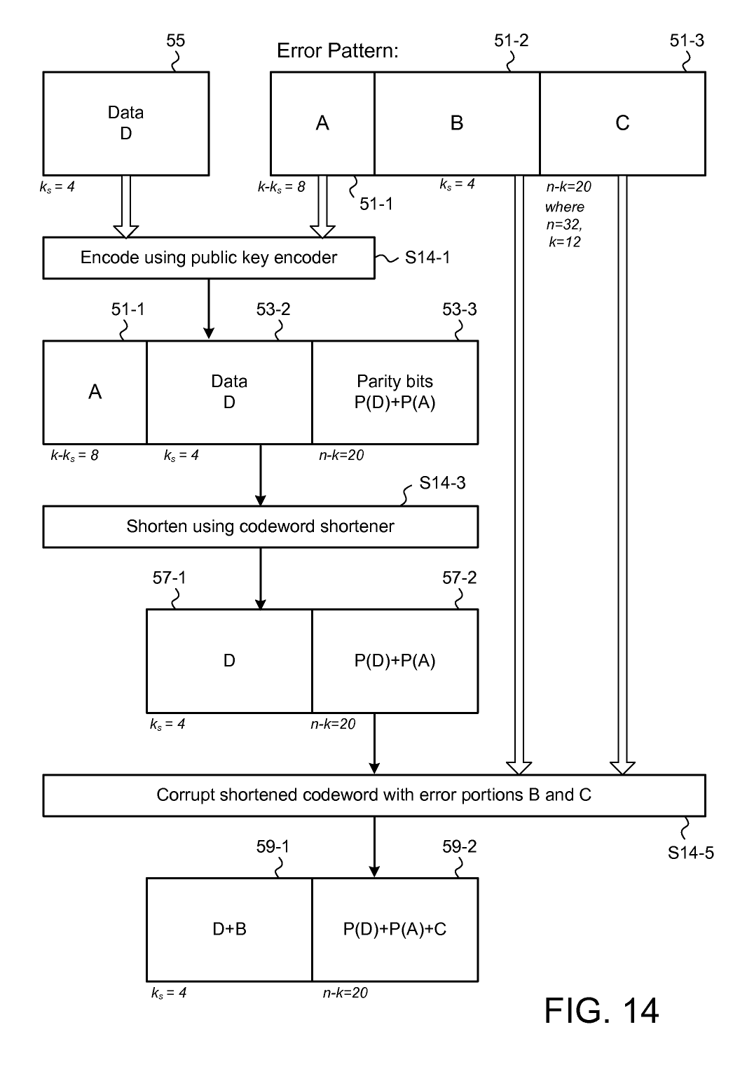

FIG. 14 is a block flow diagram schematically illustrating the computer-implemented codeword shortening process using the system of FIG. 11. As shown in FIG. 14, the composition of a random error pattern 51 is illustrated in terms of the partitioned error pattern portions (or vectors) A 51-1, B 51-2 and C 51-3. FIG. 14 also shows the composition of a codeword 53 resulting from partial error pattern portion A 51-1 and a message vector D data block 55 being encoded by the public key encoder 11-2 at step S14-1. In the present exemplary embodiment, the message data D is not encrypted prior to encoding by the public key encoder 11-2. The codeword 53 includes a parity bits portion 53-3 comprising the parity bits calculated by the public key encoder 11-2, from the message data D and the first portion A of the error pattern 51-1. The composition of a shortened and further corrupted codeword 57 is also shown, resulting from the codeword 53 being shortened by the codeword shortener 11-8 at step S14-3, by omitting the first k−kₛ bits of the codeword 53, formed by the bits from the first error portion A 51-1. At step S14-5, the shortened codeword 57 is subsequently further corrupting by adding error portions B and C, 51-2 and 51-3 to the data portion 57-1 and the parity bits portion 57-2 of the shortened codeword 57, respectively. Taking component vectors from these, the composition of a shortened cryptogram 59, which is output by the present alternative embodiment, is shown in FIG. 14. The shortened cryptogram 59 has the property that it has the same syndrome as the conventional, longer cryptogram produced by a McEliece cryptosystem using the same Goppa code, scrambling and permutation matrices for the same error pattern. In the present example, a smaller reduced echelon k×(n−k), (12×20) matrix may be derived first and split into two parts to form the public key. Firstly, rows of matrix (26) can be added together using modulo 2 arithmetic so as to produce a matrix with k independent columns. This matrix is a permuted reduced echelon matrix which may be straightforwardly derived by using the Gauss-Jordan variable elimination procedure. There are a large number of possible solutions which may be derived and candidate column positions may be selected either in consecutive order to determine a solution or optionally, permuted in random order to arrive at a random solution.

Consider as an example selecting candidate column positions in consecutive order. Following from the permuted generator matrix (26) in the worked example above, the following permuted reduced echelon generator matrix is produced:

$${PSGR}_{( 32 , 12 , 9 )} = [ \begin{matrix}1 & 0 & 0 & 0 & 0 & 0 & 0 & 0 & 0 & 0 & 0 & 0 & 0 & 1 & 0 & 0 & 1 & 1 & 0 & 1 & 0 & 1 & 0 & 1 & 0 & 0 & 0 & 1 & 1 & 1 & 1 & 1 \\ 0 & 1 & 0 & 0 & 0 & 0 & 0 & 0 & 0 & 0 & 1 & 0 & 0 & 0 & 0 & 0 & 1 & 0 & 0 & 1 & 0 & 0 & 0 & 1 & 0 & 0 & 1 & 0 & 1 & 1 & 1 & 0 \\ 0 & 0 & 1 & 0 & 0 & 0 & 0 & 0 & 0 & 0 & 0 & 0 & 0 & 1 & 0 & 1 & 0 & 0 & 1 & 0 & 1 & 1 & 1 & 1 & 0 & 0 & 1 & 1 & 0 & 0 & 0 & 0 \\ 0 & 0 & 0 & 1 & 0 & 0 & 0 & 0 & 0 & 0 & 1 & 1 & 0 & 1 & 0 & 0 & 1 & 0 & 1 & 0 & 0 & 0 & 0 & 1 & 0 & 1 & 0 & 0 & 0 & 0 & 1 & 0 \\ 0 & 0 & 0 & 0 & 1 & 0 & 0 & 0 & 0 & 0 & 0 & 1 & 0 & 1 & 0 & 0 & 1 & 1 & 1 & 1 & 0 & 1 & 0 & 0 & 1 & 0 & 0 & 0 & 1 & 0 & 0 & 1 \\ 0 & 0 & 0 & 0 & 0 & 1 & 0 & 0 & 0 & 0 & 0 & 1 & 0 & 0 & 0 & 0 & 0 & 1 & 0 & 0 & 1 & 1 & 0 & 1 & 1 & 1 & 1 & 1 & 1 & 1 & 0 & 1 \\ 0 & 0 & 0 & 0 & 0 & 0 & 1 & 0 & 0 & 0 & 1 & 1 & 0 & 0 & 0 & 0 & 0 & 0 & 1 & 0 & 1 & 1 & 0 & 0 & 1 & 0 & 0 & 1 & 1 & 0 & 0 & 1 \\ 0 & 0 & 0 & 0 & 0 & 0 & 0 & 1 & 0 & 0 & 1 & 1 & 0 & 1 & 0 & 0 & 1 & 1 & 1 & 1 & 1 & 1 & 0 & 0 & 0 & 1 & 1 & 0 & 0 & 1 & 1 & 1 \\ 0 & 0 & 0 & 0 & 0 & 0 & 0 & 0 & 1 & 0 & 0 & 0 & 0 & 0 & 0 & 0 & 0 & 1 & 1 & 0 & 1 & 0 & 0 & 1 & 1 & 0 & 1 & 1 & 0 & 0 & 1 & 1 \\ 0 & 0 & 0 & 0 & 0 & 0 & 0 & 0 & 0 & 1 & 1 & 0 & 0 & 0 & 0 & 1 & 1 & 1 & 0 & 0 & 1 & 0 & 1 & 1 & 1 & 0 & 0 & 1 & 0 & 1 & 0 & 0 \\ 0 & 0 & 0 & 0 & 0 & 0 & 0 & 0 & 0 & 0 & 0 & 0 & 1 & 0 & 0 & 1 & 1 & 0 & 1 & 0 & 1 & 0 & 1 & 1 & 1 & 1 & 0 & 0 & 0 & 1 & 1 & 1 \\ 0 & 0 & 0 & 0 & 0 & 0 & 0 & 0 & 0 & 0 & 0 & 0 & 0 & 0 & 1 & 1 & 0 & 1 & 0 & 1 & 0 & 1 & 1 & 1 & 1 & 1 & 0 & 1 & 0 & 1 & 1 & 0\end{matrix} ] \qquad ( 42 )$$

The permutation defined by the following input and output bit position sequences is used to rearrange the columns of the permuted, reduced echelon generator matrix.

$$\begin{matrix}\begin{matrix}0 & 1 & 2 & 3 & 4 & 5 & 6 & 7 & 8 & 9 & 12 & 14 & 10 & 11 & 13 & 15 & 16 & 17 & 18 & 19 & 20 & 21 & 22 & 23 & 24 & 25 & 26 & 27 & 28 & 29 & 30 & 31 \\ 0 & 1 & 2 & 3 & 4 & 5 & 6 & 7 & 8 & 9 & 10 & 11 & 12 & 13 & 14 & 15 & 16 & 17 & 18 & 19 & 20 & 21 & 22 & 23 & 24 & 25 & 26 & 27 & 28 & 29 & 30 & 31\end{matrix} & ( 43 )\end{matrix}$$

This permutation produces a classical reduced echelon generator matrix denoted as Q_{(32,12,9)}

$${Q}_{( 32 , 12 , 9 )} = [ \begin{matrix}1 & 0 & 0 & 0 & 0 & 0 & 0 & 0 & 0 & 0 & 0 & 0 & 0 & 0 & 1 & 0 & 1 & 1 & 0 & 1 & 0 & 1 & 0 & 1 & 0 & 0 & 0 & 1 & 1 & 1 & 1 & 1 \\ 0 & 1 & 0 & 0 & 0 & 0 & 0 & 0 & 0 & 0 & 0 & 0 & 1 & 0 & 0 & 0 & 1 & 0 & 0 & 1 & 0 & 0 & 0 & 1 & 0 & 0 & 1 & 0 & 1 & 1 & 1 & 0 \\ 0 & 0 & 1 & 0 & 0 & 0 & 0 & 0 & 0 & 0 & 0 & 0 & 0 & 0 & 1 & 1 & 0 & 0 & 1 & 0 & 1 & 1 & 1 & 1 & 0 & 0 & 1 & 1 & 0 & 0 & 0 & 0 \\ 0 & 0 & 0 & 1 & 0 & 0 & 0 & 0 & 0 & 0 & 0 & 0 & 1 & 1 & 1 & 0 & 1 & 0 & 1 & 0 & 0 & 0 & 0 & 1 & 0 & 1 & 0 & 0 & 0 & 0 & 1 & 0 \\ 0 & 0 & 0 & 0 & 1 & 0 & 0 & 0 & 0 & 0 & 0 & 0 & 0 & 1 & 1 & 0 & 1 & 1 & 1 & 1 & 0 & 1 & 0 & 0 & 1 & 0 & 0 & 0 & 1 & 0 & 0 & 1 \\ 0 & 0 & 0 & 0 & 0 & 1 & 0 & 0 & 0 & 0 & 0 & 0 & 0 & 1 & 0 & 0 & 0 & 1 & 0 & 0 & 1 & 1 & 0 & 1 & 1 & 1 & 1 & 1 & 1 & 1 & 0 & 1 \\ 0 & 0 & 0 & 0 & 0 & 0 & 1 & 0 & 0 & 0 & 0 & 0 & 1 & 1 & 0 & 0 & 0 & 0 & 1 & 0 & 1 & 1 & 0 & 0 & 1 & 0 & 0 & 1 & 1 & 0 & 0 & 1 \\ 0 & 0 & 0 & 0 & 0 & 0 & 0 & 1 & 0 & 0 & 0 & 0 & 1 & 1 & 1 & 0 & 1 & 1 & 1 & 1 & 1 & 1 & 0 & 0 & 0 & 1 & 1 & 0 & 0 & 1 & 1 & 1 \\ 0 & 0 & 0 & 0 & 0 & 0 & 0 & 0 & 1 & 0 & 0 & 0 & 0 & 0 & 0 & 0 & 0 & 1 & 1 & 0 & 1 & 0 & 0 & 1 & 1 & 0 & 1 & 1 & 0 & 0 & 1 & 1 \\ 0 & 0 & 0 & 0 & 0 & 0 & 0 & 0 & 0 & 1 & 0 & 0 & 1 & 0 & 0 & 1 & 1 & 1 & 0 & 0 & 1 & 0 & 1 & 1 & 1 & 0 & 0 & 1 & 0 & 1 & 0 & 0 \\ 0 & 0 & 0 & 0 & 0 & 0 & 0 & 0 & 0 & 0 & 1 & 0 & 0 & 0 & 0 & 1 & 1 & 0 & 1 & 0 & 1 & 0 & 1 & 1 & 1 & 1 & 0 & 0 & 0 & 1 & 1 & 1 \\ 0 & 0 & 0 & 0 & 0 & 0 & 0 & 0 & 0 & 0 & 0 & 1 & 0 & 0 & 0 & 1 & 0 & 1 & 0 & 1 & 0 & 1 & 1 & 1 & 1 & 1 & 0 & 1 & 0 & 1 & 1 & 0\end{matrix} ] \qquad ( 44 )$$

In the present worked example, the codeword length n is 32 bits and the total number of information bits k is equal to 12. However, a smaller number of bits kₛ=4 is predefined for each formatted message vector, for this worked example, with a corresponding reduction of k−ks=8 bits in the codeword length.

As shown in FIG. 14, the public key encoder 11-2 receives, at step S14-1, the data vector D of length kₛ=4 bits, shown as a data portion 55, and the first error portion A of length k−kₛ=8 bits, shown as block 51-1. The public key encoder 11-2 encodes the associated error vector portion A and the message vector D, with the reduced echelon k×n generator matrix to form a codeword vector of length n bits. The 20 parity bits of the codeword calculated using the generator matrix (44) are P(D)+P(A), shown as block 53-3 in FIG. 14. This codeword is shortened at step S14-3 by the codeword shortener deleting the first 8 bits of the codeword. As a result a shortened, corrupted codeword of length 24 bits is produced comprising 4 bits, D, 57-1 followed by 20 bits, P(D)+P(A), 57-2.

Errors in bit positions k−kₛ+1 to position k are designated as error portion B, 51-2 in FIG. 14 corresponding to bit positions 9 to 12 in this example. Error portion C, 51-3 corresponds to bit positions 13 to 32, the parity bit positions. The shortened codeword is corrupted with error portions B and C, at step S14-5, by a vector wide modulo 2 adder which adds error portions B and C to the respective bits of the shortened corrupted codeword. The result is a shortened further corrupted codeword comprising a first portion 59-1 formed by D+B, followed by a second portion 59-2 comprising the 20 parity bits corresponding to P(D)+P(A) plus error portion C which are the errors in the parity bit positions, as shown in FIG. 14. The cryptogram is n−k+kₛ bits long (24 bits long) since it does not contain error portion A, 51-1, contained within the first 8 bits 53-1 of the codeword 53, in this example.

In a typical implementation of the standard McEliece cryptosystem, the cryptogram would be constructed by adding errors to the 32 bit codeword and as this code can correct 4 errors, 4 errors can be added in random bit positions. For the present worked example, the error positions are 0, 2, 9 and 31. So in this example:
error portion A 51-1 is 1 0 1 0 0 0 0 0,
error portion B 51-2 is 0 1 0 0, and
error portion C 51-3 is 0 0 0 0 0 0 0 0 0 0 0 0 0 0 0 0 0 0 0 1.

Consider the particular case that the data message vector, D, 55 the 4 information bits, is 1 0 0 1. Using the encoding matrix (44), the public key encoder S14-1 generates the following codeword of length 32 bits from error pattern portion A and the data message vector D:

1 0 1 0 0 0 0 0 1 0 0 1 0 0 0 0 1 1 0 0 0 1 0 0 0 1 0 0 1 0 1 0 (45)

So that a first portion 51-1 corresponding to error pattern portion A is 1 0 1 0 0 0 0 0, a second portion 53-2 corresponding to data D 55 is 1 0 0 1, and a third portion 53-3 corresponding to calculated parity bits P(D)+P(A) is 0 0 0 0 1 1 0 0 0 1 0 0 0 1 0 0 1 0 1 0

In understanding the invention it should be noted that the syndrome of any codeword is equal to zero and as the base field is 2, the syndrome of an error pattern in the first k−kₛ positions is equal to the syndrome of an error pattern corresponding to the parity bits of a codeword formed by encoding the error pattern in the first k−kₛ positions. In this example, the error pattern

1 0 1 0 0 0 0 0 0 0 0 0 0 0 0 0 0 0 0 0 0 0 0 0 0 0 0 0 0 0 0 0 (46)

has the same syndrome as the error pattern

0 0 0 0 0 0 0 0 0 0 0 0 0 0 0 1 1 1 1 1 1 0 1 0 0 0 1 0 1 1 1 1 (47)

because the sum of these two error patterns is a codeword. It is a basic property in coding theory that each codeword has a syndrome equal to zero. Hence if two error patterns sum to a codeword the syndrome of each error pattern is equal to the negative of the other (equal to the other for a binary base field). The codeword (45) is shortened at step S14-3 by the codeword shortener 11-8 by deleting the first 8 bits of the codeword. to produce

1 0 0 1 0 0 0 0 1 1 0 0 0 1 0 0 0 1 0 0 1 0 1 0 (48)

This is input to the adder 11-9 at step S14-5 to further corrupt the shortened codeword with error portions B and C, where the errors that are not in the first k−kₛ positions (i.e. the errors in positions 10 through to 32) are added by inverting bits of the codeword in these positions to produce the 24 bit cryptogram

1 1 0 1 0 0 0 0 1 1 0 0 0 1 0 0 0 1 0 0 1 0 1 1 (49)

This corresponds to D+B, 59-1, followed by P(D)+P(A)+C, 59-2, shown in FIG. 14.

It will be appreciated by a person skilled in the art that the same cryptogram may be constructed by using a 8×20 sub-matrix of the encoder generator matrix (44) operating on A to produce parity bits P(A) and a 4×20 sub-matrix of the encoder generator matrix (44) operating on D to produce parity bits P(D) and use modulo 2 addition with B and C to produce the cryptogram D+B, followed by P(D)+P(A)+C.

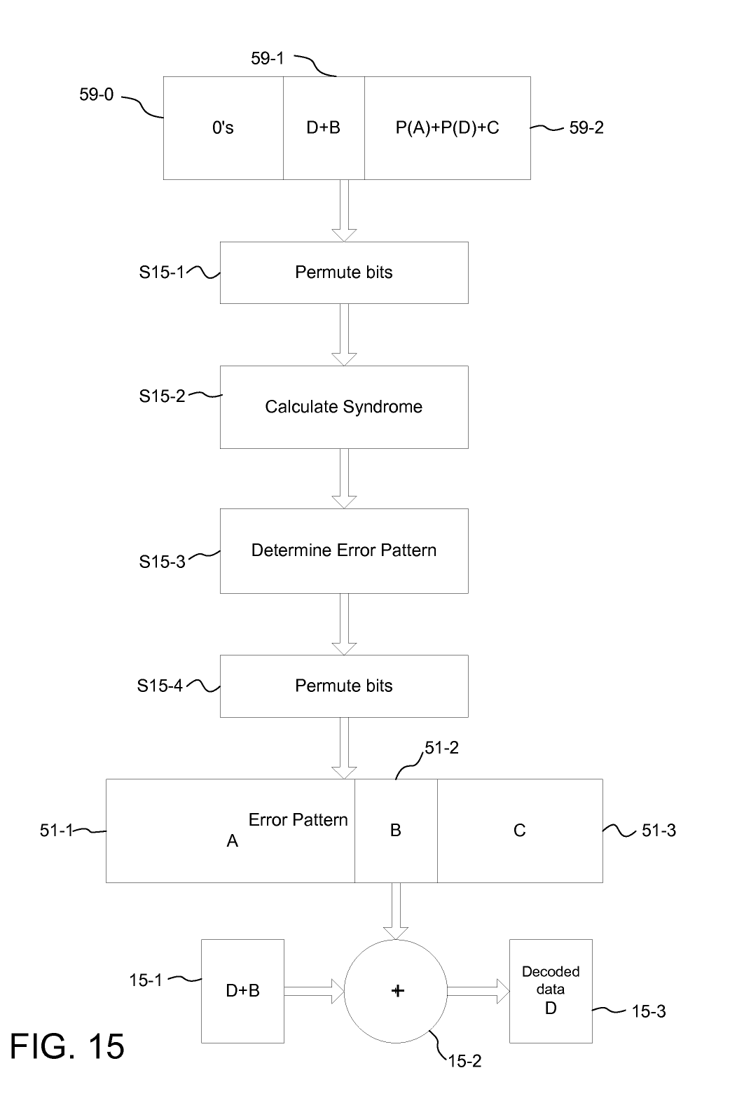

The decryption of the cryptogram constructed using the first alternative embodiment is shown in outline form in FIG. 15, the cryptogram 59, consisting of D+B, 59-1, followed by P(A)+P(D)+C, 59-2, is first padded with 8 leading zeros 59-0 to form a 32 bit cryptogram.

0 0 0 0 0 0 0 0 1 1 0 1 0 0 0 0 1 1 0 0 0 1 0 0 0 1 0 0 1 0 1 1 (53)

The inverse permutation is carried out using an inverse permutation matrix, at step S15-1, which forms part of the private key as described above. The syndrome is then calculated, at step S15-2, and the error pattern determined, at step S15-3, by using the original Goppa code, also part of the private key, in a standard error correction decoder for Goppa codes. Using the private key, the permutation is applied at step S15-4 to the error pattern found by the decoder to determine the error pattern, which in this example is

1 0 1 0 0 0 0 0 0 1 0 0 0 0 0 0 0 0 0 0 0 0 0 0 0 0 0 0 0 0 0 1.

This corresponds to the original error pattern portions A 51-1, B 51-2, and C 51-3, as shown in FIG. 15. The error pattern portion B 51-2, {0 1 0 0} is added to the received first portion 15-1 of the cryptogram corresponding to D+B, {1 1 0 1}, using the modulo 2 adder, 15-2, cancelling out the errors to recover the decoded data D 15-3, {1 0 0 1}, as shown in FIG. 15.

It will be appreciated that in the worked examples of the present embodiments, the codeword is defined as having a length of n=32 bits and able to correct up to t=4 bit errors. It will be appreciated that codewords in practice will be significantly longer. For example, the described systems may be designed to implement a Goppa code of length n=2048 bits, having n−k=660 parity bits able to correct t=60 bit errors, with message blocks of reduced length kₛ=256 bits. In such an example, the parameters for the alternative embodiments would be defined as k=1388 and k−kₛ=1132 bits, with the total length of each shortened corrupted codeword n−k+kₛ=916 bits.

The encryption and decryption arrangement of the first alternative embodiment has two limitations. Firstly apart from bits in error caused by partial error pattern B, 51-2, the message data D appears as plaintext in the cryptogram and secondly that bit errors in partial error portions A, 51-1 and C, 51-3 do not affect the message data, D contained in the cryptogram.

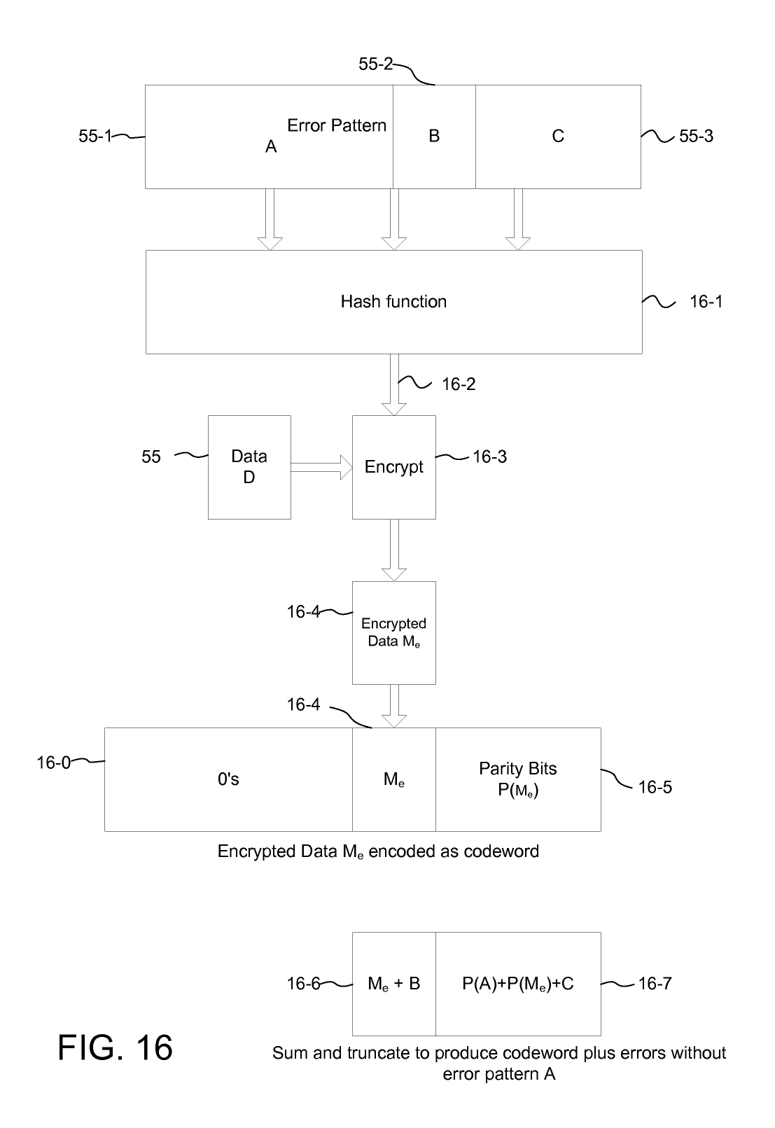

These limitations are addressed in a second alternative embodiment that will now be described with reference to FIG. 16, using corresponding reference numerals to those of preceding figures where appropriate for corresponding elements. In this alternative encryption arrangement, another layer of encryption is included in which the message data is separately encrypted into Mₑ 16-4 shown in FIG. 16. The encryption key, 16-2 for this encryption is provided by a digest, a hash function of the complete error pattern composed of A, 55-1, B, 55-2 and C, 55-3 as shown in FIG. 16.

There are many examples of digests which may be used. It is common to use hash functions as a digest. FIG. 16 shows a hash function, 16-1, being used to derive the encryption key, 16-2 from the combined error pattern, A, 55-1, B, 55-2 and C, 55-3. Some suitable hash functions are published in the Secure Hash Standard (SHS), Federal Information Processing Standards Publication 180-4 by the US National Institute of Standards and Technology.

Using the same example as that above, the combined error pattern A 55-1, B, 55-2 and C, 55-3 is

1 0 1 0 0 0 0 0 0 1 0 0 0 0 0 0 0 0 0 0 0 0 0 0 0 0 0 0 0 0 0 1

Consider that the hash function output, 16-2 is 0 1 1 0

Using the hash function output as the encryption key 16-2, 0 1 1 0, the data D 55, 1 0 0 1 is encrypted by the Encrypt block 16-3 to produce encrypted data Mₑ 16-4. Consider that the encrypted data is 1 1 1 1 in this example. To produce encrypted data, one of the many standard methods of symmetric key encryption may be used. AES is a commonly used example of symmetric encryption system where there is a secret key, that is used to encrypt the plaintext into ciphertext and the same key is used to decrypt the ciphertext back to the plaintext.

As shown in FIG. 16, the encrypted message data Mₑ 16-4 is padded with zeros 16-0 and encoded into a codeword using the generator matrix (44). An alternative is to simply encode Mₑ 16-4 using a sub-matrix of the generator matrix (44). The complete codeword in this worked example is

0 0 0 0 0 0 0 0 1 1 1 1 1 0 0 1 0 1 0 1 1 1 1 0 0 0 1 1 0 1 1 0

The parity bits of this codeword are P(Mₑ) 16-5.

1 0 0 1 0 1 0 1 1 1 1 0 0 0 1 1 0 1 1 0

The 24 bit cryptogram is formed by truncating the 8 leading zeros, adding modulo 2 the error pattern B to Mₑ to form 16-6 which is 1 0 1 1 followed by the modulo 2 sum of the parity bits resulting from encoding A using a sub-matrix of the generator matrix (44), P(A), 16-7,

0 0 0 1 1 1 1 1 1 0 1 0 0 0 1 0 1 1 1 1

and adding parity bits P(Mₑ) and partial error portion C. The complete 24 bit cryptogram is

1 0 1 1 1 0 0 0 1 0 1 0 0 1 0 0 0 0 0 1 1 0 0 0

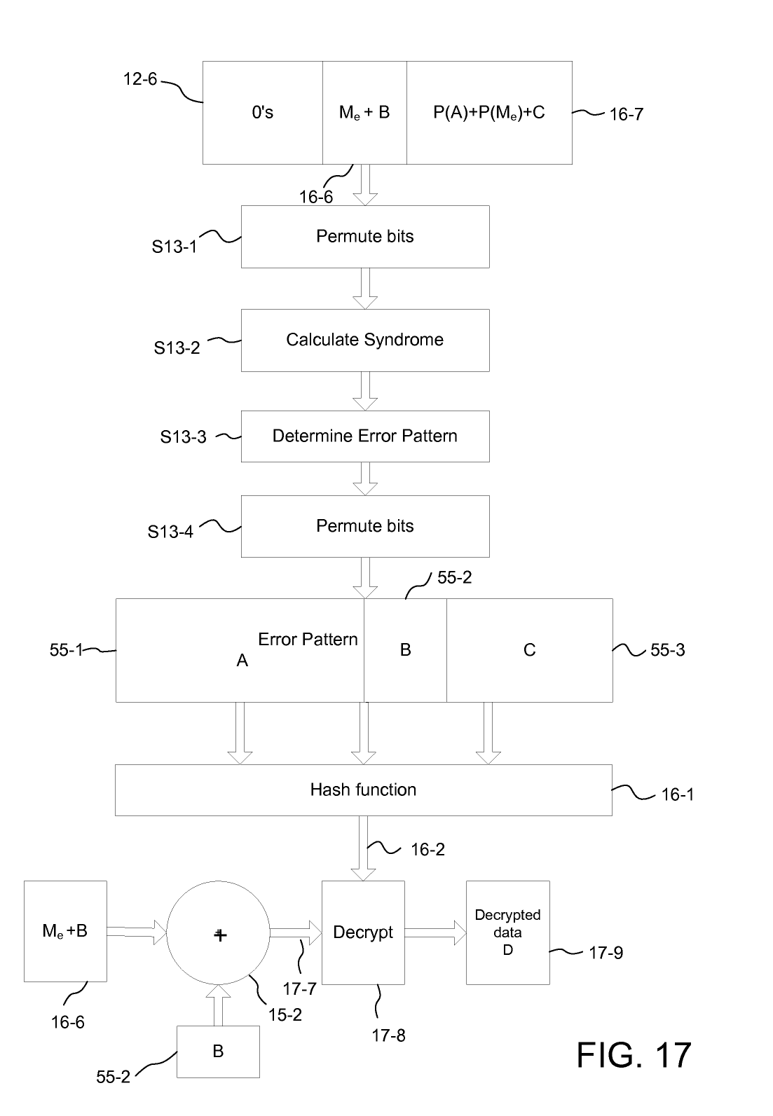

In this second alternative embodiment, the process followed in decryption is shown in FIG. 17. The 24 bit cryptogram is appended with 8 leading zeros and the resulting 32 bit vector is permuted so as to put the bits in the same order as the original Goppa code. As described above with reference to FIG. 17, in the present alternative embodiment, the inverse permutation is carried out using an inverse permutation matrix, at step S13-1, which is part of the private key. The syndrome is then calculated, at step S13-2, and the error pattern determined, at step S13-3, by using the original Goppa code, also part of the private key, in a standard Goppa code, error correction decoder. Using the private key the permutation, at step S13-4 is applied to the error pattern found by the decoder to determine the error pattern used for encryption. In this example the error pattern is

1 0 1 0 0 0 0 0 0 1 0 0 0 0 0 0 0 0 0 0 0 0 0 0 0 0 0 0 0 0 0 1.

This corresponds to A, 55-1, B, 55-2 and C, 55-3 as shown in FIG. 17 and this is input to the hash function 16-1 to produce the hash output, 16-2, which is the decryption key, 0 1 1 0 in this example. The error pattern portion B 55-2, 0 1 0 0 is added to portion 16-6, Mₑ+B of the cryptogram 1 0 1 1 using the modulo 2 adder, 15-2, cancelling out the error to produce the decoded, encrypted data Mₑ, 17-7, 1 1 1 1. This is decrypted as shown in FIG. 17 by decryption (descrambler) block 17-8 to produce the decrypted message data D, 17-9, 1 0 0 1 in this example.

It should be noted that there are alternative methods of deriving the encryption key from an error pattern instead of using a hash function. For example a simple mapping function or look up table could be used instead. Also it should be noted that the key used in decryption of the encrypted message data is identical to the key used to encrypt the message data in the first place, as in the example AES method.

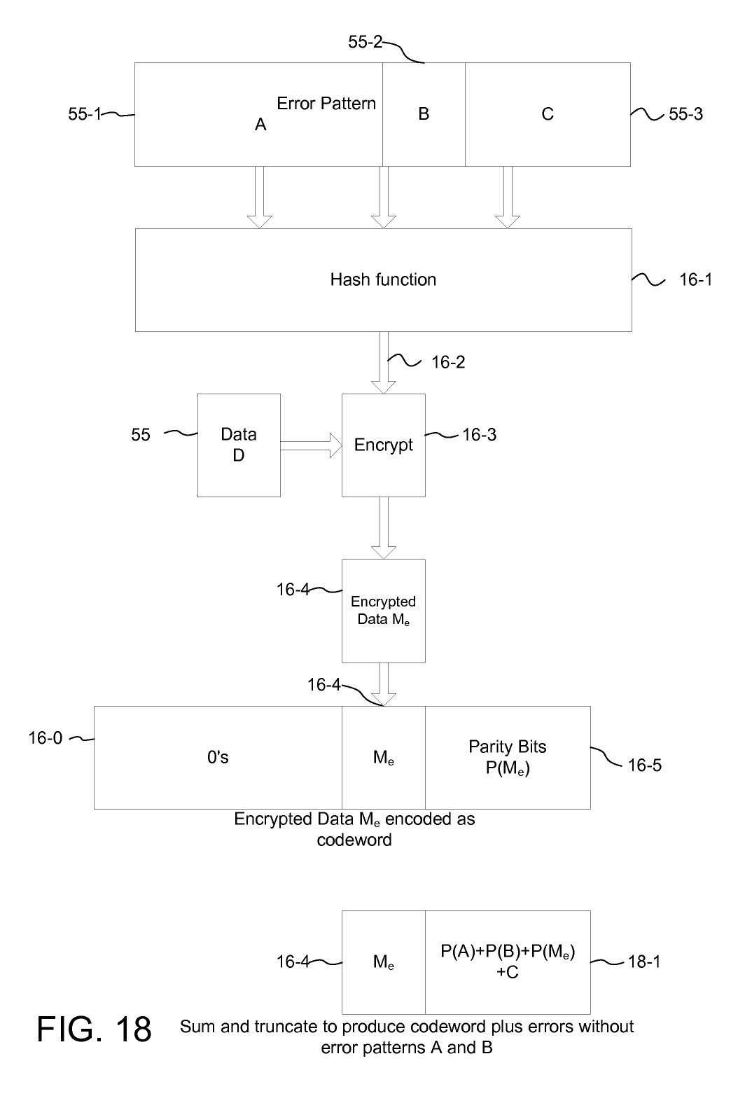

The construction of the cryptogram used in a third alternative embodiment of the invention will now be described with reference to FIG. 18, using corresponding reference numerals to those of preceding figures where appropriate for corresponding elements. This cryptogram format is similar to that of the second alternative embodiment described with reference to FIG. 16, except that the partial error pattern B, 55-2 is not added to the encrypted data Mₑ, 16-4. Instead partial error portions A and B are recombined together and encoded into a codeword using the public key encoding matrix (44). With the same error pattern example as before A, 55-1 is 1 0 1 0 0 0 0 0 and error pattern B, 55-2 is 0 1 0 0. Recombined together they form 1 0 1 0 0 0 0 0 0 1 0 0 and after encoding, the resulting codeword is

1 0 1 0 0 0 0 0 0 1 0 0 1 0 0 0 0 0 1 1 0 0 0 1 1 0 1 1 1 0 1 1

Of this codeword the parity bits P(A)+P(B) are

1 0 0 0 0 0 1 1 0 0 0 1 1 0 1 1 1 0 1 1

The next step is to encode Mₑ, 16-4 as a codeword either using a generator sub-matrix or as shown in FIG. 18 by appending zeros 16-0 and using the public key encoding matrix (44). In this example Mₑ is 1 1 1 1 and the shortened codeword after removing the pre-pended 8 zeros is

1 1 1 1 1 0 0 1 0 1 0 1 1 1 1 0 0 0 1 1 0 1 1 0

and the parity bits P(Mₑ), 16-5 are

1 0 0 1 0 1 0 1 1 1 1 0 0 0 1 1 0 1 1 0

These parity bits, P(Mₑ) are added modulo 2 to parity bits P(A)+P(B) to form P(A)+P(B)+P(Mₑ)

with the result: 0 0 0 1 0 1 1 0 1 1 1 1 1 0 0 0 1 1 0 1

Lastly error portion C which is 0 0 0 0 0 0 0 0 0 0 0 0 0 0 0 0 0 0 0 1 is added to P(A)+P(B)+P(Mₑ) to produce P(A)+P(B)+P(Mₑ)+C, 18-1:

0 0 0 1 0 1 1 0 1 1 1 1 1 0 0 0 1 1 0 0

Preceded by Mₑ, 16-4 as shown in FIG. 18, the complete 24 bit cryptogram is

1 1 1 1 0 0 0 1 0 1 1 0 1 1 1 1 1 0 0 0 1 1 0 1

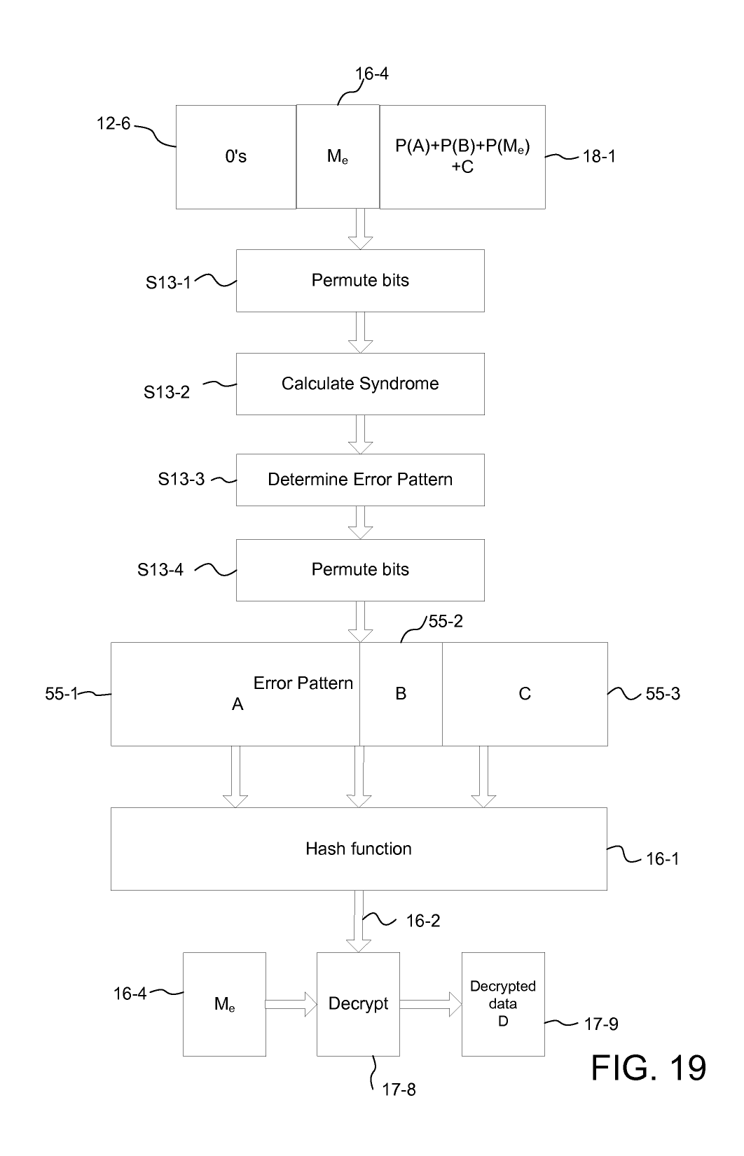

The decryption system for the third alternative embodiment is shown in FIG. 19. After padding with leading zeros, the cryptogram is permuted using the inverse permutation matrix which is stored as part of the private key and the syndrome calculated. The permuted codeword comprising Mₑ and P(Mₑ) has a syndrome of zero so that the composite error pattern determined from the syndrome after reapplying the permutation is error pattern A, 55-1, followed by B, 55-2, and C, 55-3 as shown in FIG. 19. This is input to the hash function 16-1 to produce the decryption key, 16-2. In this example the decryption key is 0 1 1 0. The encrypted data Mₑ 16-4 is partitioned from the cryptogram and decrypted by Decrypt block, 17-8, to produce the Decrypted data D, 17-9, which is 1 0 0 1 in this example.

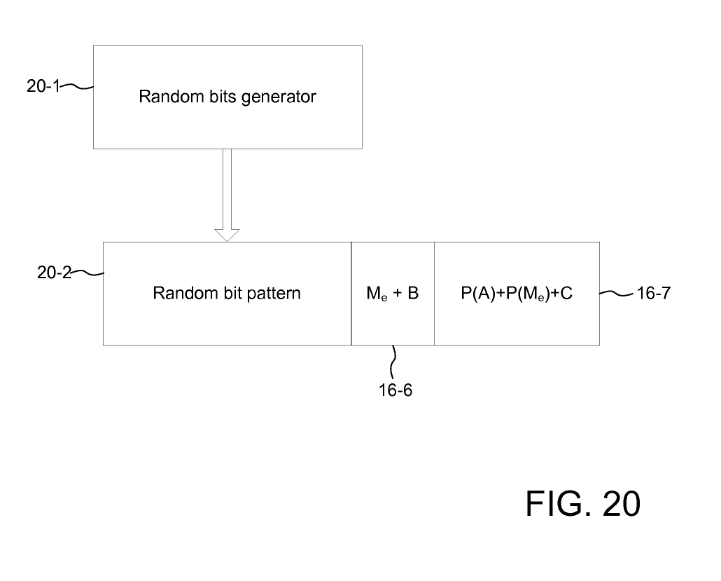

In all of the above alternative embodiments, the cryptogram has been shortened compared to the McEliece original cryptosystem. The best method of attacking the McEliece cryptosystem is information set decoding which is based on repeatedly choosing k bits at random from the cryptogram in the hope that the chosen k bits are all error free, then generating a codeword from these k bits and checking that this codeword differs from the cryptogram in exactly t bit positions. Information set decoding may be defeated in a fourth alternative embodiment of the invention by restoring the length of the cryptogram to that of the original system by pre-pending the cryptogram with random bits as shown in FIG. 20 to form a new cryptogram. The Random bits generator, 20-1 produces a random bit pattern, 20-2 so that the cryptogram consists of the random bit pattern 20-2, followed by Mₑ+B, 16-6 and P(A)+P(Mₑ)+C, 16-7, as discussed above with reference to FIG. 16.

With the inclusion of the random bit pattern, 20-2 the cryptogram no longer consists of a codeword plus t errors and information set decoding is defeated, provided the attacker does not know the exact format of the cryptogram. Consider a typical example of an instant messaging application using a Goppa code of length 2048 bits correcting t=70 errors. The number of parity bits is 770 bits. Using the second alternative embodiment with a cryptogram format shown in FIG. 16, the message data D may consist of 256 bits and the encrypted data Mₑ may also consist of 256 bits so that the cryptogram has length 1026 bits. With the standard McEliece cryptosystem the associated cryptogram has a length of 2048 bits. With the same cryptogram length of 2048 bits, the random bit pattern, 20-2, of FIG. 20, consists of 1022 random bits followed by the 256 bits, Mₑ+B, 16-6, followed by the 770 bits, P(A)+P(Mₑ)+C, 16-7. It is apparent that the resulting cryptogram is 2048 bits long and consists of a codeword and an average of 70+1022/2=581 bit errors, defeating information set decoding.

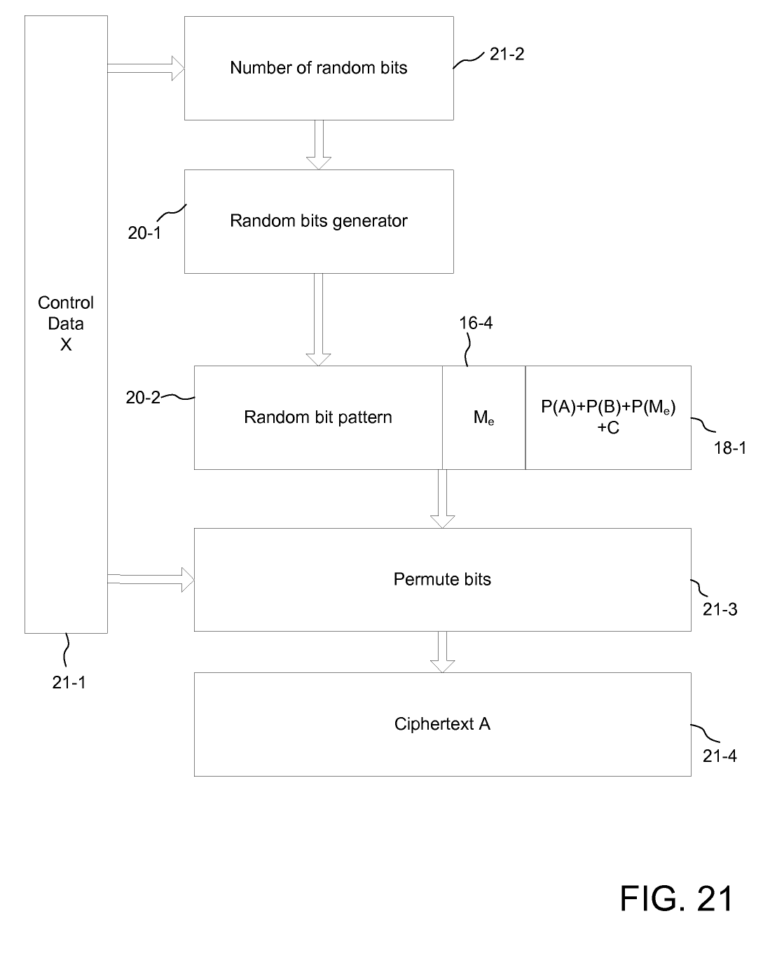

A process of generating a cryptogram according to a fifth alternative embodiment will now be described with reference to FIG. 21, using corresponding reference numerals to those of preceding figures where appropriate for corresponding elements. The present alternative embodiment addresses further difficulties which are presented to an attacker using information set decoding. In this arrangement a pre-determined permutation is carried out on the random bits and the corrupted, shortened codeword. A Control Data X vector, 21-1, typically 128 bits long controls the number of random bits, 21-2 and the pre-determined permutation that is carried out by Permute bits, 21-3. Using the same example parameters as the fourth alternative embodiment, the shortened, corrupted codeword consists of 256 bits for Mₑ, 16-4 followed by 770 bits of P(A)+P(B)+P(Mₑ)+C, 18-1. The shortened corrupted codeword is preceded by 1022 random bits. The complete 2048 bit vector is permuted by Permute bits, 21-3, with the permutation sequence specified by Control Data X, 21-1, to form the 2048 bit cryptogram, denoted as Ciphertext A, 21-4 in FIG. 21. It should be noted that yet a further alternative embodiment is to use as a basis, the second alternative embodiment with the corrupted, shortened codeword consisting of Mₑ+B followed by P(A)+P(Mₑ)+C.

In these particular alternative embodiments, the exact format of the cryptogram in terms of the length of the random bit pattern and, the positions of the random bits, within the cryptogram needs to be known by the attacker otherwise random bits, not part of the codeword will cause information set decoding to fail. Also the length of the codeword needs to be known by the attacker. In addition in order to use information set decoding the attacker needs to know the generator matrix of the code. Unless the attacker is able to undo the permutation of the 1096 bits (in this example) of the shortened, corrupted codeword and find these bits within the 2048 bits of Ciphertext A, 21-4, information set decoding will fail because the attacker knows only the public key, which is a permuted generator matrix relative to the permuted, shortened codeword contained in Ciphertext A, 21-4.

It should be noted that in these alternative embodiments, information set decoding will fail even if the number of random bits is zero, unless the attacker is able to guess correctly the permutation of the codeword bits within Ciphertext A.

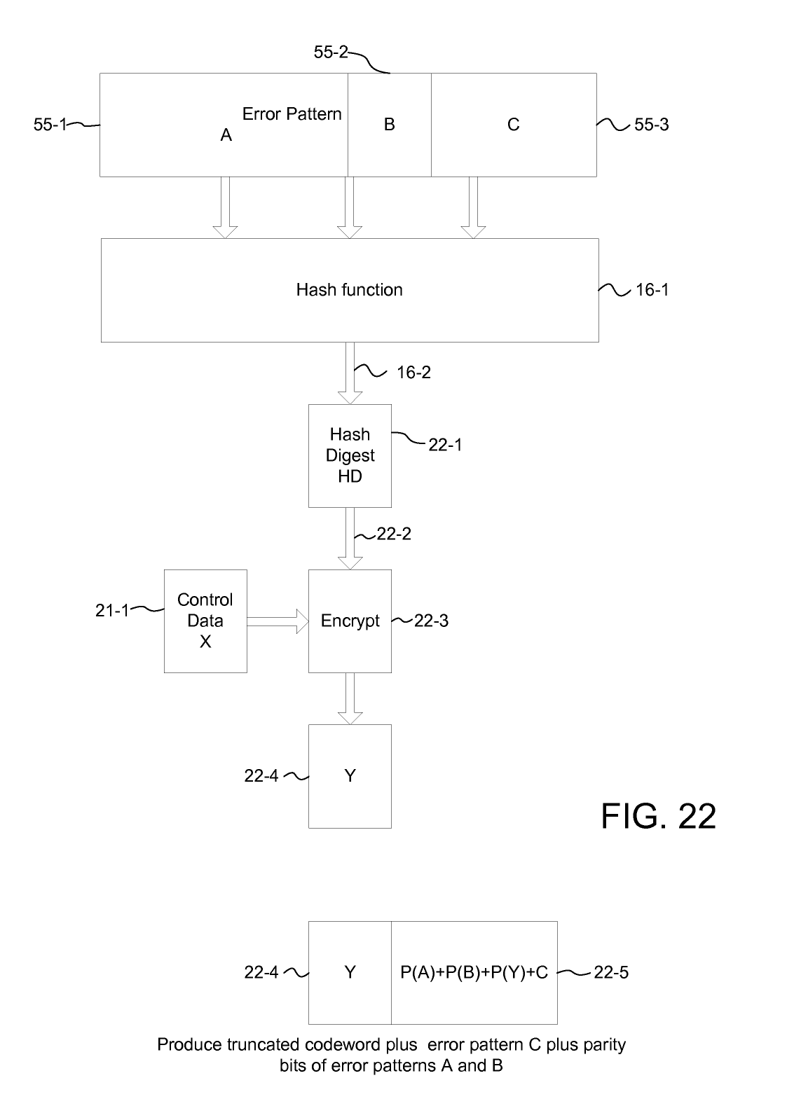

In order to carry out decryption it is necessary for the holder of the private key to also know the Control Data X, 21-1, vector. To communicate this vector to the holder of the private key a cryptogram is constructed by treating the Control Data X, 21-1, vector in the same way as data D and use the second or third alternative embodiments. Correspondingly the holder of the private key can use respectively the process shown in FIG. 17 or FIG. 19 to decrypt the Control Data X, 21-1, vector from the cryptogram. As the Control Data X, 21-1, vector is typically shorter than the data D vector, a sixth alternative embodiment of the invention may be used. The process used in the construction of the cryptogram according to this alternative embodiment will be described with reference to FIG. 22, using corresponding reference numerals to those of preceding figures where appropriate for corresponding elements.

In symmetric key encryption it is customary to match the encryption key size to the size of the block of data being encrypted Accordingly, the output, 16-2, of the hash function of the error pattern is input to a Hash Digest, HD, 22-1, whose output vector, 22-2, is designed to be the same length as the Control Data X, 21-1, vector. The output vector from the Hash Digest, HD, block 22-1 is used as the encryption key to for the Encrypt block, 22-3, which encrypts the Control Data X, 21-1, vector to produce the encrypted output Y, 22-4, as shown in FIG. 22. The cryptogram consists of encrypted output portion Y 22-4, followed by the parity bits P(A)+P(B)+P(Y)+C, 22-5.

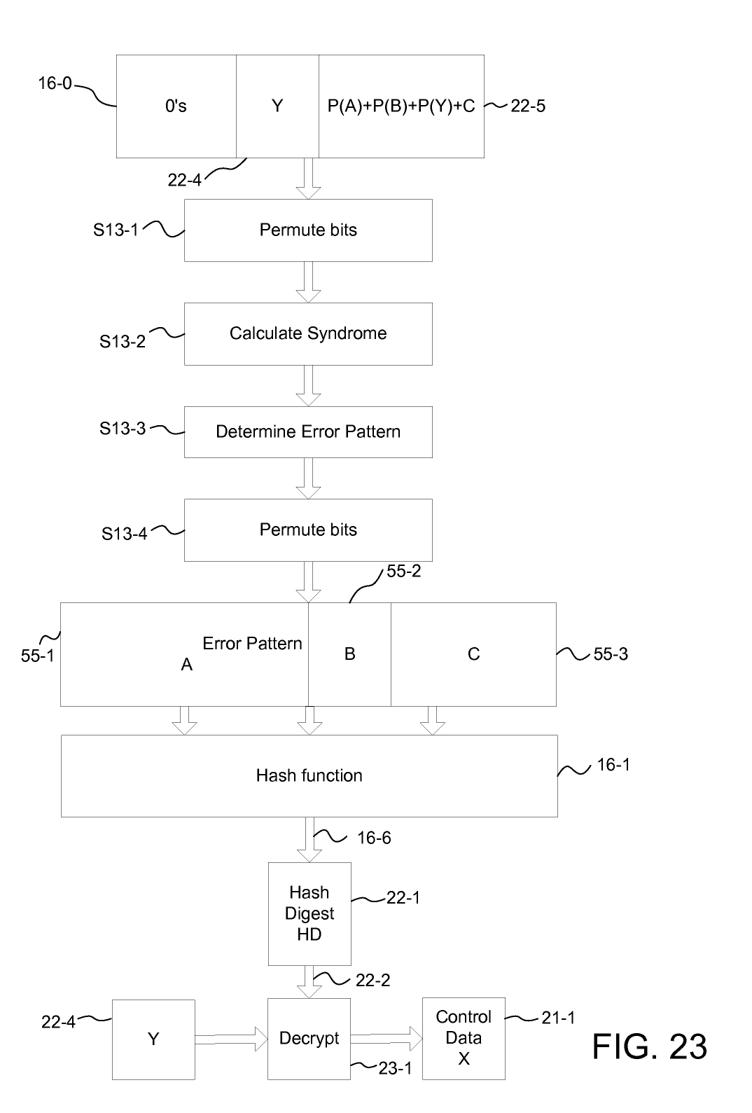

The decryption arrangement for the sixth alternative embodiment is shown in FIG. 23, using corresponding reference numerals to those of preceding figures where appropriate for corresponding elements. The cryptogram is padded with leading zeros, 16-0, so that it is the same length as a codeword and permuted by Permute bits, at step S13-1. The syndrome is calculated by Calculate Syndrome, at step S13-2 and the error pattern determined by the Determine Error Pattern block, at step S13-3. The bits in the error pattern are permuted to be in the same order as originally created by the Permute bits block, at step S13-4 to produce the reconstructed Error Pattern consisting of A, 55-1, followed by B, 55-2, followed by C, 55-3 as shown in FIG. 23. The reconstructed Error Pattern is input to the Hash Function block 16-1 to produce the hash output 16-6, which in turn is input to the Hash Digest HD block 22-1 whose output, 22-2 is the same as the encryption key used to encrypt Control Data X. Accordingly, the output 22-2 is used to decrypt Y 22-4 by using the Decrypt block 23-1 to produce Control Data X 21-1 shown in FIG. 23.

It will be appreciated that the basis of the sixth alternative embodiment could have been the second alternative embodiment instead of the third alternative embodiment. In which case, the cryptogram would consist of Y+B followed by parity bits P(A)+P(Y)+C.

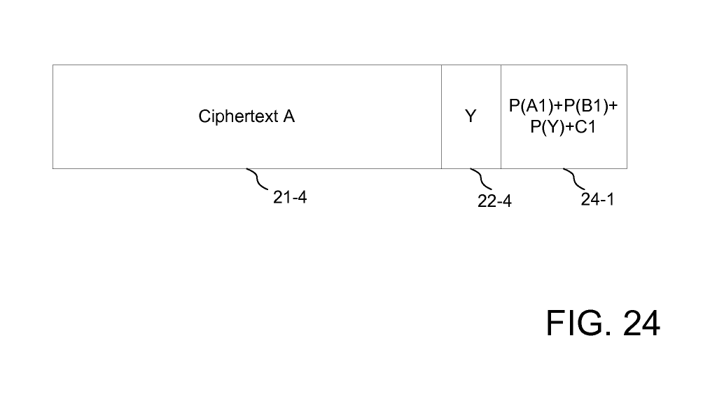

A self-contained cryptogram which defeats information set decoding is shown in FIG. 24, using corresponding reference numerals to those of preceding figures where appropriate for corresponding elements. It consists of Ciphertext A, 21-4, followed by Y, 22-4 followed by parity bits P(A1)+P(B1)+P(Y)+C1, 24-1. There are two error patterns involved, the combined Error Pattern A, B and C used to construct Ciphertext A and another, independently, randomly generated combined Error Pattern A1, B1, and C1 used to derive the encryption key to encrypt Control Data X into Y. The holder of the private key firstly decrypts the vector comprising Y, 22-4 followed by parity bits P(A1)+P(B1)+P(Y)+C1, 24-1 to determine the particular vector Control Data X being used.

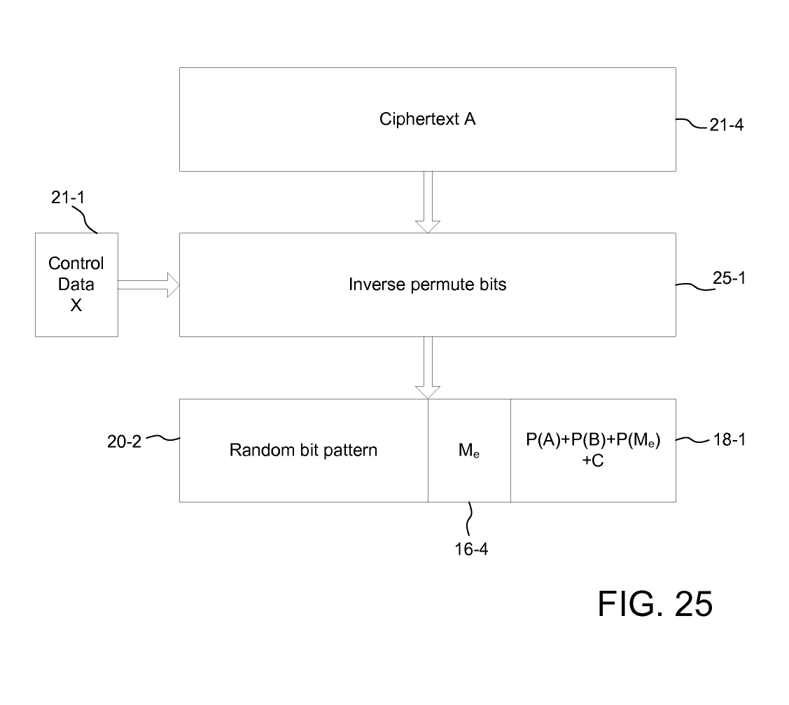

With the Control Data X vector determined, Ciphertext A may be decrypted, as shown in FIG. 25. Ciphertext A is inversely permuted into the Random bit pattern, 20-2, followed by Mₑ, 16-4 and parity bits P(A)+P(B)+P(Mₑ)+C, 18-1. Since Control Data X is known the number of random bits in the Random bit pattern is known and these may be stripped off. The decryption arrangement shown in FIG. 19 may now be applied to determine the message data D.

In practice, a much longer code would be used to produce the cryptogram consisting of the encrypted Control Data X followed by parity bits P(A1)+P(B1)+P(Y)+C1 than used to construct Ciphertext A. This is because Ciphertext A is protected from an attacker using information set decoding by the unknown permutation and unknown random bits. Typically a Goppa code of length 2048 bits with 660 parity bits may be used to construct Ciphertext A while a Goppa code of length 4096 bits with 1236 parity bits may be used to construct the cryptogram containing the Control Data X information. Consequently there will be two public keys and two private keys.

The Control Data X vector needs only to be changed infrequently and so the cryptogram consisting of the encrypted Control Data X followed by parity bits P(A1)+P(B1)+P(Y)+C1 needs only to be communicated infrequently, possibly at the beginning of any encrypted session of information storage or transmission.

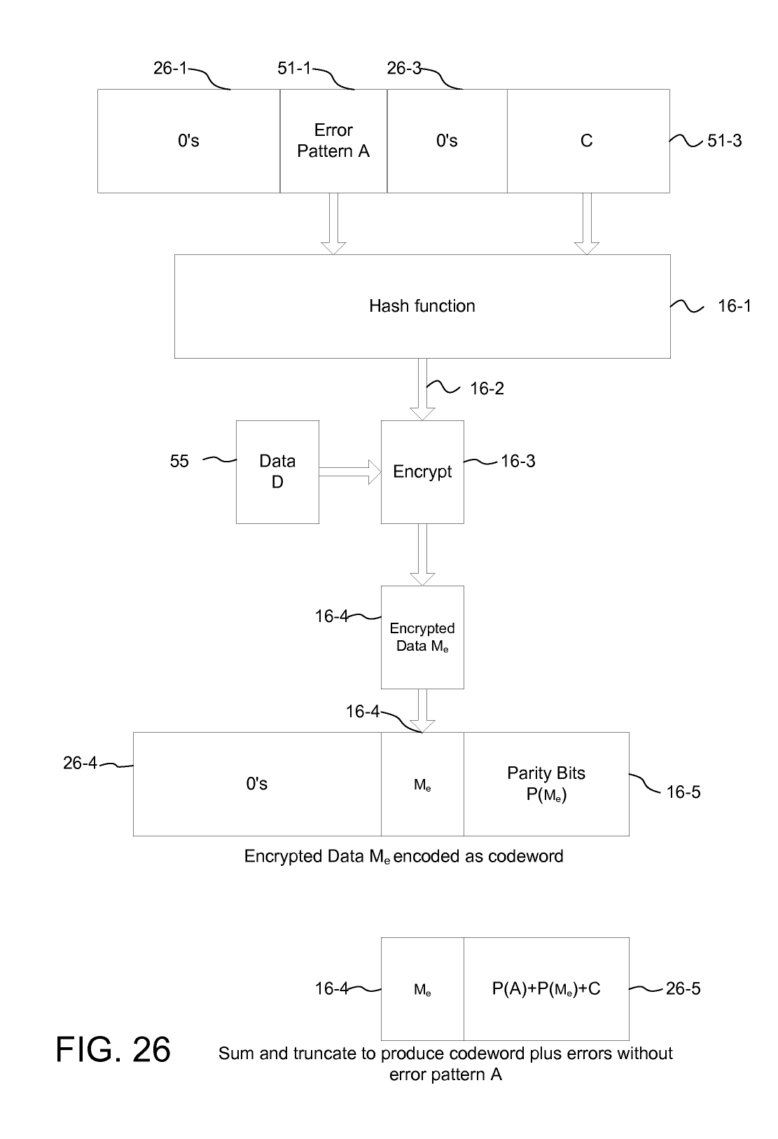

A further alternative embodiment is shown in FIG. 26, again using corresponding reference numerals to those of preceding figures where appropriate for corresponding elements, and this alternative is also designed to defeat information set decoding. A long Goppa code is used such as a Goppa code of length 16384 bits. Consider as an example that the Goppa code has been designed to correct 40 errors and so has 560 parity bits. The complete public key encoding matrix consists of the k×n binary matrix As the matrix is in reduced echelon form it may be stored as a compressed k×(n−k) matrix which is a 15,824×560 binary matrix, since there is no need to store the k×k identity part of the matrix In accordance with the invention, the public key encoding matrix that is used for data messages is a kₛ×n−k+kₛ binary sub-matrix. With an example that data messages are 256 bits in length then the compressed public key encoding matrix for data messages may be stored as a 256×560 binary sub-matrix. One possibility is that this sub-matrix is published on a web site along with the compressed complete public key encoding, 15,824×560 binary matrix. In this alternative embodiment, typically, to construct a cryptogram, to send to the recipient a user downloads the kₛ×(n−k) sub-matrix, i.e. the 256×560 binary sub-matrix and just a contiguous part of the k×(n−k) binary matrix, for example a 500×560 bit sub-matrix. As shown in FIG. 26, the user generates a random error pattern, partial Error Pattern A 51-1, confined only to 500 contiguous bit positions within the submatrix, and additional errors confined within the parity bits C, 51-3. In this example, the total number of errors is 40. As in other alternative embodiments, the complete error pattern which is 16384 bits long in this example, after including the zeros is input to Hash function block 16-1 to produce a hash output 16-2. In this example, the hash output is a 256 bit vector used as an encryption key to encrypt the 256 bits of Data D 55 to form a 256 bit vector, Encrypted Data Mₑ 16-4. The kₛ×(n−k) matrix, the 256×560 binary sub-matrix is used to calculate the 560 parity bits P(Mₑ), 16-5 in FIG. 26.

The 560 parity bits P(A) are calculated from Error Pattern A 51-1, using the 500×560 bit encoding sub-matrix and added modulo 2 to P(Mₑ), 16-5 and the error pattern C, 51-3 to form 18-1 shown in FIG. 26. The complete cryptogram is 816 bits long consisting of 256 bits of encrypted data, Mₑ, 16-4 followed by the 560 bits, 26-5 as shown in FIG. 26.

In general there will be several users downloading sub-matrices of the recipient's compressed complete public key encoding, 15,824×560 binary matrix with each user independently constructing and sending cryptograms to the recipient. The recipient does not know or need to know which sub-matrices were used by which user. The recipient simply uses their private key to determine the error pattern consisting of partial Error Pattern A and C within the code length of 16,384 bits. This is also the mechanism by which information set decoding is defeated. Unless the attacker knows the particular sub-matrix that a user has downloaded and used to construct their cryptogram, the attacker has no alternative but to use the complete, compressed 15,824×560 public key encoding matrix in an attempt to determine the 40 errors contained within 16,384 possibilities. If this is the case, it can be shown that, on average 2¹⁹⁸ information set decodings need to take place before the 40 bit error pattern is found to enable the attacker to decrypt Mₑ. The present alternative embodiment thus achieves 198 bits of security for this particular example with a cryptogram that is only 816 bits long. Users may download alternative sub matrices, erasing previously used sub matrices, or over time accumulate the complete compressed 15,824×560 public key encoding matrix, extending the boundaries of Error Pattern A in stages with each sub-matrix downloaded.

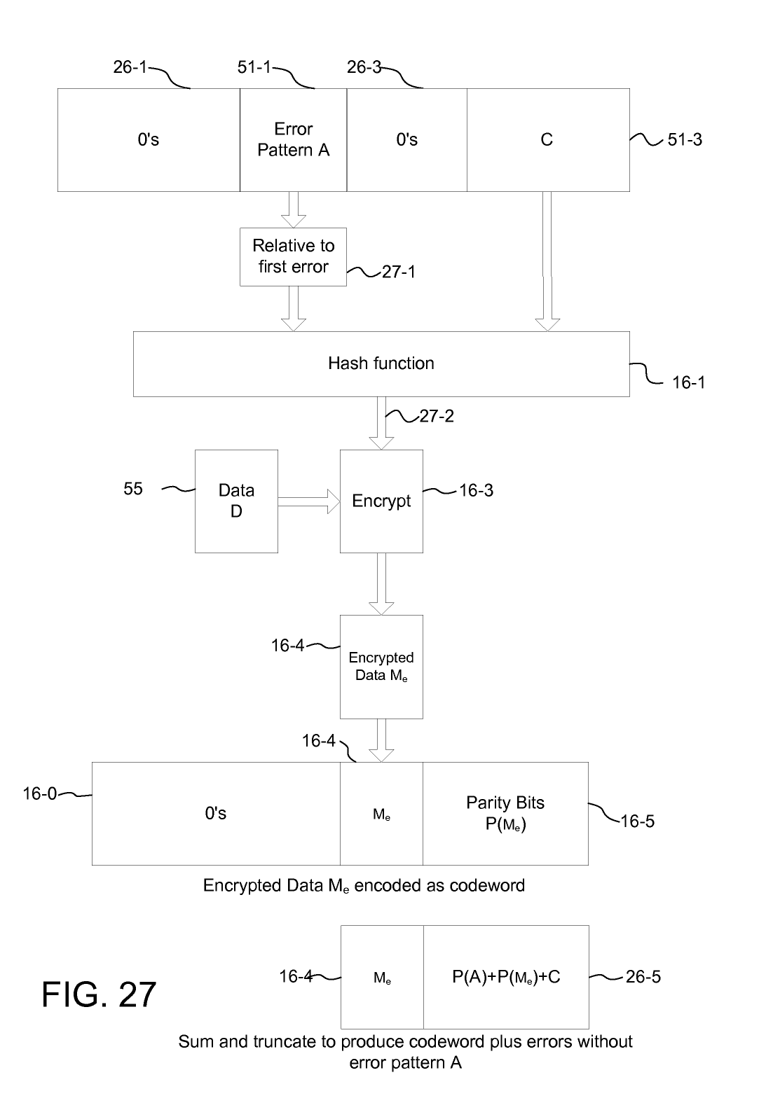

A variation of the above alternative embodiment is shown in FIG. 27 with the aim of simplifying the Hash function block 16-1. Instead of inputting absolute error positions of partial Error Pattern A to the Hash function block 16-1, error positions relative to the first error of partial Error Pattern A are input to the Hash function block 16-1. As a simple example, consider that partial Error Pattern A has errors in positions 9355, 9366, 9394, 9412, 9433, 9512 and 9600. In FIG. 27, a Relative to first error block 27-1 converts this sequence to 0, 11, 39, 57, 78, 157 and 245. This sequence is input to Hash function, 16-1 along with the partial error pattern C to determine the encryption key 27-2. Correspondingly the recipient uses their private key to determine partial Error Pattern A and converts this to the sequence 0, 11, 39, 57, 78, 157 and 245. Hence the recipient is able to reproduce the same encryption key output from Hash function, 16-1 and in turn to decrypt Encrypted Data Mₑ, 16-4, to reconstruct Data D, 55. The advantage of this alternative embodiment apart from the Hash function simplification is that the user can use any contiguous sub matrix and there is no need to keep track of the absolute positions of the sub matrix columns within the complete encoding matrix.

### Other Applications

The present embodiments may be implemented in a wide number of different applications such as active and passive RFID, secure bar-codes, secure ticketing, magnetic cards, message services, e-mail applications, digital broadcasting, digital communications, wireless communications, video communications and digital storage. As an example, consider applications using bar-codes or passive RFID tags. These have fixed codes and use short sequences that are easy to read by anybody with suitable equipment. The invention may be used to encrypt the information using a public key to form a cryptogram that can only be decrypted with the private key. As the encryption key is public there is no need for highly secure key management at the point where the bar-codes and RFID tags are manufactured. A relatively short Goppa code may be used to construct the public key, for example n=128 bits. With t=15, and s ranging from 7 to 15, the number of error combinations is 1.8×10¹⁹ equivalent to a secure key of length 64 bits. A message of length 23 bits can be encrypted and securely contained in the barcode or passive RFID tag. With bit deletions the cryptogram is reduced in length from 128 bits to an average of 113 bits.

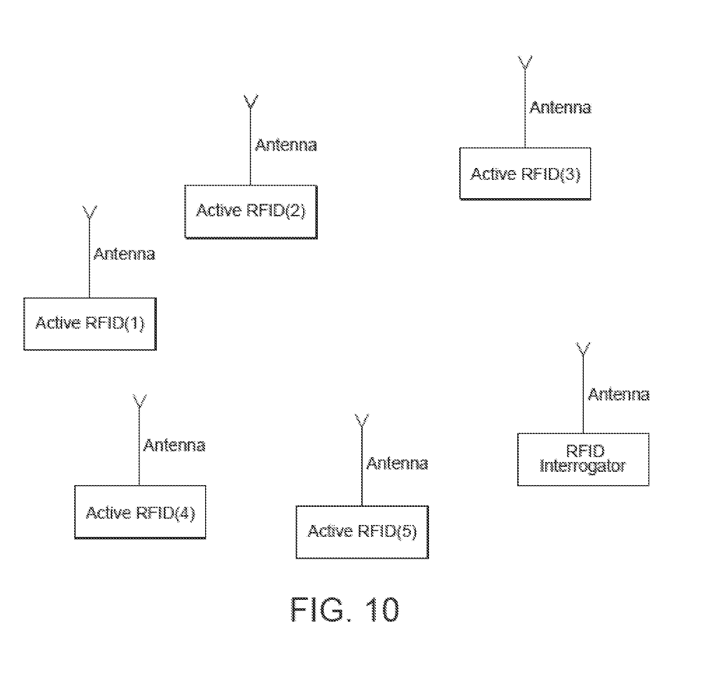

An application using wireless, for example with active RFID is shown in FIG. 10 depicting 5 containers Active RFID(1) through to Active RFID(5) equipped with active RFID transponders. The containers are periodically monitored by RFID Interrogator shown by FIG. 10 by RFID Interrogator which transmits using wireless transmission, a request for information to each of the containers in turn. Each container, Active RFID(1) through to Active RFID(5) responds with a wireless message. In order to keep the information transmitted by the containers' secure each encrypts their information using their own public key. The private keys are held by RFID Interrogator. Even if the wireless transmissions are intercepted the information cannot be retrieved without knowledge of the private key. As an example with n=256 bits, t=20 transmissions and with s ranging from 10 to 20, the number of error combinations is 3.1×10²⁹ equivalent to a secure key of length 98 bits. A message of length 96 bits can be encrypted with an average wireless transmission of 246 bits duration.

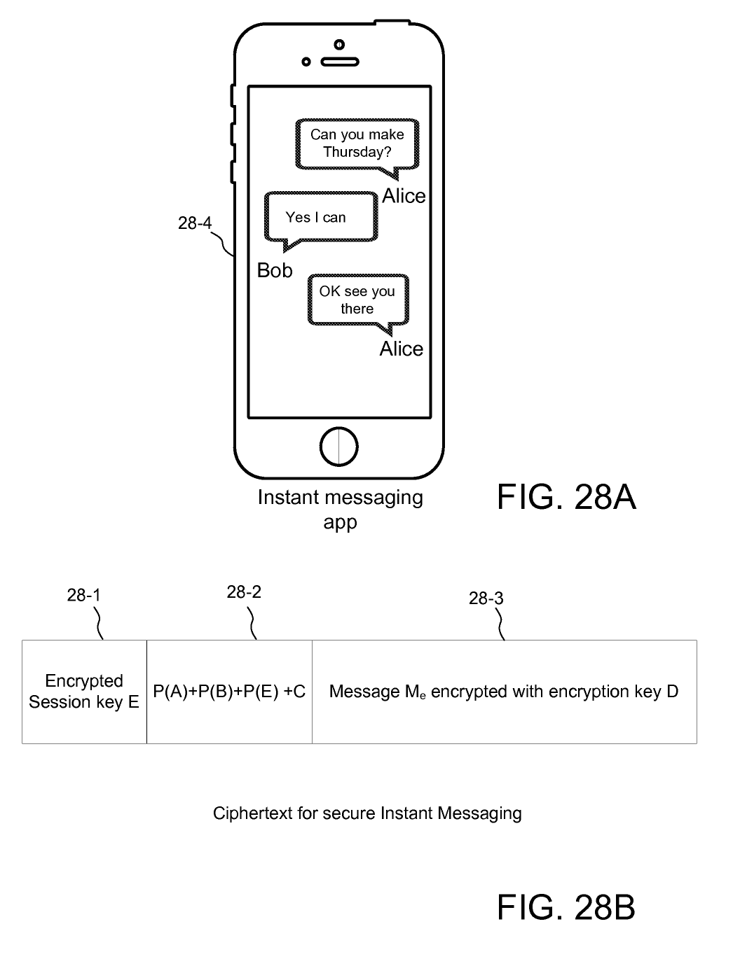

It is apparent that a similar system could be used for secure messaging such as e-mail or text messaging. A further embodiment is shown in FIG. 28 for a secure instant messaging app in which each message is independently encrypted before transmission as a cryptogram. Each message employs a different encryption key. There are two exemplary users, Alice and Bob, as schematically illustrated by the respective data messages in FIG. 28A. It is assumed each user is in possession of a smartphone, 28-4, on which the messaging app is installed. Each user has the other's public key and each user has their private key stored on their smartphone. Messages may be short consisting of short texts or may be long consisting of documents, photos, videos or other digital files. With each message encrypted with a new encryption key, it is advantageous to utilise the property of the invention that cryptograms consist of a shortened corrupted codeword without compromising security. An exemplary embodiment has the cryptogram format shown in FIG. 28B. Each message is encrypted, 28-3, using a session key D which is randomly generated and a symmetric encryption system such as AES is used.

An encrypted version of the session key D is communicated to the recipient by using one of the alternative embodiments of the invention described above. FIG. 28 shows the cryptogram format for the case in which the third alternative embodiment is used to send D. A digest of the random error pattern is used as the encryption key to encrypt D into the Encrypted Session key E, 28-1 which is followed by the parity bits consisting of P(A)+P(B)+P(E)+C, 28-2. As an example for Alice to send a cryptogram to Bob, Alice first generates a random session key D and uses AES encryption to encrypt her message to Bob using D to form the encrypted message, 28-3, Alice then generates a random error pattern, calculates a hash of it and uses this as the encryption key to AES encrypt D to produce E, 28-1. Alice partitions the random error pattern into error vectors A, B and C. Alice then uses Bob's public key, his encoding sub matrix to calculate the parity bits P(E), and also uses Bob's complete encoding matrix to calculate the parity bits P(A)+P(B) from error vectors A and B. Alice then adds, modulo 2, error vector C to P(E) and P(A)+P(B) to form P(A)+P(B)+P(E)+C, 28-2. Alice assembles the complete cryptogram and sends it to Bob. Bob on receiving the cryptogram on his smartphone, uses his private key to determine the error pattern and regenerates the encryption key from the hash of the error pattern. Bob uses this key to AES decrypt E into D. Bob is then able to decrypt Alice's message, 28-3, and display and store, her plaintext message on his smartphone. Similarly Bob sends encrypted messages to Alice utilising Alice's public key, her encoding sub-matrix and her complete encoding matrix. Alice uses her private key to decrypt Bob's cryptograms.

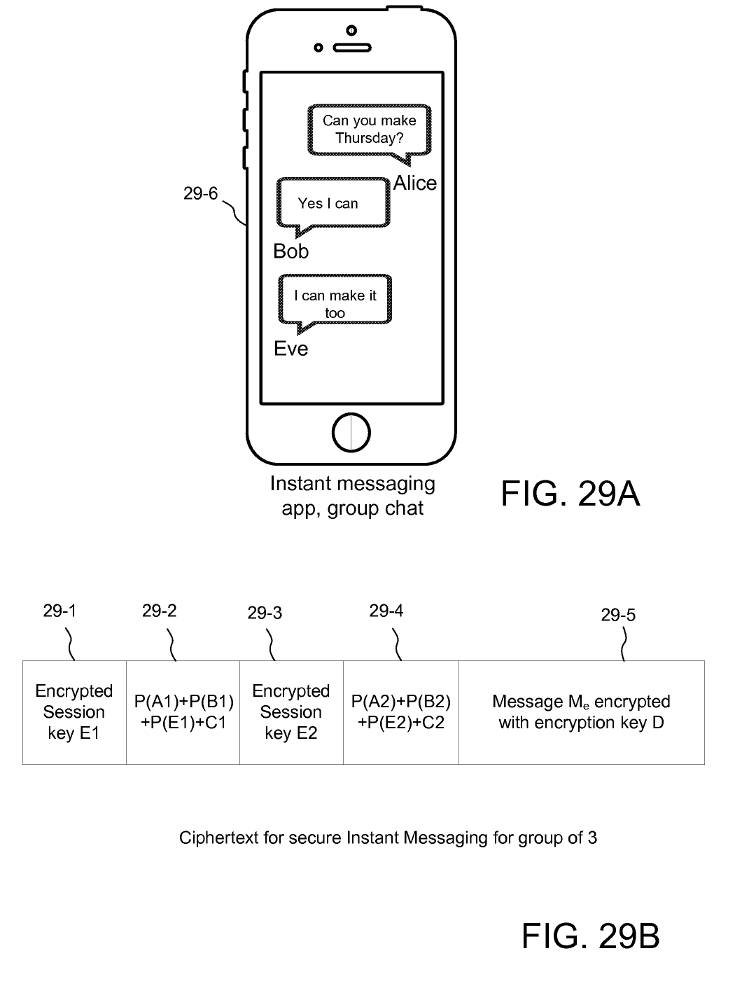

FIG. 29B shows the cryptogram format for communication to groups of users (group chat) in a secure instant messaging app in which there is, for example, a group of three users Alice, Bob and Eve, as shown in FIG. 29A. In this example, the third alternative embodiment is utilised in composing the cryptogram but it is clear that any of the alternative embodiments may be utilised. Any one user sends encrypted messages to the other two users. Considering the case of Alice sending an encrypted message to Bob and Eve, Alice first generates randomly the session key D and uses this to encrypt her message, using AES, to produce an encrypted message Mₑ, illustrated as block 29-5. Separately for Bob, Alice then generates a random error pattern, calculates a hash of it and uses this as the encryption key to AES encrypt D to produce E1, illustrated as block 29-1. Alice partitions the random error pattern into error vectors A1, B1 and C1. Alice then uses Bob's public key, his encoding sub matrix to calculate the parity bits P(E1), and also uses Bob's complete encoding matrix to calculate the parity bits P(A1)+P(B1) from error vectors A1 and B1. Alice then adds, modulo 2, error vector C1 to P(E1) and P(A1)+P(B1) to form P(A1)+P(B1)+P(E1)+C1, illustrated as block 29-2.

Alice then repeats this procedure for Eve with a second randomly generated error pattern consisting of error vectors A2, B2 and C2. The hash of the error pattern is used as the encryption key to encrypt D, using AES, to produce E2, illustrated as block 29-3. Alice uses Eve's public key to produce P(A2)+P(B2)+P(E2)+C2, illustrated as block 29-4 and assembles the complete cryptogram shown in FIG. 29B and sends this to Bob and Eve.

On receiving the cryptogram Bob and Eve use their respective private keys to determine the session key D and then use the session key to decrypt, using AES, Alice's encrypted message Mₑ 29-5. A similar procedure is adopted by Bob for formatting cryptograms to send to Alice and Eve as is the case for Eve when formatting cryptograms to send to Alice and Bob.

For groups consisting of M users each cryptogram consists of M−1 parts with each part enabling the respective user to use their private key to determine the session key D. Each part consists of a shortened, corrupted codeword according to the invention. Typically each user uses a different Goppa code and has different public and private keys from other users

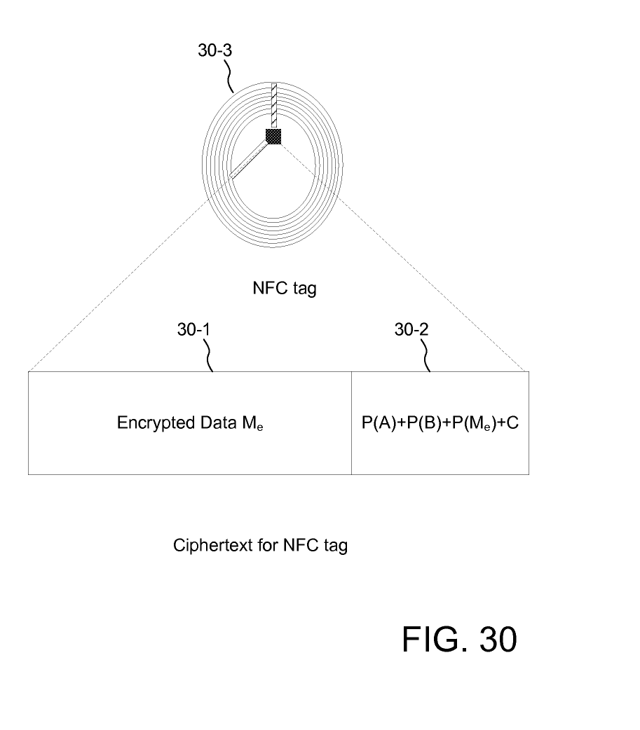

FIG. 30 shows an example of the cryptogram format that may be used to store encrypted information on an RFID tag, for example a Near Field Communication (NFC) tag. RFID tags typically have small memory and as such, it is important in storing encrypted information that the cryptogram be efficient in the trade-off between security and memory. Using a public key encryption system, as in the invention, has the advantage that tags can be encrypted without any risk of compromising the decryption key(s). Portable encryption and tag writing devices may be used with little risk of compromise even if the devices are later lost or stolen. FIG. 30 shows the cryptogram format for storing data on the tag, the format corresponds to the third alternative embodiment but any of the alternative embodiments may be used to compose the cryptogram.

To write to the NFC tag 30-3 shown in FIG. 30, the tag writing device (not shown) first generates a random error pattern, calculates a hash of it and uses this as the encryption key to encrypt the secret information D, using AES, to produce Mₑ, 30-1. The random error pattern is partitioned into error vectors A, B and C. The public key, comprising the encoding sub matrix is used to calculate the parity bits P(Mₑ), and also the complete encoding matrix is used to calculate the parity bits P(A)+P(B) from error vectors A and B. The tag writer then adds, modulo 2, error vector C to P(Mₑ) and P(A)+P(B) to form P(A)+P(B)+P(Mₑ)+C, 30-2 and writes the complete cryptogram to the NFC tag.

The tag contents are read by a tag reading device to obtain the cryptogram stored on the NFC tag, 30-3. When read by a device containing, or having access to the private key, the private key is used by the tag reader to determine the error pattern comprising A, B and C first generated by the tag writer and regenerates the encryption key from the hash of the error pattern. The reader then uses the regenerated encryption key to decrypt Mₑ, 30-1 into the secret information D.

### Alternatives and Modifications

Advantageously, embodiments of the present invention provide an improved technique to reduce the public key size without compromising the security of the McEliece-based encryption system, whilst retaining the family of Goppa error correcting codes as the basis of the encryption system. Furthermore, embodiments of the present invention are able to exploit the implicit error correction capability so as to deal with naturally occurring errors in the transmission or retrieval of cryptograms, given the constraint of reduced public key size.

It will be understood that the various embodiments of the present invention are described by way of example only, and that various changes and modifications may be made without departing from the scope of the invention.

For example, as encryption consists of the addition, modulo 2 of rows of the scrambled generator matrix according to the 1's in the message vector, encryption with hardware can be extremely fast which is useful for encryption in data storage or high speed data such as encoded video. Similarly as the slowest function involved in decryption is essentially the error and erasure correction of corrupted codewords, it is known from examples of implemented hardware of such decoders that this can also be carried out at speeds beyond 1 Gbit/sec.

In some embodiments described above, a reduced echelon generator matrix is used to generate codewords of a permuted binary Goppa code. As these codes are linear binary codes, it will be appreciated that the (nl,kl,d) permuted binary Goppa code can be shortened to a (n,k,d) shortened code by setting some information bits always to 0's and in particular cases some parity bits to 0's, depending on the minimum weight codewords of the dual code, for example as taught by MacWilliams and Sloane in the above-referenced textbook.

In the various embodiments of the invention that feature permutation of the encoded codewords, the bits that always have value 0 may be permuted to the end of the permuted codeword vector occupying positions n1−1 to n1−k1+k−μ where μ is a small integer corresponding to the number of parity bits that are always equal to zero. Effectively the bits in these positions are deleted. The error generator is constrained in these cases so that bit errors are never added to the deleted bit positions. Accordingly the cryptogram is formatted using only bits in the n positions, 0 to n1−k1+k−1. In this way the length of the cryptogram may be closely matched to the available communications packet length or storage capacity. For example the EPC Class 1 Gen 2 RFID tag has an EPC field of 96 bits. Any of the Goppa codes of length 128 bits may be shortened to a length of 96 bits and so utilise all of the bits available in the RFID tag. One example is a (128,79,15) Goppa code which can correct 7 bit errors. The dual code has a minimum weight codeword of 22 and so one parity bit is always zero, if 21 information bits in the appropriate positions are set to zero. Hence, the (128,79,15) Goppa code can be shortened to a (96,48,15) code conveying 48 message bits in a 96 bit cryptogram. Using one of the high throughput embodiments up to 77 message bits can be conveyed in a 96 bit cryptogram.

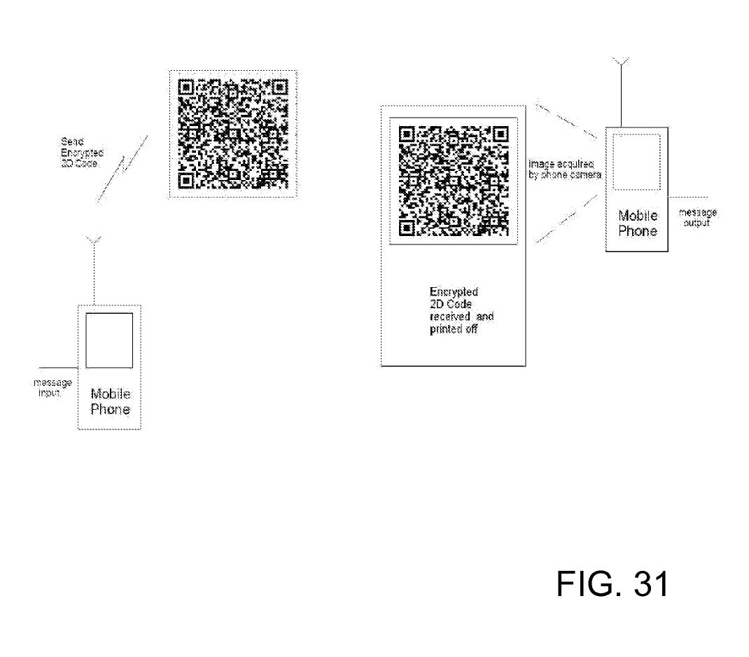

An example of using the invention to encrypt a message onto a 2D barcode using a mobile phone is shown in FIG. 31. In one particular case encryption and decryption is implemented on an iPhone 4 as an app (such as that marketed by the present inventors under the name “Cloud Wallet”). The iPhone is used to input a message and using a public key derived from a (2048,1168,161) Goppa code the cryptogram is produced and stored in a Cloud network online storage, for example using Dropbox. The private key is itself encrypted using another Goppa code encoded onto a 2D barcode. The actual resulting 2D barcode is shown in FIG. 31. A binary image of the 2D barcode is transmitted by the iPhone to produce a printed copy. No encrypted information nor the private key is stored on the iPhone. Access to the encrypted information stored on Dropbox is provided by using the iPhone to recover the private key by capturing and decrypting the image of the 2D barcode from the printed copy and using it to decrypt cryptograms downloaded from Dropbox. Each cryptogram is decrypted within the iPhone, correcting the residual errors, to produce the original message as depicted in FIG. 31. The same app can also be used on an iPod Touch or iPad.

The App secures all the important voice, visual and text data and stores them in Dropbox for “anywhere” access. It has the following benefits:
Unique and device specific 2D barcode, access code, kept separately from a user's device, for authentication and access, no password to remember.
If a user loses the 2D barcode code, they can regenerate a new 2D barcode and the lost 2D barcode becomes useless immediately.
Stores a wide range of important voice, visual and text data.
Strong security: all information is encrypted and decrypted using the invention. Encryption and decryption is made transparent to the end user to ensure user-friendliness.
None of the encrypted information is stored on the device. Nothing is lost if the device is lost or stolen, and the data is always available from the cloud—encrypted by the user.
The encrypted information stored on Dropbox may be accessed by any of a user's iPhone, iPod Touch or iPad 2 devices with each device having its own unique 2D barcode With the invention operating on an iPhone, iPod Touch or iPad 2, each of the devices will be assigned a different 2D barcode.

In summary, the invention may be used in a wide number of different applications such as active and passive RFID, secure barcodes, secure ticketing, magnetic cards, secure messaging services, secure voice, e-mail applications, digital broadcasting, digital communications, wireless communications, video communications and digital storage.

The invention includes, but is not limited to, all embodiments within the scope of the claims appended hereto and also any and all novel subject-matter disclosed herein and combinations thereof, as well as all variations, modifications and substitutions to the embodiments described herein that fall within the scope of the present invention as defined by the claims.

### Computer Systems

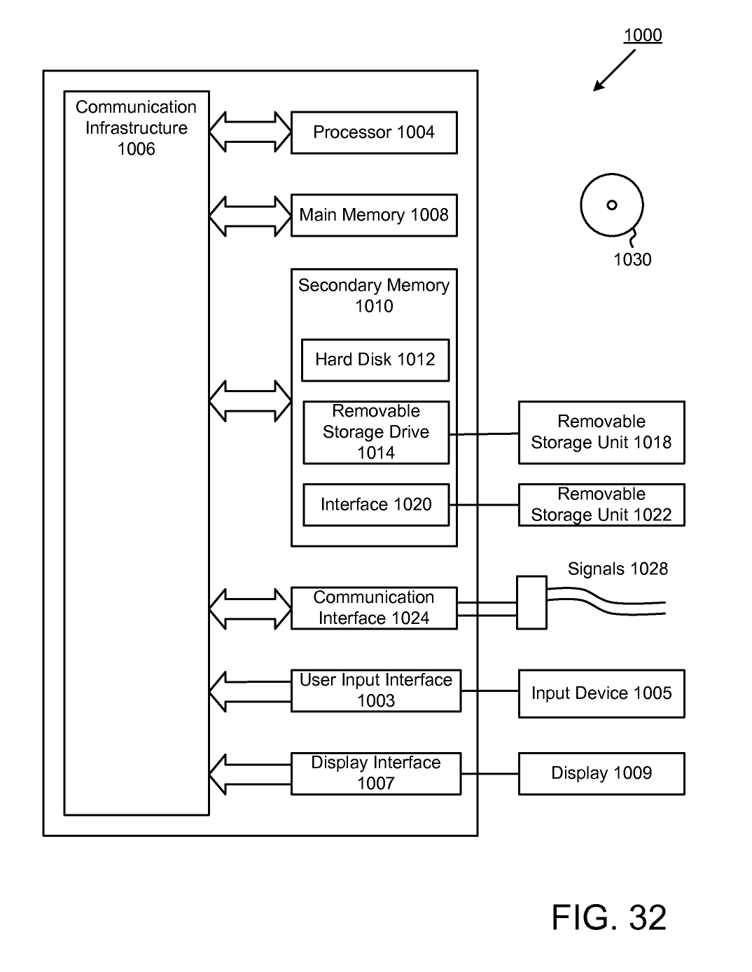

The processing modules, blocks and entities described herein, such as the generation of error patterns, implementation of hash functions, encryption devices, codeword construction, permutation devices and error correction decoding may be implemented by computer systems such as computer system 1000 as shown in FIG. 32 with execution by such computer systems 1000. After reading this description, it will become apparent to a person skilled in the art how to implement the invention using other computer systems and/or computer architectures and other signal processing hardware.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures and other signal processing hardware.

Computer system 1000 also includes a user input interface 1003 connected to one or more input device(s) 1005 and a display interface 1007 connected to one or more display(s) 1009. Input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

Alternative embodiments may be implemented as control logic in hardware (e.g. dedicated circuitry, processors, chips, etc.), firmware, or software or any combination thereof.

### OTHER ASPECTS AND EMBODIMENTS

Other applications will be evident to the skilled reader. The present invention is limited only by the scope of the appended claims and extends to all obvious variations, modifications and substitutions that would be apparent to the reader. Protection is hereby sought for any and all novel subject-matter and combinations thereof, whether or not the same are the subject of claims in the application as filed.

1. A method of encrypting data by constructing a digital cryptogram using a public key algorithm, the method comprising machine-implemented steps of:
constructing a first generator matrix of a binary code with dimension k with a preselected finite field and a Goppa polynomial whose degree is such that the corresponding binary code provides a t error correcting capability by utilising n−k parity bits;
constructing a scrambled k×n generator matrix by matrix multiplication, said scrambled generator matrix being the product of a non-singular matrix, said first generator matrix and a permutation matrix;
encoding a message vector D with the scrambled generator matrix, using matrix multiplication to form a codeword vector of length n bits;
generating a shortened corrupted codeword by corrupting said codeword vector and omitting a predefined number of bits from each corrupted codeword; and
forming a cryptogram from the shortened corrupted codeword.

2. The method of claim 1, further comprising:
using a random number generator to generate independently, an integer s such that s<t for each codeword vector,
and wherein the shortened corrupted codeword is generated by:
adding to each codeword vector using modulo 2 arithmetic a random, independently generated, error vector of length n bits, containing s bit errors; and
removing 2(t−s) bits from the codeword vector, according to a pre-defined position vector.

3. The method of claim 1, further comprising:
for each message vector, randomly generating an associated error vector of length n bits, containing s bit errors;
generating an associated reversible mapping function for each binary message vector from the associated error vector, wherein the reversible mapping function uses a k bit to k bit scrambling function that is derived from the associated error vector; and
mapping each binary message vector into a different mapped binary message vector using the associated reversible mapping function.

4. The method of claim 1, further comprising formatting a message to be sent into r binary message vectors D of length kₛ bits each, by converting the message into binary form and appending dummy bits as necessary.

5. The method of claim 4, further comprising constructing a reduced echelon k×n generator matrix by randomly selecting k independent columns of the scrambled k×n generator matrix according to a second permutation matrix, wherein the reduced echelon k×n generator matrix consists of a first sub-matrix portion having dimensions (k−kₛ)×n, and a second sub-matrix potion having dimensions kₛ×n.

6. The method of claim 5, further comprising randomly generating, for each binary message vector D, an associated error vector of length n bits, containing t bit errors.

7. The method of claim 6, wherein the generated error vector includes at least three error vector portions, wherein first and second portions have bits (A) in positions corresponding to the k−kₛ information bits and bits (B) in positions corresponding to the kₛ information bits, and a third portion C has bits in positions corresponding to the n−k parity bit positions.

8. The method of claim 7, wherein the step of encoding the message vector D further comprises encoding the associated error vector portion A of length k−kₛ bits and the message vector D of length kₛ bits, with the reduced echelon k×n generator matrix to form a codeword vector of length n bits.

9. The method of claim 8, wherein the message vector D of length kₛ bits is encoded with the first sub-matrix portion having dimensions kₛ×(n−k) using matrix multiplication to produce a first parity bits portion P(D) of the codeword vector, and wherein the error vector portion A is encoded with the second sub-matrix portion (k−kₛ)×(n−k) using matrix multiplication to produce a second parity bits portion P(A) of the codeword vector.

10. The method of claim 8, wherein generating a shortened corrupted codeword comprises omitting the first k−kₛ bits from each codeword to form a shortened codeword of length n−k+kₛ bits, wherein the cryptogram is formed from the r corrupted shortened codewords.

11. The method of claim 10, wherein generating a shortened corrupted codeword further comprises corrupting each shortened codeword by adding to each codeword using modulo 2 arithmetic the associated error vector portions B and C to form a corrupted shortened codeword.

12. The method of claim 11, wherein the error vector portion B of length kₛ bits is added to first kₛ bits of the shortened codeword, and wherein the error vector portion C of length n−k bits is added to following n−k parity bits of the shortened codeword.

13. The method of claim 7, wherein the step of encoding the message vector D further comprises encoding the associated error vector portions A and B of length k bits with the reduced echelon k×n generator matrix to form parity bits P(A)+P(B) and the message vector D of length kₛ bits, is encoded with a kₛ×(n−k+kₛ) sub-matrix of the reduced echelon k×n generator matrix to form a shortened codeword of length n−k+kₛ bits; and
corrupting each shortened codeword by adding to each codeword using modulo 2 arithmetic the associated error vector portion C and P(A)+P(B) to form a corrupted shortened codeword,
wherein the cryptogram is formed from the r corrupted shortened codewords.

14. The method of claim 3, further comprising generating an associated encryption key for each message vector D from the associated error pattern, and encrypting each message vector into an encrypted message vector using said associated encryption key.

15. The method of claim 7, wherein the relative positions of the errors in error vector A to the first error in error vector A are used in the generation of an associated encryption key for each binary message vector from the associated error vector.

16. The method of claim 1, wherein each shortened corrupted codeword is preceded by a predetermined number of random bits generated by a random number generator to form a cryptogram.

17. The method of claim 16, wherein each cryptogram is formed by a predetermined permutation of the combination of each shortened corrupted codeword preceded by a predetermined number of random bits generated by a random number generator.

18. The method of claim 17, further comprising encrypting a control vector which determines the number of random bits contained in the cryptogram and the predetermined permutation used to form said cryptogram.

19. The method of claim 1, wherein the cryptogram is constructed for an instant messaging system in which a randomly generated session key is conveyed, said session key being used to produce an encrypted message which is also contained in the cryptogram.

20. The method of claim 1, wherein the cryptogram is constructed for a group chat instant messaging system in which repetitions of a randomly generated session key are conveyed to multiple recipients, said session key being used to produce an encrypted message which is also contained in the cryptogram.

21. The method of claim 1, further comprising reconstructing a message from the cryptogram utilising a private key algorithm.

22. The method of claim 21, wherein reconstructing the message comprises:
retrieving said cryptogram from a communications channel or storage medium as r retrieved vectors, each of length n symbols by inserting a 0 for each pre-defined, deleted bit, marking the position as an erased symbol such that each retrieved vector does not contain more the s bit errors and 2(t−s) erasures;
multiplying each retrieved vector by the inverse of the permutation matrix used in creating the public key scrambled generator matrix to obtain a codeword of a Goppa code corrupted with no more than s bit errors and 2(t−s) erasures;
applying an erasure and error correcting decoding algorithm to each corrupted codeword to form r scrambled binary message vectors of length k bits each;
multiplying each scrambled binary message vector by the inverse of the non-singular matrix used in creating the public key scrambled generator matrix to derive r unscrambled binary message vectors; and
reformatting the r unscrambled binary message vectors removing appended dummy bits to form the original digital message.

23. The method of claim 21, wherein reconstructing the message comprises:
retrieving said cryptogram from a communications channel or storage medium as r retrieved vectors, each of length n symbols by inserting a 0 for each pre-defined, deleted bit, marking the position as an erased symbol such that each retrieved vector does not contain more the s bit errors and 2(t−s) erasures;
adding to each retrieved vector using modulo 2 arithmetic an error vector of length n bits, containing pre-defined u bit errors in pre-defined positions;
multiplying each retrieved vector by the inverse of the permutation matrix used in creating the public key scrambled generator matrix to obtain a codeword of a Goppa code corrupted with no more than s bit errors and 2(i−s) erasures;
applying an erasure and error correcting decoding algorithm to each corrupted codeword to form r scrambled binary message vectors of length k bits each;
multiplying each scrambled binary message vector by the inverse of the non-singular matrix used in creating the public key scrambled generator matrix to derive r unscrambled binary message vectors; and
reformatting the r unscrambled binary message vectors removing appended dummy bits to form the original digital message.

24. The method of claim 21, wherein reconstructing the message comprises:
retrieving said cryptogram from a communications channel or storage medium as r retrieved vectors, each of length n−k+kₛ bits;
padding each retrieved vector with k−kₛ zeros and multiplying by a first permutation matrix to obtain a corrupted codeword of the Goppa code used in creating a public key scrambled generator matrix;
applying an error correcting decoding algorithm to each corrupted codeword to form r binary codewords of the Goppa code and r associated error patterns;
multiplying each binary codeword of the Goppa code and each associated error pattern by a second permutation matrix;
selecting an encrypted binary message vector of length kₛ bits from each permuted codeword,
generating a decryption key for each encrypted binary message vector from the associated permuted error pattern;
decrypting each encrypted binary message vector by using the associated decryption key to form r decrypted binary message vectors; and
reformatting the r decrypted binary message vectors by removing appended dummy bits to form the original digital message.

25. The method of claim 24, wherein reconstructing the message further comprises retrieving said cryptogram from a communications channel or storage medium, applying a permutation matrix to r retrieved vectors, discarding the random bits to form a cryptogram consisting of r corrupted codewords, each of length n−k+kₛ bits.

26. The method of claim 21, wherein reconstructing the message comprises:
retrieving said cryptogram from a communications channel or storage medium as r retrieved vectors, each of length n−k+kₛ bits;
padding each retrieved vector with k−kₛ zeros and multiplying by a first permutation matrix to obtain a corrupted codeword of the Goppa code used in creating a public key scrambled generator matrix;
applying an error correcting decoding algorithm to each corrupted codeword to form r binary codewords of the Goppa code and r associated error patterns;
multiplying each associated error pattern by a second permutation matrix;
selecting the encrypted binary message vector of length kₛ bits from each retrieved vector;
generating a decryption key for each encrypted binary message vector from the associated permuted error pattern;
decrypting each encrypted binary message vector by using the associated decryption key to form r decrypted binary message vectors; and
reformatting the r decrypted binary message vectors by removing appended dummy bits to form the original digital message.

27. The method of claim 26, wherein reconstructing the message further comprises retrieving said cryptogram from a communications channel or storage medium, applying a permutation matrix to r retrieved vectors, discarding the random bits to form a cryptogram consisting of r corrupted codewords, each of length n−k+kₛ bits.

28. Apparatus for encrypting data by constructing a digital cryptogram using a public key algorithm, comprising:
a first constructor configured to construct a first generator matrix of a binary code with dimension k with a preselected finite field and a Goppa polynomial whose degree is such that the corresponding binary code provides a t error correcting capability by utilising n−k parity bits;
a second constructor configured to constructing a scrambled k×n generator matrix by matrix multiplication, said scrambled generator matrix being the product of a non-singular matrix, said first generator matrix and a permutation matrix;
an encoder configured to encode a message vector D with the scrambled generator matrix, using matrix multiplication to form a codeword vector of length n bits;
a codeword generator configured to generate a shortened corrupted codeword by corrupting said codeword vector and omitting a predefined number of bits from each corrupted codeword; and
a former configured to form a cryptogram from the shortened corrupted codeword.

29. The apparatus of claim 28, further comprising:
a random number generator configured to generate independently, an integer s such that s<t for each codeword vector,
and wherein the codeword generator is further configured to:
add to each codeword vector using modulo 2 arithmetic a random, independently generated, error vector of length n bits, containing s bit errors; and
remove 2(t−s) bits from the codeword vector, according to a pre-defined position vector.

30. The apparatus of claim 29, further comprising a key generator configured to generate an associated encryption key for each message vector D from the associated error pattern, and an encrypter configured to encrypt each message vector into an encrypted message vector using said associated encryption key.

31. The apparatus of claim 28, further comprising:
a third constructor configured to construct a reduced echelon k×n generator matrix by randomly selecting k independent columns of the scrambled k×n generator matrix according to a second permutation matrix, wherein the reduced echelon k×n generator matrix consists a first sub-matrix portion having dimensions (k−kₛ)×n, and a second sub-matrix portion having dimensions kₛ×n; and
an error vector generator configured to randomly generate, for each message vector D, an associated error vector of length n bits, containing t bit errors, the generated error vector including at least three error vector portions, wherein first and second portions have bits (A) in positions corresponding to the k−kₛ information bits and bits (B) in positions corresponding to the kₛ information bits, and a third portion C has bits in positions corresponding to the n−k parity bit positions;
wherein the encoder is further configured to encode the associated error vector portion A of length k−kₛ bits and the message vector D of length kₛ bits, with the reduced echelon k×n generator matrix to form a codeword vector of length n bits; and
wherein the codeword generator is further configured to generate a shortened corrupted codeword by omitting the first k−kₛ bits from each codeword to form a shortened codeword of length n−k+kₛ bits, and corrupting each shortened codeword by adding to each codeword using modulo 2 arithmetic the associated error vector portions B and C to form a corrupted shortened codeword.

32. The apparatus of claim 31, further comprising a key generator configured to generate an associated encryption key for each message vector D from the associated error pattern, and an encrypter configured to encrypt each message vector into an encrypted message vector using said associated encryption key.

33. A non-transitory computer-readable storage medium storing computer-executable instructions that when executed performs the method of encrypting data by constructing a digital cryptogram using a public key algorithm, comprising:
constructing a first generator matrix of a binary code with dimension k with a preselected finite field and a Goppa polynomial whose degree is such that the corresponding binary code provides a t error correcting capability by utilising n−k parity bits;
constructing a scrambled k×n generator matrix by matrix multiplication, said scrambled generator matrix being the product of a non-singular matrix, said first generator matrix and a permutation matrix;
encoding a message vector D with the scrambled generator matrix, using matrix multiplication to form a codeword vector of length n bits;
generating a shortened corrupted codeword by corrupting said codeword vector and omitting a predefined number of bits from each corrupted codeword; and
forming a cryptogram from the shortened corrupted codeword.
